(19) United States
(12) Patent Application Publication
(10) Pub. No.: US 2025/0116838 A1
(43) Pub. Date: Apr. 10, 2025

(54) DEVICES AND METHODS FOR PULLING TERMINATED AND UNTERMINATED CABLES

(71) Applicant: 13447685 CANADA INC., TROIS-RIVIERES (CA)

(72) Inventors: FRANCOIS MENARD, TROIS-RIVIERES (CA); YANNIS MENARD, TROIS-RIVIERES (CA)

(21) Appl. No.: 18/833,260

(22) PCT Filed: Jan. 26, 2023
(86) PCT No.: PCT/CA2023/050095

§ 371 Date: Jul. 25, 2024

Related U.S. Application Data
(60) Provisional application No. 63/408,254, filed on Sep. 20, 2022.
(60) Provisional application No. 63/371,778, filed on Aug. 18, 2022.
(60) Provisional application No. 63/366,978, filed on Jun. 24, 2022.
(60) Provisional application No. 63/352,884, filed on Jun. 16, 2022.
(60) Provisional application No. 63/267,169, filed on Jan. 26, 2022.

(51) Int. Cl. G02B 6/54

(52) U.S. Cl. CPC G02B 6/545

(57) ABSTRACT

There are many instances where electrical, RF and fiber optic cables require installation either initially within different environments or during upgrades, repairs etc. These cables may be pre-terminated or unterminated and generally physically pulled through holes within wood, concrete, brick, etc. as well as ducts. Prior art approaches are expensive wasting or damage the cables and labour intensive. To support pulling of pre-terminated cables and unterminated cables there are provided different designs of demountable attachments to provide an attachment means to a pre-terminated cable for pulling. The underlying design concepts of these demountable attachments for pre-terminated cable pulling are also applicable to attachments for unterminated cables for pulling these as well as to devices for the storage of pre-terminated cables.

### CROSS-REFERENCE TO RELATED APPLICATIONS

This patent application claims the benefit of priority as a 371 national phase entry application of PCT/CA2023/050095 filed Jan. 26, 2023; which itself claims the benefit of priority from U.S. Provisional Application 63/408,254 filed Sep. 20, 2022; the benefit of priority from U.S. Provisional Application 63/371,778 filed Aug. 18, 2022; the benefit of priority from U.S. Provisional Application 63/366,978 filed Jun. 24, 2022; the benefit of priority from U.S. Provisional Application 63/352,884 filed Jun. 16, 2022; and the benefit of priority from U. S. Provisional Application filed 63/267,169 filed Jan. 26, 2022.

### FIELD OF THE INVENTION

This patent application relates to pre-terminated cable pulling, unterminated cable pulling and more particularly to devices and methods for compact demountable attachments to pre-terminated cables as well as unterminated cables, to enable pulling as well as other devices and methods to enable storage of pre-terminated cables.

### BACKGROUND OF THE INVENTION

Pre-terminated cables are telecommunications cables factory pre-installed with connectors. They are inconvenient to pull because of their connectors which requires drilling holes or conduits sizes greater than the cable sheath outside diameter and sufficiently large to allow pulling through the connector as well. Pre-terminated cables, like unterminated cables, can be installed through ducts or other elements of infrastructure. Within outside plant these ducts are typically buried and run between one element of network infrastructure, e.g., central office, street cabinet, etc. to another element of network infrastructure. Other ducts or pipes may run from the outside plant to a pre-terminated panel position, integrated into a demarcation device designated as a network interface device (NID). The NID is typically located outdoor on the dwelling wall and designated as an outdoor NID.

Easy troubleshooting of customer installations for broadband services typically entails installing a separate indoor pre-terminated cable between the outdoor NID terminating the outdoor distribution network drop cable onto the outer wall of a building and the location where the customer premise equipment is to be located inside the dwelling. Oftentimes, such customer premise equipment includes built-in Wi-Fi and is best located centrally to the dwelling, thereby requiring that the indoor distribution cable be up to several tens of meters long, separating that location from the NID outside the building. The installation of such long indoor pre-terminated cables is labour intensive, involving pulling the pre-terminated cables in crawl spaces, ceilings, addicts, behind walls, piercing through walls & floors, etc. In a commercial building the matter is fundamentally not different. Minimizing the dimensions of the holes and facilitating pre-terminated cable pulling through potentially inaccessible portions of a building without creating substantial more damage to be repaired would be beneficial.

At present, “Kellem Grips” as described within U.S. Pat. No. 1,670,543, operating on the principle of a Chinese finger pulling toy, are commonly used for pulling larger diameter cables in large diameter pipes. Alternatively, textile sleeve tools exist for pulling pre-terminated cables but require affixing the textile sleeve with a tape or a crimp ring.

Accordingly, compact demountable attachments to pre-terminated cables to enable pulling of the cables through small holes in thin or thick materials such as wood, brick, concrete, plastic, metal etc. would be beneficial. It would be further beneficial for these compact demountable attachments to, be easily mounted/demounted to a pre-terminated cable, protect the connector on the end of the cable, allow for the pulling force to be distributed way from the connector onto the sheath of the cable, to avoid potential damage to pre-terminated cables connectors and be low cost/disposable and potentially re-usable. Such compact demountable attachments addressing these requirements have been established by the inventors. The same demountable attachments may also be employed to pull on cables without connectors.

Pre-terminated cables can be either assembled with fiber-optic strands, where the fiber-optic can either be single mode or multimode or metal strands, where such metal is typically copper. The metal stranded pre-terminated cables are typically referred to as unshielded twisted pairs (UTP), coaxial or twin-axial. In the data center industry, twin-axial pre-terminated cables where the connector is a complete transceiver is referred to as a “direct attached cable,” which is effectively an active pre-terminated cable rather than a passive pre-terminated cable. In the same datacenter industry, whereas the cable is made out of fiber optics permanently attached to an optical transceiver head, the pre-terminated cable is referred to as an “active optical cable.” Herein we consider active optical cables and direct attached cables as variants of pre-terminated cables. Pre-terminated cables can be composed out of several strands of optical fiber or several metal strands. For instance, fiber optic pre-terminated cables with MTP connectors typically bundle 12 strands of single mode optical fiber. Metal stranded Category 5, 6, 6A, 7 & 8 variants of UTP make use of 8 metal strands and an RJ-45 type connector. The UTP pre-terminated cables herein generalized as “electrical” pre-terminated cables are more precisely radio-frequency capable cables, which in the case of Category 8 UTP cables can support speeds up to 40 Gbps.

Accordingly, in order to support pulling pre-terminated cables the inventors have established demountable attachments to provide an attachment means to the pre-terminated cable for pulling. The underlying design concepts of such demountable attachments for pulling on pre-terminated cables are also beneficially applicable to pulling of unterminated cables as well as to devices for the storage of pre-terminated cables.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations within the prior art relating to pre-terminated cable pulling and more particularly to devices and methods for compact demountable attachments to pre-terminated cables as well as unterminated cables, to enable pulling as well as other devices and methods to enable storage of pre-terminated cables.

In accordance with an embodiment of the invention there is provided a device for attachment to a pre-terminated cable comprising:
a boot portion disposed at a first end of the device having a slot formed therein for insertion and removal of a cable forming part of the pre-terminated cable;
a front portion disposed at a distal end of the device comprising an inner portion for housing a first portion of a connector terminating the cable and a fitting for attachment of another device with which the device and cable are pulled; and
a body portion disposed between the boot portion and the front portion comprising an opening for housing a second portion of the connector and allowing insertion and removal of the connector into the front portion and body portion of the device.

In accordance with an embodiment of the invention there is provided a method comprising:
attaching a device to a pre-terminated cable;
attaching another device to the device; and
pulling pre-terminated cable through an opening by pulling the another device through the opening and therein pulling the device and a portion of the pre-terminated cable through the opening; wherein
the device comprises:
   a boot portion disposed at a first end of the device having a slot formed therein for insertion and removal of a cable forming part of the pre-terminated cable;
   a front portion disposed at a distal end of the device comprising an inner portion for housing a first portion of a connector terminating the pre-terminated cable and a fitting for attachment of the another device with which the device and pre-terminated cable are pulled; and
   a body portion disposed between the boot portion and the front portion comprising an opening for housing a second portion of the connector and allowing insertion and removal of the connector into the front portion and body portion of the device; and
the pulling force is transferred from the front portion to the boot portion thereby removing stress induced on the connector portion of a pre-connectorized cable.

In accordance with an embodiment of the invention there is provided a method for attachment to a cable comprising:
a helix with a helical structure wherein the helix has a bore of a first diameter and an outer surface of a second diameter; wherein
the helix when mounted to the cable adapts a cable pulling attachment to the cable such that the cable is frictionally retained within the cable pulling attachment under application of a longitudinally load to the cable pulling attachment.

In accordance with an embodiment of the invention there is provided a design for attachment to a cable comprising:
an element having an inner geometry defined by a predetermined portion of a connector terminating an end of the cable and an outer geometry defined by an inner geometry of a body portion of a pulling attachment; wherein
the element is to be mounted over the predetermined portion of the connector and pushed into the body portion of the pulling attachment to retain the connector allowing the cable to be pulled by a pulling means attached to the pulling attachment; and
the element has one of a retaining U-shape and a reentrant U-shape.

In accordance with an embodiment of the invention there is provided a device for attachment to a pre-terminated cable comprising:
a front portion disposed at an end of the device comprising an inner portion for housing a first portion of a connector terminating the pre-terminated cable and a fitting for attachment of a pulling mechanism with which the device and pre-terminated cable are pulled;
an end portion comprising a helical structure at a distal end of the device; and
a body portion disposed between the front portion and the end portion comprising an opening for housing a second portion of the connector and allowing insertion and removal of the connector into the front portion and body portion of the device; wherein
the helical structure can be mounted onto and removed from a portion of the cable.

In accordance with an embodiment of the invention there is provided a device for attachment to a cable comprising:
a first end portion having a defined length for encasing a predetermined portion of a cable having a diameter wherein the first end portion can be mounted onto and removed from the predetermined portion of the cable;
a second end portion having another defined length for encasing another predetermined portion of the cable wherein the second end portion can be mounted onto and removed from the another predetermined portion of the cable;
a helical structure having an end coupled to the first end portion and a distal end coupled to the second end portion; wherein
the helical structure can be mounted onto and removed from a further portion of the cable between the predetermined portion of the cable and the another predetermined portion of the cable.

In accordance with an embodiment of the invention there is provided a device for attachment to a fiber optic cable comprising:
a front portion disposed at an end of the device comprising an inner portion for housing a first portion of a connector terminating a cable and a fitting for attachment of another device with which the device and cable are pulled;
an end portion comprising a helical structure at a distal end of the device; and
a body portion disposed between the front portion and the end portion comprising an opening for housing a second portion of the connector and allowing insertion and removal of the connector into the front portion and body portion of the device; wherein
the helical structure can be mounted onto and removed from a portion of the cable.

In accordance with an embodiment of the invention there is provided a device comprising:
a body having an end and a distal end;
a fitting for attachment of a pulling mechanism with which the device is pulled disposed within an exterior face of the end;
a plurality of N recesses disposed around the periphery of the end, each recess of the plurality of N recesses for accommodating a connector terminating a cable and having an end at the exterior face of the end and a distal end; and
a plurality of N grooves, each groove of the plurality of N grooves dimensioned to accommodate a cable and running from an end at the distal end of a predetermined recess of the plurality of recesses to a point along the body; wherein
the device supports the mounting of up to M terminated cables;
N and M are positive integers greater than or equal to 2; and
M≤N.

In accordance with an embodiment of the invention there is provided a device comprising:
a body having an end and a distal end;
a fitting for attachment of a pulling mechanism with which the device is pulled disposed within an exterior face of the end;
a plurality of N grooves, each groove of the plurality of N grooves dimensioned to accommodate a cable and running from a point along the body to another point along the body; wherein
each groove supports the mounting of up to M cables;
the device supports the mounting of up to R cables;
N and M are positive integers;
N≥2;
M≥1; and
R≤N*M.

In accordance with an embodiment of the invention there is provided a device for attachment to an unterminated cable comprising:
a front portion disposed at an end of the device having a slot formed within an outer surface of the front portion;
an end portion comprising a helical structure at a distal end of the device having another slot formed within an outer surface of the end portion; and
a body portion disposed between the front portion and the end portion comprising a helically disposed groove disposed around an outer surface of the body portion wherein an end of the groove connects with the slot in the front portion and a distal end of the groove connects with the other slot in the end portion; wherein
the slot, the another slot, and the groove each allow the insertion and removal of a cable.

In accordance with an embodiment of the invention there is provided a device comprising:
a body of defined cross-sectional geometry with a plurality of surfaces; and
one or more grooves of defined geometry and dimensions where each groove of the one or more grooves is formed within a surface of the a plurality of surfaces; wherein
each groove of the one or more grooves allows the insertion and removal of a cable; and
an end of each groove of the one or more grooves terminates within a defined surface of the plurality of surfaces and a distal end of the groove of the one or more grooves terminates within another defined surface of the plurality of surfaces.

In accordance with an embodiment of the invention there is provided a device comprising:
a body of defined cross-sectional geometry with an outer surface, an end and a distal end;
a first recess formed within the end of the body;
a second recess formed within the distal end of the body;
a helically disposed groove of defined geometry and dimensions disposed around the outer surface of the body;
a first guide with the defined geometry and dimensions connecting an end of the first recess to an end of the helically disposed groove;
a second guide with the defined geometry and dimensions connecting an end of the second recess to a distal end of the helically disposed groove; wherein
the first recess is dimensioned to hold a first connector terminating an end of a cable;
the second recess is dimensioned to hold a second connector terminating a distal end of the cable; and
the first guide, the second guide and the helically disposed groove allow for the demountable insertion of the cable.

In accordance with an embodiment of the invention there is provided a method of attaching a cable itself by the sheath in a helical grip device according to an embodiment of the invention.

In accordance with an embodiment of the invention there are provided devices and methods of pulling cables by employing an aramid rope or aramid strength member of one or all cables to the same cable pulling device with helical grip(s).

In accordance with an embodiment of the invention there is provided a cable pulling device with two or more grooves formed helically, with a portion of the grooves serving to attach cables and another portion of the grooves serving to attach one of the aramid strength members of the locally attached cable or a common pull rope interconnecting all cable pulling devices within a daisy chain

In accordance with an embodiment of the invention there is provided a cable pulling device with one or more grooves wherein the grooves are formed helically and have a re-entrant shape with an opening less than 180 degrees in order to allow press-fitting and snapping of the cable into the cable pulling device, at one of a beginning, end or intermediate point along the path of the helical groove in the cable pulling device.

In accordance with an embodiment of the invention there is provided a cable pulling device with one or more grooves wherein the grooves are formed helically and have a re-entrant shape with an opening less than 180 degrees in order to allow press-fitting and snapping of a pulling rope into the cable pulling device, at one of a beginning, end or intermediate point along the path of the helical groove in the cable pulling device.

In accordance with an embodiment of the invention there is provided a method of using the aramid strength member of the shortest cable in a bundle of cables as the pulling rope for a daisy chain of pulling devices according to an embodiment of the invention whereby the aramid strength member of the shortest cable is employed to form a pulling eye allowing the transfer of pulling force from device to device within the daisy chain

In accordance with an embodiment of the invention there is provided a method of implementing a staggered configuration of pulling devices according to an embodiment of the invention which minimizes the overall diameter of the bundle of cables towards the tip of the bundle thereby providing greater maneuverability through sharp or small radius conduit bends, discontinuities in conduit bore diameter and easier handling for smaller hands.

In accordance with an embodiment of the invention there is provided a method of implementing a rooted staggered configuration of pulling devices according to an embodiment of the invention where all cables are pulled from one end with the pulling force being applied sequentially through the staggered configuration of pulling devices from that end to the other end.

In accordance with an embodiment of the invention there is provided a method of implementing a distributed staggered configuration of pulling devices according to an embodiment of the invention where cables are incrementally dropped through the staggered configuration.

In accordance with an embodiment of the invention there is provided a pulling method which avoids stretching cables, by making it possible to pull not only on the cable, but principally on the aramid strength members inside the cables, thus avoiding plastic deformation of the cable sheath and excessive strain on one of the optical fiber or copper conductors inside the cable, thus avoiding either potential breakage of the optical fiber or loss of optical performance on fiber optic cable or disrupting the twisting configuration of twisted pair cabling and potential or loss of performance on twisted pair cables or increased crosstalk.

In accordance with an embodiment of the invention there is provided a method of pulling cables which either reduces or eliminates the need for wrapping of a tape around the cable(s) thereby providing faster set-up and dismantlement of cable pulling assemblies.

In accordance with an embodiment of the invention there is provided a method which of pulling cables which removes the scrapping of a section of cable due to the cost or time in removing of a tape and/or residue on the cable arising from the from the use of the tape to bind the cable as part of a pulling assembly.

In accordance with an embodiment of the invention there is provided a method which eliminates the requirement for coiling back cables resulting from the unspooling from cable storage, e.g. cable boxes or cable drums, of longer sections than required where the correct length is unspooled by implementing a distributed staggered configuration of pulling devices according to an embodiment of the invention.

In accordance with an embodiment of the invention there is provided a cable pulling device which minimizes the number of stocks keeping units (SKU's) required and associated spares whereby the pulling device according to an embodiment of the invention supports pulling operations of bundles of cables containing more than one cable by daisy-chaining multiple instances of the pulling device according to an embodiment of the invention within a single daisy chain or multiple daisy chains in parallel to one another.

In accordance with an embodiment of the invention there is provided a method of reducing an overall length of a daisy chain of pulling devices according to an embodiment of the invention by employing multiple daisy chains in parallel.

In accordance with an embodiment of the invention there is provided a pulling device according to an embodiment of the invention with a helical groove of a shape which is designed according to different cable geometries like round, square, rectangle, peanut shape flat drop, figure-eight Siamese cables, hybrid cables, duplex cables, cable arrays, etc.

In accordance with an embodiment of the invention there is provided a pulling device according to an embodiment of the invention which can pull different cable geometries at the same time with multiple grooves or grooves of multiple configurations in the depth or lateral axis

In accordance with an embodiment of the invention there is provided a pulling device according to an embodiment of the invention which can secure the cable geometry in one groove and its aramid strength member, or rope, in another groove of the same apparatus, where the grooves are helically formed in the apparatus.

In accordance with an embodiment of the invention there is provided a pulling device according to an embodiment of the invention wherein helically formed grooves in the pulling device according to an embodiment of the invention intersect with other grooves thereby allowing aramid strength members of the cables or an aramid rope of a cable to transition from a cable groove to a rope groove or vice-versa.

In accordance with an embodiment of the invention there is provided a pulling device according to an embodiment of the invention comprising one or more cable groove(s) and no rope grooves wherein an attachment of one or more aramid strength members is made by knotting the aramid strength members around the pulling device according to an embodiment of the invention using one or more knots such as anti-slip knots whereby the aramid strength members upon pulling the pulling device according to an embodiment of the invention do not crush the cable which is secured inside a groove of the pulling device according to an embodiment of the invention.

In accordance with an embodiment of the invention there is provided a pulling device according to an embodiment of the invention comprising one or more rope grooves where aramid rope or aramid strength members of the cable are locally attached or passed through to form a common rope across a daisy chain of pulling devices according to an embodiment of the invention.

In accordance with an embodiment of the invention there is provided a pulling device according to an embodiment of the invention comprising two or more cable grooves formed helically around an outer surface of the pulling device according to an embodiment of the invention.

In accordance with an embodiment of the invention there is provided a pulling device according to an embodiment of the invention comprising two or more cable grooves formed helically around an outer surface of the pulling device according to an embodiment of the invention wherein the pulling device supports multiple cable geometries.

In accordance with an embodiment of the invention there is provided a pulling device according to an embodiment of the invention with cable grooves which intersect one another within the pulling device according to an embodiment of the invention allowing a cable groove to accept a cable stripped to one or more aramid strength members wherein the aramid strength members transition into a rope groove at an interim location along the length of the pulling device according to an embodiment of the invention between the ends of the cable pulling device such that the pulling device according to an embodiment of the invention comprises at least a profiled end for reducing likelihood of the pulling device catching and/or allow for reduced gap between two cable grooves formed upon the pulling device to accommodate a pull rope between the two cable grooves.

In accordance with an embodiment of the invention there is provided a method of daisy chaining a series of pulling devices according to embodiments of the invention in order to provide an M×N staggered configuration where a first pulling device according to an embodiment of the invention with M grooves serves to pull cables attached to the pulling device according to an embodiment of the invention each with N cable grooves, thus allowing pulling of M×(N−1) cables in a single pulling operation.

In accordance with an embodiment of the invention there is provided a method for adding common rope through a daisy-chain of pulling devices according to embodiments of the invention without need for providing one or more anti-slip-knots on each pulling device according to an embodiment of the invention whereby a common pull rope is being unspooled from the opposite direction as the cables are being unspooled as the daisy chain gets assembled and where the common rope is wound forward, then backward, then forward again across first, second and then first rope grooves thus avoiding the requirement to dismantle or break the common pull rope to create the one or more anti-slip-knots onto pulling device according to an embodiment of the invention.

In accordance with an embodiment of the invention there is provided an apparatus which enables the pulling operation to be implemented entirely dielectrically without any metal part, allowing pulling to be done inside epoxy covered conduits without scratching them or in explosive environments.

In accordance with an embodiment of the invention there is provided pulling device according to an embodiment of the invention which can be manufactured at a deployment location using one or more additive manufacturing processes (commonly referred to as being printed).

In accordance with an embodiment of the invention there is provided a device for attachment to a pre-terminated cable comprising:
a boot portion disposed at a first end of the device having a slot formed therein for insertion and removal of a cable forming part of the pre-terminated cable;
a front portion disposed at a distal end of the device comprising an inner portion for housing a first portion of a connector terminating the pre-terminated cable and a fitting for attachment of another device with which the device and pre-terminated cable are pulled; and
a body portion disposed between the boot portion and the front portion comprising an opening for housing a second portion of the connector and allowing insertion and removal of the connector into the front portion and body portion of the device; wherein
the boot portion and the body portion are a single piece part; and
the front portion is one of removably attachable to the body portion and permanently attached to the body portion.

In accordance with an embodiment of the invention there is provided a method of forming an attachment to a pre-terminated cable comprising:
forming a boot portion, the boot portion to be disposed at a first end of the device having a slot formed therein for insertion and removal of a cable forming part of the pre-terminated cable;
forming a body comprising:
a front portion, the front portion to be disposed at a distal end of the device comprising an inner portion for housing a first portion of a connector terminating the pre-terminated cable and a fitting for attachment of another device with which the device and pre-terminated cable are pulled; and
a body portion, the body portion to be disposed between the boot portion and the front portion comprising an opening for housing a second portion of the connector and allowing insertion and removal of the connector into the front portion and body portion of the device;
joining the front portion to the body portion by a process to permanently attach the body portion to the front portion.

In accordance with an embodiment of the invention there is provided a method of forming an attachment to a pre-terminated cable comprising:
fabricating a number of piece parts; and
joining the piece parts together to form the attachment; wherein the attachment comprises:
a boot portion to be disposed at a first end of the device having a slot formed therein for insertion and removal of a cable forming part of the pre-terminated cable;
a front portion to be disposed at a distal end of the device comprising an inner portion for housing a first portion of a connector terminating the pre-terminated cable and a fitting for attachment of another device with which the device and pre-terminated cable are pulled; and
a body portion to be disposed between the boot portion and the front portion comprising an opening for housing a second portion of the connector and allowing insertion and removal of the connector into the front portion and body portion of the device.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts a three-dimensional (3D) schematic of a fiber optic cable (FOC) pulling attachment (FOC-PA) according to an embodiment of the invention;

FIG. 2 depicts a side elevation view of a FOC-PA according to an embodiment of the invention;

FIG. 3 depicts a plan elevation view of a FOC-PA according to an embodiment of the invention;

FIG. 4 depicts an end elevation view of a FOC-PA according to an embodiment of the invention;

FIG. 5 depicts a bottom elevation view of a FOC-PA according to an embodiment of the invention;

FIG. 6 depicts a bottom elevation view of a FOC-PA according to an embodiment of the invention;

FIG. 7 depicts a 3D perspective detailed view of a FOC-PA according to an embodiment of the invention;

FIG. 8 depicts optical micrographs of a process for mounting a FOC-PA to a pre-connectorized fiber optic cable and subsequent assembly with a pulling stick (puller);

FIG. 9 depicts a side elevation view of a FOC-PA according to an embodiment of the invention assembled with a puller;

FIG. 10 depicts a side elevation view of a FOC-PA according to an embodiment of the invention assembled with a puller and rotary joint;

FIG. 11 depicts a side elevation view of a FOC-PA according to an embodiment of the invention assembled with a puller and ball joint;

FIG. 12 depicts side elevation views of FOC-PAs according to embodiment of the invention;

FIG. 13 depicts an optical micrograph of a FOC-PA according to an embodiment of the invention with an eye for attachment to a pulling cable;

FIG. 14 depicts an optical micrograph of a FOC-PA according to an embodiment of the invention with a helical adapter (HELIX) for a 2 mm buffered fiber rather than 4.8 mm cable;

FIG. 15 depicts an optical micrograph of a HELIX and an assembled FOC-PA with a HELIX adapter for a 2 mm cable as inserted in the re-entrant U linear groove of the FOC-PA;

FIG. 16 depicts a perspective CAD image of a HELIX according to an embodiment of the invention;

FIGS. 17 and 18 depict plan and front elevation CAD images of a HELIX according to an embodiment of the invention;

FIGS. 19 to 21 depict perspective CAD images of an electrical cable (EC) PCA (EC-PA) according to an embodiment of the invention; and

FIG. 22 depicts a cross-section perspective CAD image of an EC-PA according to an embodiment of the invention;

FIG. 23 depicts exemplary images of over-molding a connector boot to a connector according to the prior art;

FIG. 24 depicts exemplary images of optical and electrical connectors with over-molded connector boots;

FIG. 25 depicts an exemplary EC-PA with an Ethernet connector according to an embodiment of the invention wherein the EC-PA engages against the connector boot to retain the connector rather than the cable and force from the pulling attachment is directed to the connector boot;

FIGS. 26 and 27 depict perspective and cross-sectional perspective views of a pulling attachment (PA) according to an embodiment of the invention wherein the PA engages the rear of the connector (not shown) to retain the connector during a pulling operation;

FIGS. 28 and 29 depict perspective and cross-sectional perspective views of a Retaining U-Component (RUC) according to an embodiment of the invention for use in conjunction with a PA as depicted in FIGS. 26 and 27 respectively;

FIG. 30 depicts a cross-section exploded view of the RUC and PA;

FIGS. 31 and 32 depict the RUC, PA, and Cat 8 Ethernet cable assembly unassembled and assembled, respectively;

FIGS. 33 and 34 depict upper left and lower right perspective views of an inline helical pulling attachment (HELI-PA) according to an embodiment of the invention;

FIGS. 35 and 36A depict plan and bottom views of the inline HELI-PA according to an embodiment of the invention as depicted in FIGS. 33 and 34;

FIG. 36B depicts the inline HELI-PA according to an embodiment of the invention as depicted in FIGS. 33 to 36A in use with respect to pulling a cable terminated with a SC connector sub-assembly within clear 9.5 mm (⅜ inch) inner diameter tubing employing “fishing line” to pull the HELI-PA;

FIGS. 37A, 37B and 37C depict a variant of the HELI-PA according to an embodiment of the invention with respect to pulling an unterminated cable;

FIGS. 38 and 39 depict perspective views of an end of a HELI-PA according to an embodiment with grooves for the cable to be pulled to fit within;

FIGS. 40 to 42 depict perspective views of a pre-terminated cable pulling attachment (PA) according to an embodiment of the invention with a helical retention for the cable (referred to as a PA-HELR);

FIGS. 43 to 45 depict top, front, and bottom views of the PA-HELR according to the embodiment of the invention as depicted in FIGS. 40 to 42 respectively;

FIGS. 46 and 47 depict perspective views of a multi-cable pulling attachment (MC-PA) according to an embodiment of the invention supporting the attachment and pulling multiple cables;

FIG. 48 depicts a cross-section of the MC-PA according to the embodiment of the invention as depicted in FIGS. 46 and 47 respectively;

FIG. 49 depicts a variant of an MC-PA for pulling cables without connectors;

FIGS. 50 and 51 depict perspective views of a multi-cable pulling attachment (MC-PA) according to an embodiment of the invention as depicted in FIG. 49 supporting the attachment and pulling multiple cables;

FIGS. 52 and 53 depict an expanded perspective front end view and cross-section view of the MC-PA) according to an embodiment of the invention as depicted in FIGS. 49 to 51 respectively;

FIGS. 54 and 55 depict perspective and cross-sectional perspective views of multi-cable pulling attachment (MC-PA) or Multi-Cable Organizer Element (MC-OE) according to an embodiment of the invention;

FIG. 56 depicts cross-sectional views of the MC-PA/MC-OE according to the embodiment of the invention depicted in FIGS. 54 and 55 respectively;

FIG. 57 depicts a perspective view of a MC-OE according to an embodiment of the invention;

FIGS. 58 and 59 depict perspective and cross-section views of a MC-OE according to an embodiment of the invention;

FIGS. 60 and 61 depict perspective views of a MC-OE according to an embodiment of the invention with and without the connectorised cable;

FIG. 62 depicts a non-connectorised cable pulling assembly (NC-PA) according to an embodiment of the invention;

FIGS. 63 to 65 depict NC-PAs according to embodiments of the invention supporting multiple non-connectorised cables (MNC-PAs);

FIG. 66A depicts an MNC-PA according to an embodiment of the invention supporting multiple non-connectorised cables;

FIG. 66B depicts an MNC-PA according to an embodiment of the invention supporting multiple non-connectorised cables with a profiled geometry;

FIGS. 67 and 68 depict helical non-connectorised cable puller assemblies (HEL-NC-PA) according to embodiments of the invention;

FIGS. 69 and 70 depict exemplary deployment scenarios for the HEL-NC-PA designs depicted in FIGS. 67 and 68 respectively;

FIG. 71 depicts an exemplary stacked NC-PA according to an embodiment of the invention employing a pair of NC-PAs according to the design depicted in FIG. 66A; and

FIG. 72 depicts an exemplary NC-PA according to the design depicted in FIG. 66A assembled with cables; and

FIGS. 73, 74A and 74B depict HEL-NC-PAs according to embodiments of the invention;

FIGS. 75 and 76 depict a schematic and photograph respectively of a staggered cable pulling configuration employing HEL-NC-PAs according to an embodiment of the invention;

FIGS. 77A and 77B depict a flow diagram for implementing a staggered pull configuration with a daisy chain of HEL-NC-PAs according to an embodiment of the invention; and

FIG. 78 depicts an exemplary PA according to an embodiment of the invention;

FIG. 79 depicts a perspective view of a rear groove of a HEL-PA according to an embodiment of the invention with 120° opening to “pinch” the cable;

FIG. 80 depicts a perspective view of a HEL-PA according to an embodiment of the invention with “pinch” regions at the entrance to the helical grip nearest the head of the HEL-PA as well as at the rear;

FIG. 81 depicts perspective views of a 2-part injection molding mold for fabrication of a HEL-PA according to an embodiment of the invention such as depicted in FIG. 80 wherein the requirement for a core pin is removed;

FIG. 82 depicts photographs of HEL-PAs according to embodiments of the invention with counter-clockwise and clockwise grooves;

FIG. 83 depicts a perspective view of a HEL-PA according to an embodiment of the invention upon a cable depicted a re-entrant profile of the HEL-PA with 120° opening in a similar manner to that depicted in FIG. 80;

FIG. 84 depicts an end view schematic of a HEL-PA according to an embodiment of the invention with a reentrant profile such as described and depicted with respect to FIGS. 80 and 83 wherein the position of the cable has been offset from the centre of the HEL-PA so that the cable sits deeper within the HEL-PA;

FIG. 85 depicts full and detailed perspective views of a HEL-PA according to an embodiment of the invention exploiting the design depicted in FIG. 84 for the groove of the HEL-PA;

FIG. 86 depicts a perspective view of a rear portion of a HEL-PA according to an embodiment of the invention wherein the outer body at the rear is reduced in diameter to support addition of a tape wrapping;

FIG. 87A depicts a perspective view of a “flat-drop” HEL-PA according to an embodiment of the invention for use upon cables with heat shrink tubing protecting a transition from cabled to non-cabled portions of the cable;

FIG. 87B depicts a photograph of the “flat-top” HEL-PA according to an embodiment of the invention as depicted in FIG. 87A assembled with a cable;

FIGS. 88A and 88B depict perspective views of a two-part HEL-PA according to an embodiment of the invention in assembled and unassembled form allowing different “head portions” for attachment to different pulling means to be mounted to a common HEL-PA body according to an embodiment of the invention;

FIG. 89 depicts a multi-element injection molding strategy for a HEL-PA according to an embodiment of the invention wherein the multiple molded elements are subsequently joined to form an HEL-PA according to an embodiment of the invention;

FIG. 90 depicts a perspective view of an injection mold for forming the molded HEL-PA according to an embodiment of the invention in a single molding step.

### DETAILED DESCRIPTION

The present invention is direct to pre-terminated cable pulling and more particularly to devices and methods for compact demountable attachments to pre-terminated cables to enable pulling.

The ensuing description provides representative embodiment(s) only, and is not intended to limit the scope, applicability, or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment,” “an embodiment,” “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may,” “might,” “can” or “could” be included, that particular component, feature, structure, or characteristic is not required to be included.

Reference to terms such as “left,” “right,” “top,” “bottom,” “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users.

Reference to terms “including,” “comprising,” “consisting,” and grammatical variants thereof do not preclude the addition of one or more components, features, steps, integers, or groups thereof and that the terms are not to be construed as specifying components, features, steps, or integers. Likewise, the phrase “consisting essentially of,” and grammatical variants thereof, when used herein is not to be construed as excluding additional components, steps, features integers or groups thereof but rather that the additional features, integers, steps, components, or groups thereof do not materially alter the basic and novel characteristics of the claimed composition, device, or method. If the specification or claims refer to “an additional” element, that does not preclude there being more than one of the additional element.

A “pre-terminated cable,” also known as a pre-terminated cord, a patch cable, or a pre-terminated lead, as used herein refers to, but is not limited to, an electrical cable or optical cable used to connect cables with connectors between patch panel positions or end-devices like optical transceivers or RJ-45 ports on switches and network interface cards for signal routing.

“Fishing line” as used herein refers to, but is not limited to, a cord resembling a long, thin string, formed from a material such as nylon or a braided polymer for example. The attributes of a fishing line can include length, material, weight, and thickness in order to provide performance characteristics such as breaking strength, knot strength, stretch, abrasion resistance, and visibility. Commonly, in the art of cable pulling, flat pulling line (a polypropylene rope that is flat) and a flat mule tape are also employed and accordingly it is evident that derivatives of the invention allowing for attachment of something else than a fishing line would be evident to one skilled in the art.

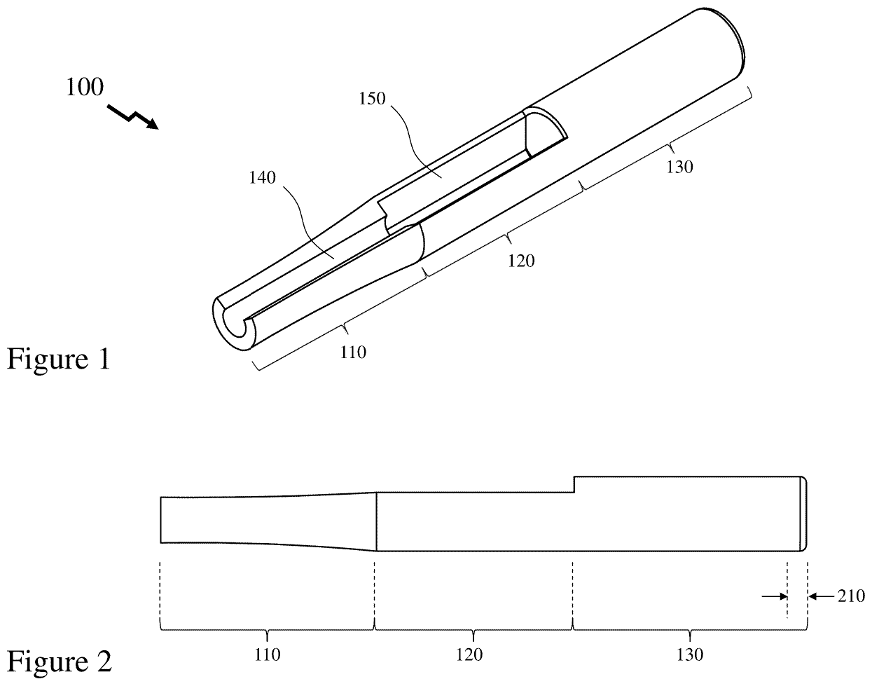

Referring to FIG. 1 there is depicted a three-dimensional (3D) schematic of a fiber optic cable pulling attachment (FOC-PA) 100 according to an embodiment of the invention. As depicted the FOC-PA 100 comprises three-sections, Boot 110, Body 120 and Front 130. The Boot 110 is designed in dependence upon the outer diameter of the fiber optic cable (FOC) it is designed to be attached to so that the FOC-PA 100 is retained in position based upon the engagement of the Boot 110 with the FOC (not depicted for clarity). For example, the outer diameter may be 900 μm, 2 mm, 3 mm or 4.8 mm, where these latter dimensions are more common as the cables include fibers for increased strength as well have superior pulling load capabilities, crush resistance, bend insensitivity, self-bend limiting capabilities, etc. The FOC being pre-terminated with a fiber-optic connector such as SC Angled Physical Contact (SC/APC, typically (green for visual identification or SC Ultra Physical Contact (SC/UPC, typically blue for visual identification), not depicted for clarity, being inserted, upon having previously removed its outer body housing, into Opening 150 in Body 120, allowing the connector to partially or fully enter a cavity in the Front 130 of the FOC-PA, and then subsequently allow for the cable portion of the FOC to be crimped into a Slot 140 in the Boot 110 section of the FOC-PA.

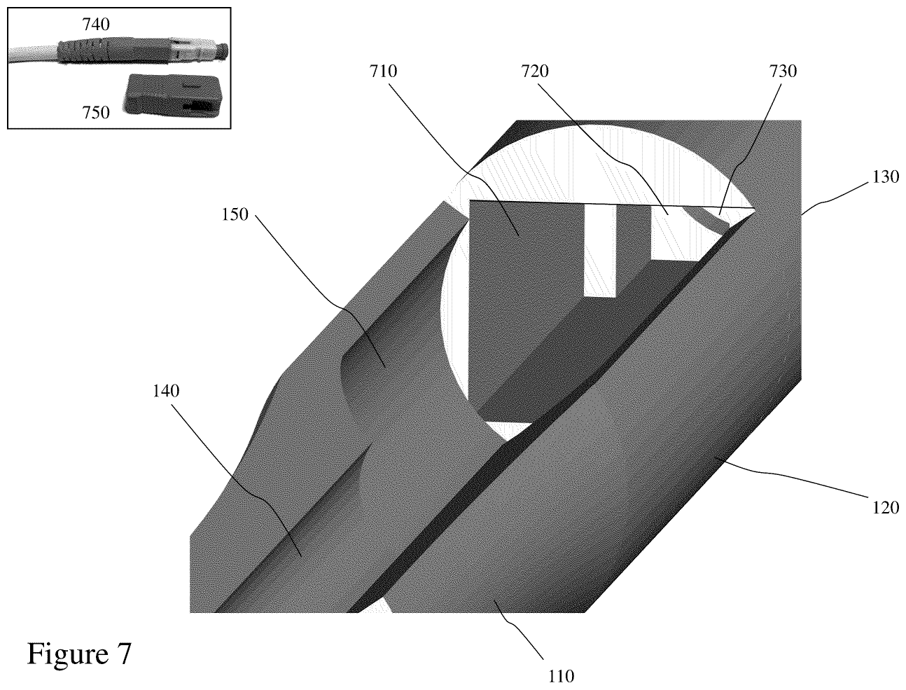

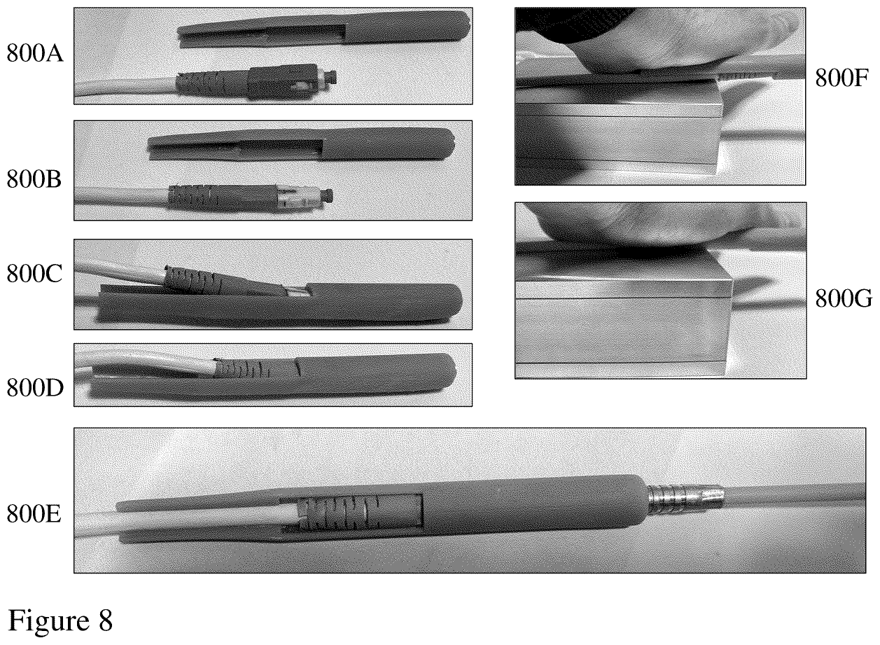

The boot of the connector such as SC/APC of the FOC, not depicted for clarity, is retained within the Body 120 of the FOC-PA and the connector portion of the FOC is retained in a portion of the Front 130 of the FOC-PA. The Opening 150 in the Body 120 being dimensioned in dependence upon one of the boot and of optical connector on the end of the FOC. As evident from FIGS. 7 and 8 the optical connector also fits into a portion of the Front 130 together with its dust cap which is fitted over the ferrule of the optical connector to protect the facet of the optical fiber and ferrule. The outer diameter of the Front 130 being dimensioned to be larger than the dimensions of the optical connector such that the optical connector is within the footprint of the FOC-PA.

The FOC-PA may within embodiments of the invention be specific to a discrete connector type for a single optical connection, e.g., Ferrule Connector (FC), ST Connector (ST), Lucent Connector (LC), Standard Connector (SC), MU Connector, SMA Connector, E2000 Connector, or an SC connector sub-assembly with connector housing removed, etc.

The removal of the SC connector outer body housing makes it possible for the FOC-PA to achieve a smaller outside diameter than if needing to encapsulate the entire SC connector including the outer body housing inside the FOC-PA. This then makes it possible for the FOC-PA to be pulled into a smaller diameter hole or conduit than that would be possible for an FOC-PA encapsulating the entire SC connector including its outer body enclosure.

The FOC-PA may within embodiments of the invention be specific to several discrete connector types for single optical connections, e.g., SC/LC/MU or FC/SMA/ST etc.

The FOC-PA may within embodiments of the invention be specific to one or more optical connector types supporting multiple optical connections, e.g., MT. MXC or Multi-fiber Push On (MPO) connectors for ribbon cable.

The FOC-PA may within embodiments of the invention be designed to accommodate duplex optical connectors such as SC Duplex or LC Duplex for example with or without a housing element joining the pair of optical connectors together.

Whilst, within the following description and FIGS. 1 to 12 the FOC-PA is described and depicted as being one with circular cross-sectional geometry it would be evident that within other embodiments of the invention that other single cross-sectional geometries or multiple cross-section geometries may be employed without departing from the scope of the invention. For example, those to manage duplex or ribbon connectors may, for example, be elliptical. The design of the FOC-PA being one that protects the optical connector during its placement/pulling with reduction in surfaces/edges that might cause the FOC-PA to be stuck during its placement/pulling. Accordingly, it may also be possible for the FOC-PA to be designed to encapsulate a bare ended SC or LC ferrule, with or without a dust cap, allowing the pulling of a bare ferrule ended fiber optic strand into a 900-micron buffer tube (not illustrated).

Now referring to FIG. 2 there is depicted a side elevation view of a FOC-PA according to an embodiment of the invention showing the Boot 110, Body 120, Front 130, and End 210 of the Front 130 which has an End 210. The End 210 closes off the Front 120 and may include a Fitting, such as Fitting 410 in FIG. 4, to attach a puller which is employed to pull the FOC-PA and cable. Within embodiments of the invention the End 210 may be formed as a common piece-part with the Boot 110, Body 120, and Front 130 during manufacturing of the FOC-PA or it may a discrete element which is attached to a piece-part comprising the Boot 110, Body 120, and Front 130. Optionally, the Boot 110, Body 120, and Front 130 may themselves be formed from multiple piece-parts or formed as a single element. The exact method of manufacturing the FOC-PA may be determined in dependence upon one or more factors including, the material or materials employed, method of manufacturing (e.g., casting, machining, molding, additive manufacturing, etc.), loading(s) to be applied to the FOC-PA etc.

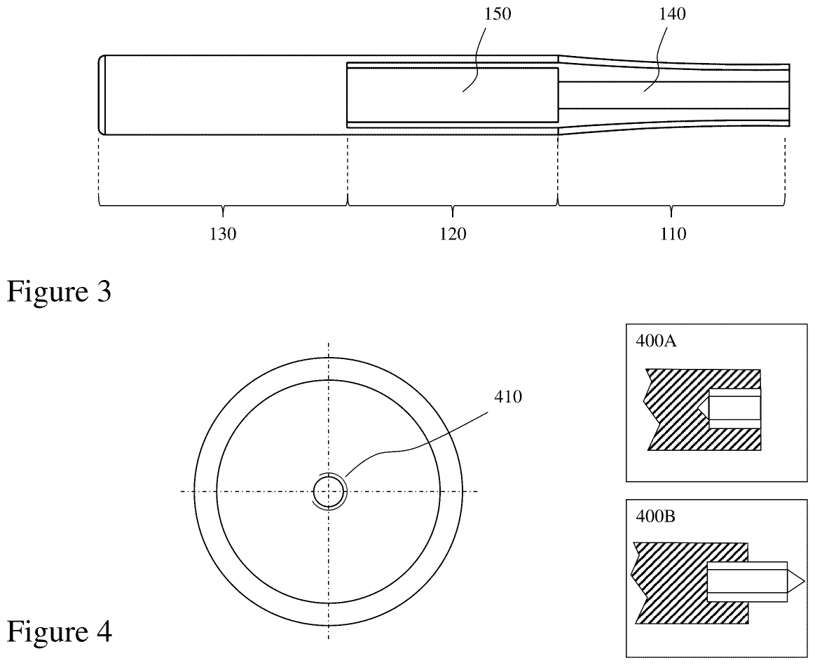

Referring to FIG. 3 there is depicted a plan elevation view of a FOC-PA according to an embodiment of the invention showing the Boot 110, Body 120, Front 130, Slot 140 and Opening 150. Now referring to FIG. 4 there is depicted an end elevation view of a FOC-PA according to an embodiment of the invention wherein a Fitting 410 is disposed within the end of the FOC-PA for attaching a pulling cable, a flexible pulling stick such as made out of fiberglass, pull-rod or other element (referred to herein as a Puller) to pull the FOC-PA and therein the optical cable. As depicted in first Image 400A the Fitting 410 is a threaded opening or an insert with threaded opening allowing a threaded mating element to be attached. In second Image 400B in the Fitting 410 is an insert with external threaded portion projecting from the FOC-PA allowing a threaded mating element to be attached.

Whilst threaded designs for the Rigging 410 and mating element of the Puller are described and depicted it would be evident to one of skill in the art that other detachable mating mechanisms may be employed to attach the FOC-PA to the Puller. In other embodiments of the invention the FOC-PA may be part of the Puller.

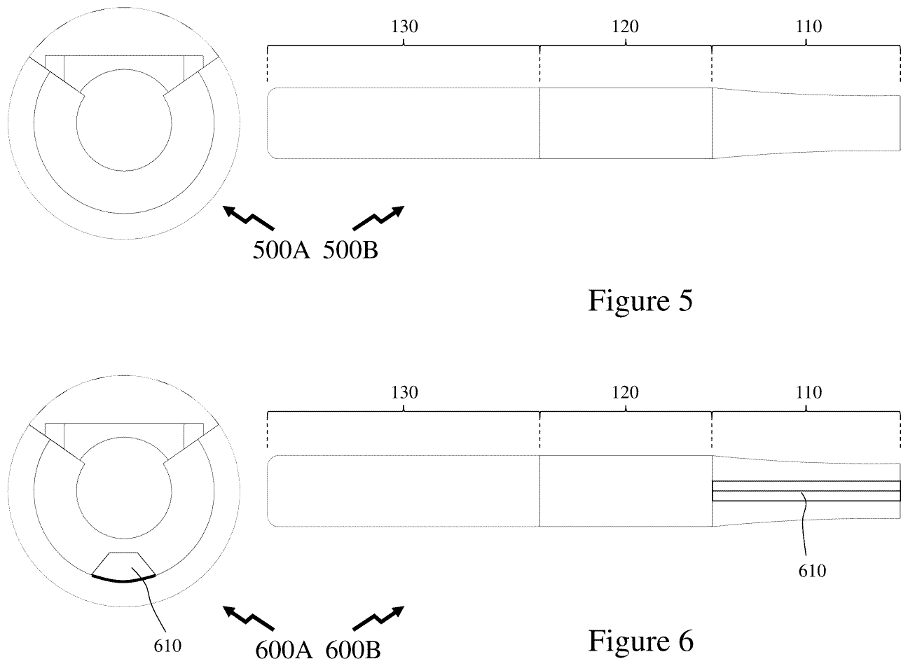

Referring to FIG. 5 there are depicted a bottom elevation view 500B of a FOC-PA according to an embodiment of the invention together with an end elevation 500A from the end towards the Boot 110. As depicted the FOC-PA comprises the Boot 110, Body 120, and Front 130 portions as discussed and described above. As evident from FIG. 5 the lower surface of the Boot 110 of the FOC-PA is concentric both on the inside to the outer diameter of the FOC cable outer diameter for the entire length of Boot 110, which is optimized to minimize length and maximize pulling force with crimp friction. In the current embodiment, this length is on or about 35 mm, but may be adjusted as a function of plastic composition, friction between materials etc., or reduced if for instance if an epoxy, resin, or glue is employed in Boot 110 to enhance the retention force. As evident in end elevation 500A the Boot 110 has a re-entrant geometry allowing for the insertion of the cable into the Boot 110 wherein the re-entrant profile prevents its removal except by the application of force as well as to enhance the grip force in the longitudinal axis, which is the axis of the pull. The dimensions of the inner diameter of the Boot 110, the material of the Boot 110 and the degree of re-entrance of the profile are factors determining the pressure/force required to insert or remove the cable into or from the Boot 110 and therein its ability to retain the cable during the pulling operation which is also determined by the pull-force onto the puller attached to the Front 130 of the FOC-PA, where longitudinal pull force in opposite direction of the FOC is transferred from Front 130, across Body 120 of the FOC-PA onto Boot 110 of the FOC-PA which crimps onto the outer sheath of the FOC, thereby avoiding to put any stress onto the connector portion of the pre-connectorized FOC.

Referring to FIG. 6 there are depicted a bottom elevation view 600B of a FOC-PA according to an embodiment of the invention together with an end elevation 600A from the end towards the Boot 110, which is not only concentric on the inside of the FOC-PA in FIG. 5, but unlike FIG. 5, includes an additional feature on the lower (outer) surface of the Boot 110 of the FOC-PA in the form of Recess 610. The Recess 610 imparts some flexing in the Boot 110 when inserting or removing the cable from the FOC-PA which is not solely determined by the overall dimensions and material(s) of the FOC-PA. The geometry of the Recess 610 may be consistent along the length of the Boot 110 or it may vary along the length of the Boot 110. The geometry of the Recess 610 may be triangular, rectangular, or other regular or irregular geometries. Optionally, within embodiments of the invention the Recess 610 may extend along only a portion of the Boot 610 and/or it may extend along a portion of the Body 120.

Referring to FIG. 7 there is depicted a 3D perspective detailed view of a FOC-PA according to an embodiment of the invention. Accordingly, a portion of the Boot 110, the Body 120, and a portion of the Front 130 are depicted. The Slot 140 is also evident within the Boot 110 together with the Opening 150 within the Body 120. Also evident is the internal structure of the Front 130 comprising first to third Sections 710, 720 and 730 respectively, which in this instance is for an SC Connector 740 without the SC Connector outer Body 750 (as depicted in the insert). First Section 710 is dimensioned for the rear body portion of the SC Connector 740. Second Section 720 is dimensioned for the front body portion of the SC Connector 740. The third Section 730 is dimensioned to accommodate the dust cap (not shown for clarity) which is attached to the SC Connector 740 to prevent damage to the ferrule of the SC Connector 740 or the end-facet of the optical fiber.

Noting that for sake of enabling the FOC-PA to be manufactured using injection molding with a single sliding core pull, the FOC-PA may be designed with a cylindrical shape and terminated with a cap in the form of a second part, affixed by glue, by snap fit features, or other means, onto Front 130, wherein the vertical walls matching the width and height of the SC connector body tip, may be features within that additional cap rather than be formed within the FOC-PA Front 130, when such FOC-PA is made with 3D printing out of a single monocoque.

Now referring to FIG. 8 there are depicted optical micrographs of an assembly process for a FOC-PA with a fiber optical cable (FOC) and subsequent assembly with a pulling stick (puller). First and second Images 800A and 800B depict the SC Connector, for example SC Connector 740 in FIG. 7, in relation to the size of the FOC-PA both prior and after the removal of the SC connector sliding outer body, for example Body 750 in FIG. 7. Third and fourth Images 800C and 800D depict the FOC connector, in this case an SC/APC with the outer body removed, being inserted into the Opening 150 of the Body 120 of the FOC-PA. Fifth Image 800E depicts the FOC-PA with the optical cable once the optical cable has been “snapped” into the boot portion of the FOC-PA with the FOC-PA assembled onto the optical cable with a Puller attached, in this instance a fiber glass pulling stick (although other pullers may be attached). Sixth and seventh Images 800F and 800G depict the before and after of a method for hand pressing on the back side of the FOC-PA so as to force “clip” the FOC-PA Boot 110 onto the cable of the FOC (noting that this method could be automated for automatically mounting FOC-PAs onto FOCs at the factory, rather than in the field and that other methods may be employed without departing from the scope of the invention). Within the embodiment of the invention depicted in FIG. 8 the puller is attached to the FOC-PA via a threaded connection although it would be evident that other demountable or non-demountable attachment means for the connection between the puller and FOC-PA may be employed without departing from the scope of the invention.

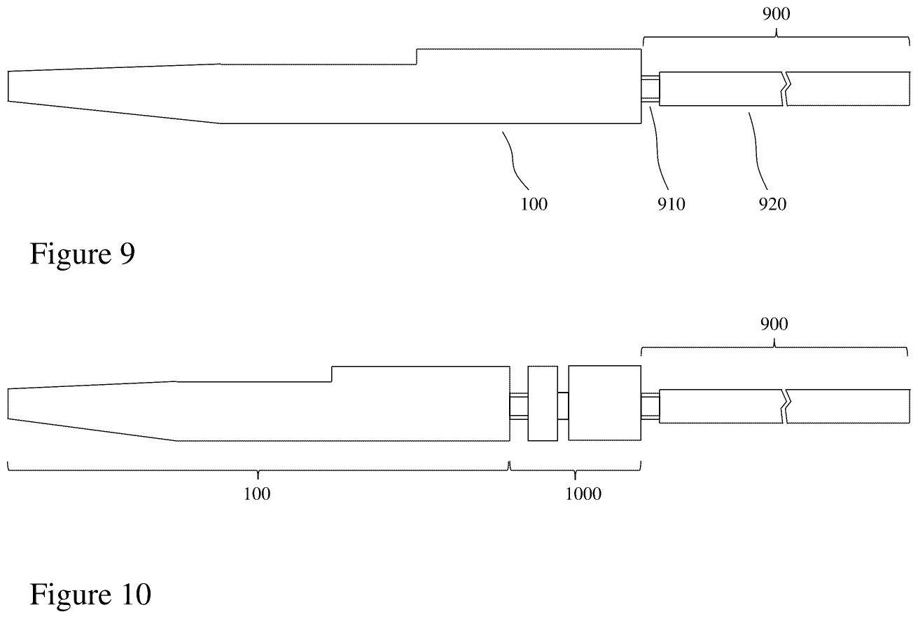

Referring to FIG. 9 there is depicted a side elevation view of a FOC-PA 100 according to an embodiment of the invention assembled with a Puller 900 which comprises Puller Body 920 and Coupling 910. The Coupling 910 mates with the Fitting 410 of the FOC-PA 100. Accordingly, for example, the Coupling 910 may be a male threaded fitting which interfaces with a female threaded Fitting 410 or vice-versa. Other demountable interfaces between the Puller 900 and FOC-PA 100 may be employed without departing from the scope of the invention.

Now referring to FIG. 10 there is depicted a side elevation view of a FOC-PA 100 according to an embodiment of the invention assembled with a Puller 900 and a Rotary Joint 1000. The Puller 900 is connected to the Rotary Joint 1000 and therein to the FOC-PA 100. The Rotary Joint 1000 mates with the Fitting 410 of the FOC-PA 100. Accordingly, for example, the Rotary Joint 1000 may connect to the FOC-PA 100 via a male threaded fitting which interfaces with a female threaded Fitting 410 or vice-versa. Other demountable interfaces between the Rotary Joint 1000 and the FOC-PA 100 may be employed without departing from the scope of the invention, such as use of the many variants of a twist-lock mechanism known to one skilled in the art.

The Rotary Joint 1000 may connect to the Puller 900 via a male threaded fitting which interfaces with a female threaded fitting on the Puller 900 or vice-versa. Other demountable interfaces between the Rotary Joint 1000 and the Puller 900 may be employed without departing from the scope of the invention.

The Rotary Joint 900 allows for relative rotation of the FOC-PA 100 with respect to the Puller 900. This allows for rotation of the FOC-PA relative to the puller as the optical cable to which the FOC-PA is attached is pulled through, such as when the optical cable is being spooled from a drum.

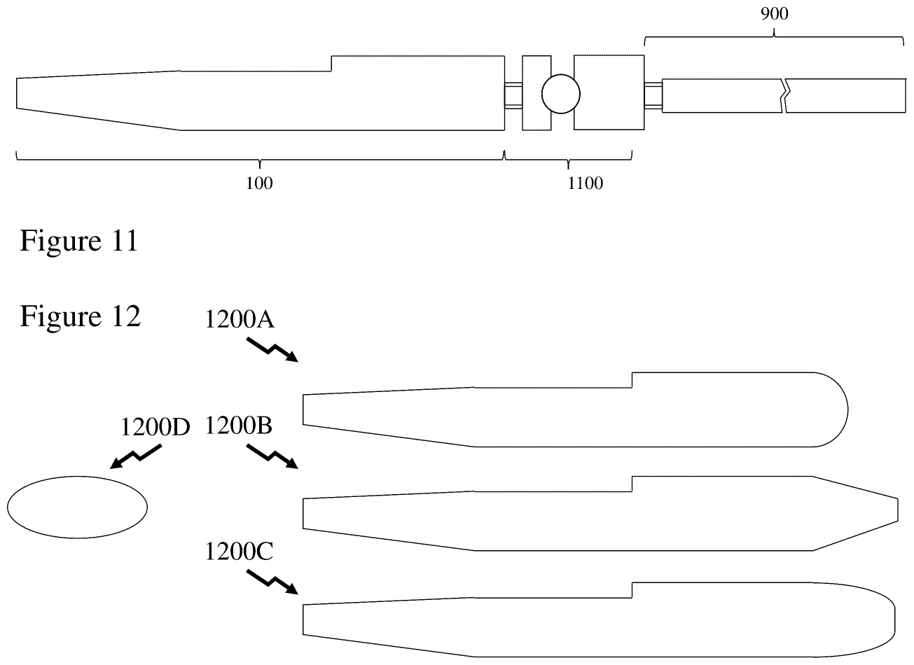

Now referring to FIG. 11 there is depicted a side elevation view of a FOC-PA 100 according to an embodiment of the invention assembled with a Puller 900 and a Ball Joint 1100. The Puller 900 is connected to the Ball Joint 1100 and therein to the FOC-PA 100. The Ball Joint 1100 mates with the Fitting 410 of the FOC-PA 100. Accordingly, for example, the Ball Joint 1100 may connect to the FOC-PA 100 via a male threaded fitting which interfaces with a female threaded Fitting 410 or vice-versa. Other demountable interfaces between the Ball Joint 1100 and the FOC-PA 100 may be employed without departing from the scope of the invention.

The Ball Joint 1100 may connect to the Puller 900 via a male threaded fitting which interfaces with a female threaded fitting on the Puller 900 or vice-versa. Other demountable interfaces between the Ball Joint 1100 and the Puller 900 may be employed without departing from the scope of the invention.

The Ball Joint 1100 allows for relative angular movement and/or rotation of the FOC-PA 100 with respect to the Puller 1100. This allows for angular movement and/or rotation of the FOC-PA relative to the puller as the optical cable to which the FOC-PA is attached is pulled through, such as when the optical cable is being spooled from a drum or for misalignments between the direction of the Puller 1100 relative to FOC-PA 100 as it is being pulled through. Ball Joint 1100 being one form of a universal joint.

Now referring to FIG. 12 there are depicted first to third side elevation views (SEVs) 1200A to 1200C respectively of FOC-PAs according to embodiment of the invention. Each of first to third SEVs 1200A to 1200C depicting exemplary profile variations for the end of the FOC-PA. End elevation view (EEV) 1200D depicts an exemplary profile variation for the cross-sectional geometry of the FOC-PA. As depicted in EEV 1200D the FOC-PA is elliptical rather than circular. Within other embodiments of the invention the pulling attachment may be rectangular, square, hexagonal, a regular polygon, an irregular polygon or other geometry. The cross-section of a pulling attachment may be uniform or non-uniform. The end of the pulling attachment with the fitting attaching the pulling attachment to the pre-terminated cable may be profiled as depicted in first to third SEVs 1200A to 1200C to reduce the likelihood of snagging upon being pulled although within other embodiments of the invention the end of the pulling attachment may be blunt.

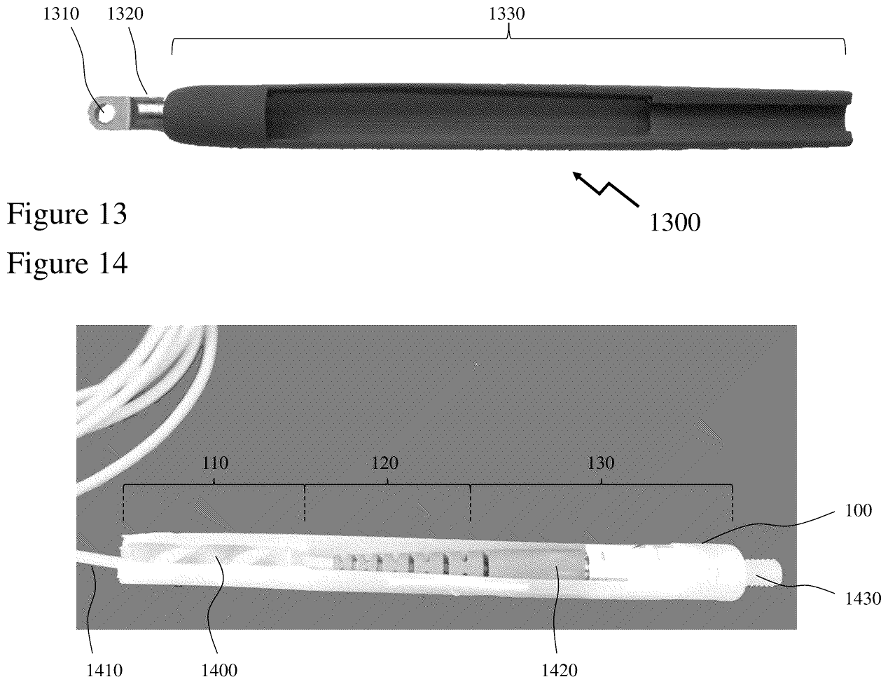

Referring to FIG. 13 there is depicted an optical micrograph of a FOC-PA 1300 according to an embodiment of the invention with an Eye 1310. The Eye 1310 is within an End 1320 disposed at the end of the FOC-POC 1300. The Body 1310 of the FOC-PA 1300 being as described and depicted within respect to FOC-PA 100 in FIG. 1. The Eye 1310 allows for the attachment to a pulling cable to the FOC-PA 1300 in contrast to the use of a threaded fitting, such as Fitting 410 in FIG. 4.

Now referring to FIG. 14 there is depicted an optical micrograph of a FOC-PA according to an embodiment of the invention. Within FIGS. 1 to 3, 8 and 13 the FOC-PAs as depicted for use upon fiber optical cable such as a 4.8 mm diameter cable for example. Such 4.8 mm or other cables comprise, for example, a 4.8 mm outer diameter jacket within which are one or more strength members (e.g., Kevlar fibers) surrounding an inner cable or buffer disposed around the optical fiber. However, in many applications the fiber optical cable is the 2 mm buffered cable fiber rather than 4.8 mm diameter cable or other cables. Such 2 mm buffered cables may be what are referred to a loose-tube, wherein the inner diameter of the 2 mm cable is larger outer diameter of the inner optical fiber, e.g. 900 μm so that the buffered fiber is “loose” within the 2 mm outer cable whereas within other cables the inner optical fiber and inner diameter of the 2 mm cable are the same or filled with another material such that the fiber optic cable is known as “tight-buffered.” However, loose-tube or tight buffered 2 mm cables are typically much softer than the thicker cable sheath of a 4.8 mm cable. Accordingly, the inventors have established a helical attachment (HELIX) 1400 for a softer smaller diameter such as a 2 mm buffered cable. Without the HELIX, it would not be possible for the re-entrant end portion of the FOC-PA 100 to clamp on a soft cable sheath.

As depicted in FIG. 14 the HELIX 1400 is wrapped around the 2 mm cable jacket (Jacket) 1410 wherein the HELIX 1400 and Jacket 1410 are then inserted into the re-entrant end portion of the FOC-PA 100 wherein the Optical Connector 1420 is retained within the end of FOC-PA 100 in FIGS. 1 to 12 which were designed for 4.8 mm cable. Accordingly, the HELIX 1400 provides for securing a 2 mm soft sheathed cable into the same FOC-PA as employed for 4.8 mm hard sheathed cables. Accordingly, the HELIX 1400 adapts between the outer 2 mm cable and the inner diameter of the Boot 130 portion as depicted in FIG. 1 of the FOC-PA 100.

Disposed at one end of the FOC-PA is a Threaded Portion 1430, representing an example of the Fitting 410 depicted in second Image 400B in FIG. 4 where the Fitting 410 is external threaded portion for attachment to a pulling stick or fitting on a cable etc. As depicted the Threaded Portion 1430 is molded as part of the FOC-PA whilst in other embodiments of the invention the Threaded Portion 1430 may be formed from another material to that of the FOC-PA, e.g., metal, around a portion of which the FOC-PA is molded. Within other embodiments of the invention the FOC-PA may be formed with a threaded opening as single piece or with an insert with a threaded opening is retained at the end of the FOC-PA through the molding process. Accordingly, FOC-PA's may be formed with a threaded end or threaded opening for use with mating threaded opening or threaded end of the pulling mechanism. Optionally, an attachment may be employed between the FOC-PA and pulling mechanism.

Within other embodiments of the invention the FOC-PA 100 is designed for 2 mm cable, i.e., the Boot 130 portion has an inner diameter specified by the 2 mm cable rather than a larger inner diameter for use upon 4.8 mm cable, wherein a HELIX 1400 may allow a FOC-PA 100 to be used with 900 μm and 2 mm fiber optical cables.

Within other embodiments of the invention the FOC-PA 100 is designed for 4.8 mm cable, i.e., the Boot 130 portion has an inner diameter specified by the 4.8 mm cable, wherein a HELIX 1400 may allow a FOC-PA 100 to be used with 900 μm and 4.8 mm fiber optical cables. Accordingly, two different HELIX 1400 designs, one designed for 900 μm fiber optical cables and another for 2 mm fiber optical cables, may allow a single FOC-PA 100 design to manage 900 μm, 2 mm, and 4.8 mm fiber optical cables.

Whilst the embodiments of the invention are described with respect to exemplary cable geometries, e.g., 900 μm, 2 mm, and 4.8 mm, it would be evident that other embodiments of the invention may be designed to support other cable geometries.

The HELIX 1400 allows for FOC-PAs according to embodiments of the invention to pull fiber optic pre-terminated cables which have a soft sheath and which therefore cannot be crimped into the U-clamp portion, i.e., Body 130 of FOC-PA 100, of the FOC-PA. Within embodiments of the invention the HELIX 1400 provides friction against the fiber optic cable wherein the HELIX 1400 retains the fiber optic cable within the FOC-PA. Embodiments of the invention provide a gripping force in excess of 25 pounds.

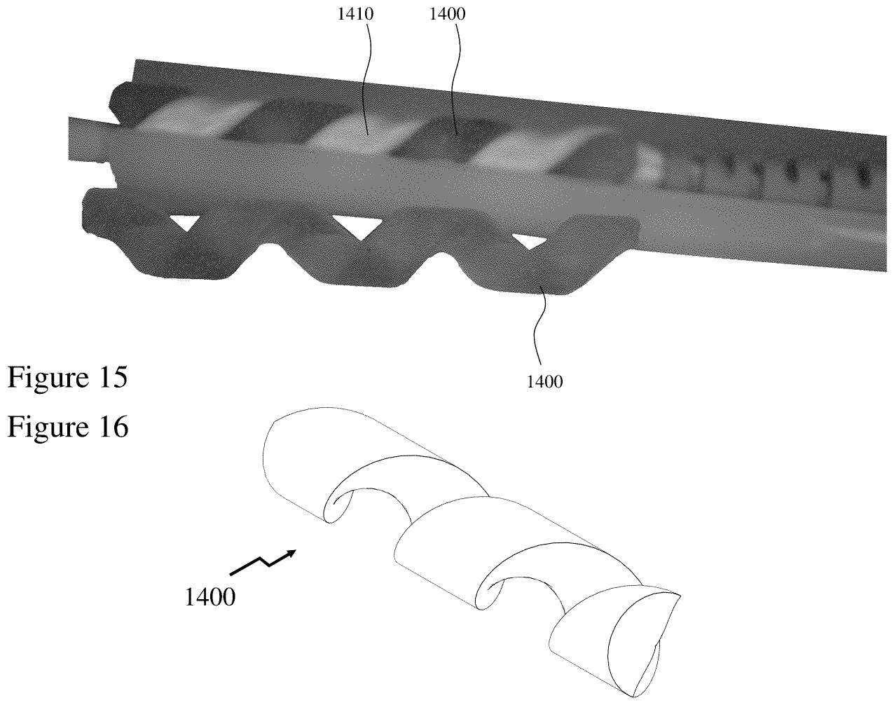

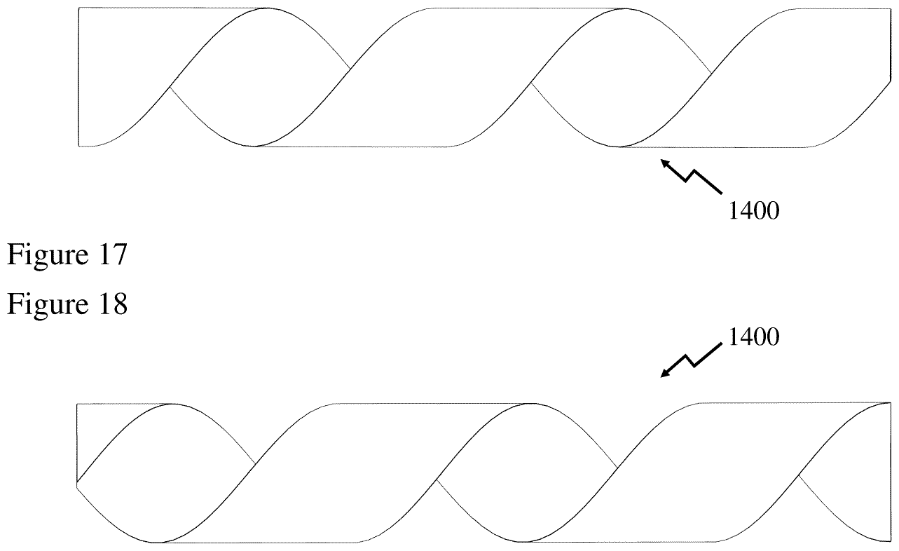

Referring to FIG. 15 there is depicted an optical micrograph of a HELIX 1400 in the foreground with an assembled FOC-PA with HELIX 1400 upon a 2 mm cable 1410. An exemplary perspective CAD image of a HELIX 1400 according to an embodiment of the invention is depicted in FIG. 16 whilst FIGS. 17 and 18 depict plan and front elevation CAD images of the HELIX 1400 according to embodiments of the invention.

Within embodiments of the invention the HELIX 1400 has an inner diameter defined by the outer diameter of the cable to which it is intended to mount and an outer diameter defined by the inner diameter of the FOC-PA. For example, the inner diameter may be 2 mm and the outer diameter 4.8 mm or that of the inner diameter of the Boot 130 of the FOC-PA 100. Within another example the inner diameter may be 900 μm and the outer diameter 4.8 mm or that of the inner diameter of the Boot 130 of the FOC-PA 100. Accordingly, with these embodiments of the HELIX the same FOC-PA can support 900 μm, 2 mm and 4.8 mm cables. It would be evident that other designs of the HELIX and/or FOC-PA designs would allow other cables to be accommodated within one or more FOC-PA designs.

Within embodiments of the invention the HELIX may “expand” upon assembly to the cable, which is accomplished by rotation of the HELIX relative to the cable. According to the characteristics of the material(s) selected for the HELIX this “expansion” in the inner diameter may be accompanied by a reduction in length of the HELIX and/or a reduction in thickness of the HELIX.

Within embodiments of the invention the material(s) of the HELIX may be deformable such that the HELIX when assembled onto a cable is compressed upon insertion into the FOC-PA to provide increased surface contact between the FOC-PA and cable via the HELIX for friction based retention with absorption of compression forces external to the FOC/PCA and/or compliance of the HELIX to variances in the cable and/or FOC-PA.

Within embodiments of the invention a HELIX may be assembled onto a cable when the cable is to be pulled and removed subsequently. Within other embodiments of the invention the HELIX may be disposed of post-use being intended for one-time use. Within other embodiments of the invention the HELIX once assembled on the cable the HELIX may be left in place. Within other embodiments of the invention a HELIX may be pre-assembled onto a cable when connectorized such that field installation of the HELIX is not required.

Whilst within FIGS. 14 and 15 the HELIX is depicted as disposed between the Cable 1410 and the Boot 110 of the FOC-PA it would be evident that the HELIX may alternatively be disposed between the Cable 1410 and the Body 120 of the FOC-PA. Optionally, within other embodiments of the invention the HELIX may extend along the Cable 140 and be within the Boot 110 and Body 120 portions of the FOC-PA.

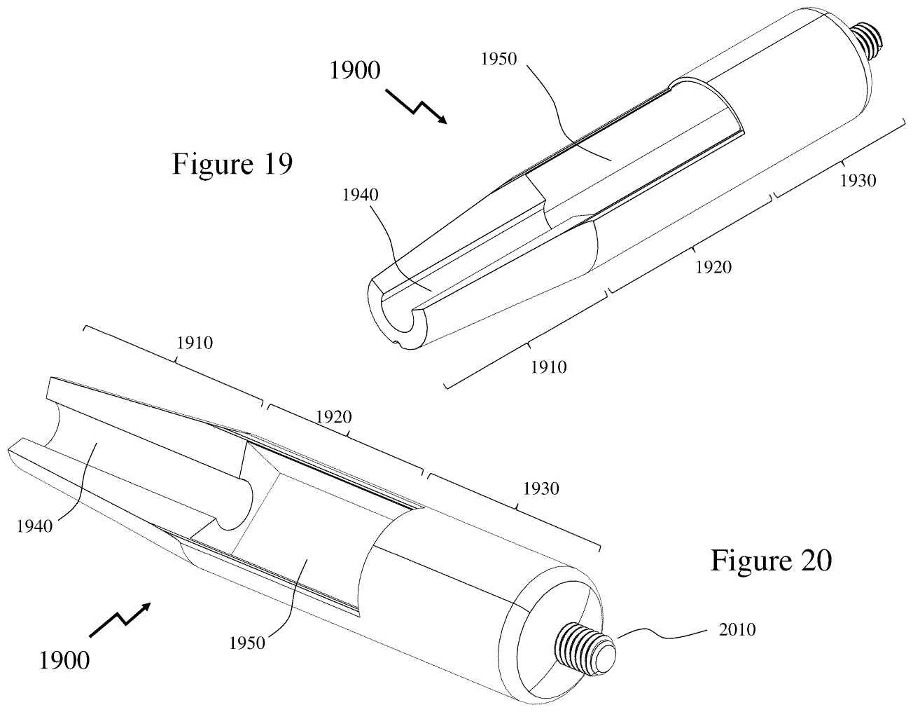

Now referring to FIGS. 19 to 22 there are depicted perspective CAD images of an electrical cable (EC) PCA (EC-PA) 1900 according to an embodiment of the invention. The design of the EC-PA 1900 is in similar to that of the FOC-PA 100 described and depicted above. As depicted the EC-PA comprises three-sections, Boot 1910, Body 1920 and Front 1930. The Boot 1910 is designed in dependence upon the outer diameter of the electrical cable (EC) it is designed to be attached to so that the EC-PA 1900 is retained in position based upon the engagement of the Boot 1910 with the EC (not depicted for clarity). For example, the outer diameter may be 2.8 mm (0.11″), 5.0 mm (0.195″) or 9 mm (0.35″) etc. according to the cable specification as well as factors such as pulling load capability, crush resistance, bend insensitivity, self-bend limiting capabilities, etc. The EC being pre-terminated with an electrical connector such as a Sub-Miniature version A (SMA) connector, a 2.92 mm connector (also known as a K connector), a 2.4 mm connector, a 1.85 mm connector (also known as a V connector), Sub-Miniature version B (SMB) connector, a Bayonet Neill-Concelman (BNC) connector, a 1 mm connector (also known as a W connector) etc. Other connectors such as Registered Jack (RJ) 45 (RJ-45) for Ethernet, High-Definition Multimedia Interface (HDMI), Mini-HDMI, Micro Universal Serial Bus (USB), Mini USB, Apple™ Lightning, USB Type C, RJ-11 for Digital Subscriber Line (DSL), etc. may also be employed.

The electrical connector may also be an entire transceiver body within other embodiments of the invention, such as those conformant to the Small Form Factor Pluggable (SFP) specifications of the Storage Networking Industry Association (SNIA) for example, such as found on direct-attached cables and active optical cables. The SFP transceiver head of the active optical cable which would be encapsulated within the cavity 150 of the FOC-PA 100 or the cavity 1950 of the EC-PA 1900.

HDMI active optical cables are variants of active optical cables incorporating an optical transceiver inside the pre-terminated cable head with its HDMI connector, which would be encapsulated within the cavity 150 of the FOC-PA 100 or the cavity 1950 of the EC-PA 1900.

The connector is inserted into an Opening 1950 in Body 1920, allowing the connector to partially or fully enter a cavity in the Front 1930 of the EC-PA, and then subsequently allow for the cable portion of the EC to be crimped into a Slot 1940 in the Boot 1910 section of the EC-PA. The boot of the connector such as an SMA connector, not depicted for clarity, is retained within the Body 1920 of the EC-PA and the connector portion of the FOC is retained in a portion of the Front 1930 of the EC-PA. The Opening 1950 in the Body 1920 being dimensioned in dependence upon one of the boot and of electrical connector on the end of the EC. The Slot 1940 being dimensioned to a predetermined EC diameter. It would evident that within embodiments of the invention the EC-PA may be employed with a HELIX to allow the EC-PA to support multiple EC diameters.

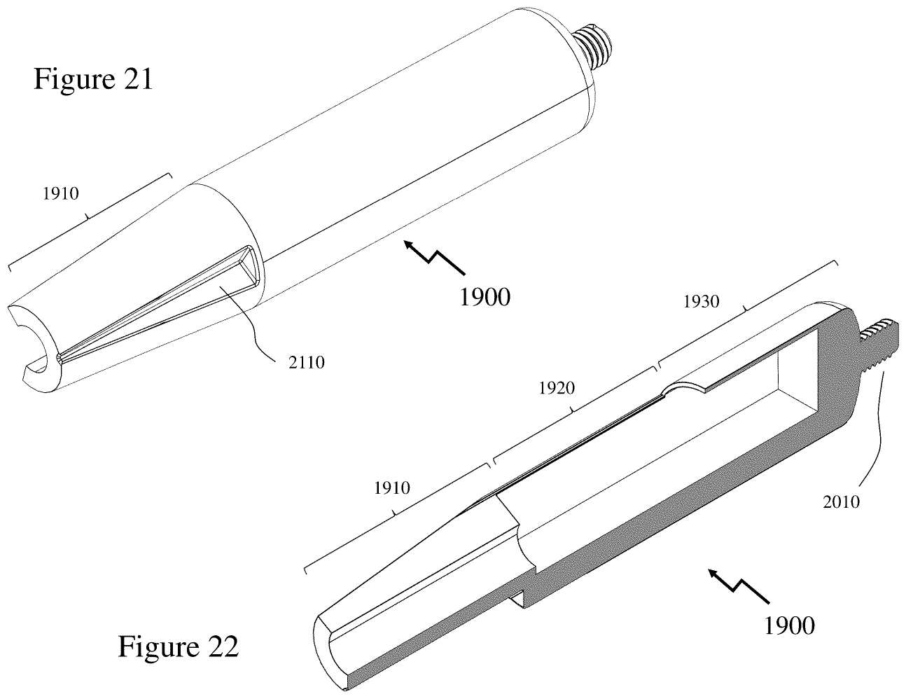

As evident from FIG. 21 the lower outer surface of the Boot 1910 contains a shaped Recess 2110 which allows the Boot 1910 to deform as the cable of the EC is inserted (i.e., “snapped” or “clipped” into the Boot 1910). Within other embodiments of the invention the Boot 1910 for ECs may omit the Recess 2110.

Referring to FIG. 22 there is depicted a perspective cross-section of an EC-PA 1900 depicting the Boot 1910, Body 1920 and Front 1930. As evident in FIG. 22 the Front 1930 allows for a portion of the electrical connector to fit within the Front 1930. This portion of the electrical connector may, within embodiments of the invention, include a dust cap which is fitted over the electrical connector. The outer diameter of the Front 1930 being dimensioned to be larger than the dimensions of the electrical connector such that the electrical connector is within the footprint of the EC-PA.

Within the variant of the EC-PA depicted in FIG. 22 the EC-PA includes a threaded external portion 2010 for attachment of a pull-stick or other means for pulling the EC-PA through a bore within an element the EC is to go through.

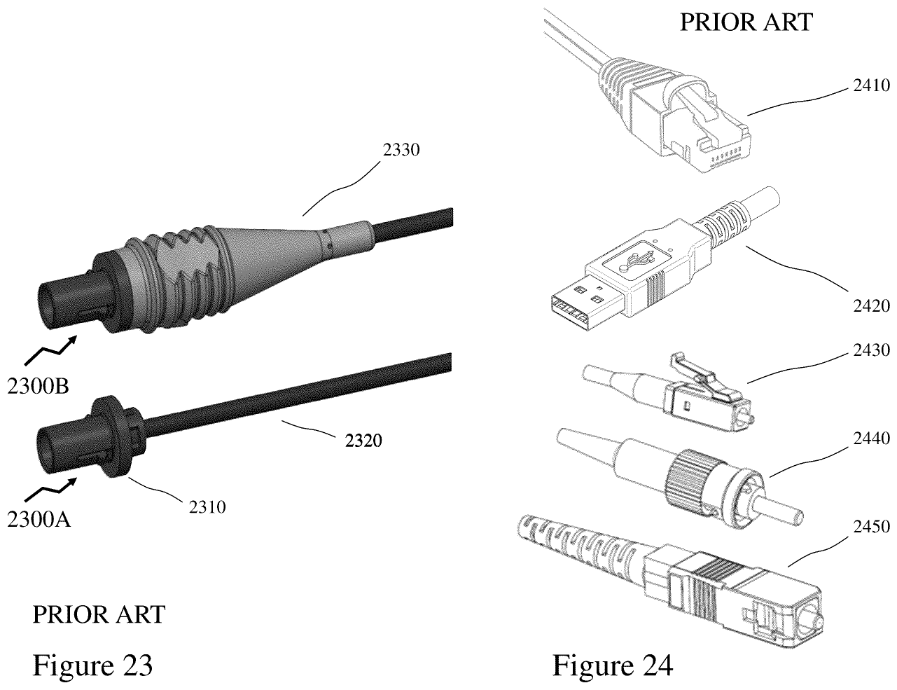

Referring to FIG. 23 there are depicted first and second exemplary images of over-molding a connector boot to a connector according to the prior art. In first Image 2300A a Connector 2310 is depicted assembled onto a Cable 2320. Second Image 2300B depicts the assembly after over-molding of a Connector Boot 2330. The over-molded material for the Connector Boot 2330 typically chemically bonds to the outer jacket material of the Cable 2320 to provide sealing and fluid ingress protection. The Connector Boot 2330 typically provides an attractive shape, incudes ribs to provide a nonslip grip of the connector, and provides a measure of bend limiting for the cable close to the connector. In some instances, the Connector Boot 2330 may be formed in two parts within an inner mold formed from a first material and a second outer mold formed from a second material. Exemplary materials for the Connector Boot 2330 are typically thermoplastics where the exact choice of material or materials is driven by a number of factors including, but not limited to, appearance, feel, environmental factors and compatibility with the connector and cable jacket materials. Commonly used thermoplastics for over-molding include Polyvinyl Chloride (PVC), Thermoplastic Vulcanizate (TPV), Acrylonitrile Butadiene Styrene (ABS), Low-Density Polyethylene (LDPE), High-Density Polyethylene (HDPE), Polypropylene (PP), Polyamide (nylon), and Thermoplastic Polyurethane (TPU). However, in other instances other materials such as thermoset materials may be employed. FIG. 24 depicts exemplary images of optical and electrical connectors with over-molded connector boots comprising CAT Ethernet 2410, USB 2420, LC 2430, Ferrule Connector (FC) 2440, and SC 2450.

Within the preceding embodiments of the invention the retention of the cable assembly within the FOC-PA or EC-PA was via friction or physical retention of the cable within the boot portion of the FOC-PA or EC-PA cither directly or via an intermediate HELIX such that the force from the pulling attachment onto the pre-terminated cable (PC) is directed to the cable and not the head of the connector. However, the inventors have also established variants of a Pulling Attachment (PA) where the connector is retained by a combination of the front portion, e.g., Front 1930 of EC-PA 1900 or Front 130 of FOC-PA 100. It is worth noting at this point that the differentiation between FOC-PA and EC-PA is simply from a description of embodiments of the invention point of view as an EC-PA with appropriate dimensions may work with a FOC and a FOC-PA with appropriate dimensions may work with an EC.

Within these embodiments of the invention the force from the pulling attachment onto the PC is directed to the connector boot and not directly onto the head of the connector. When the connector boot of the PC is bonded to the outer PC sheath, applying forward pulling force onto the FOC-PA or EC-PA effectively transfers the force to the PC sheath without needing for the FOC-PA or EC-PA to make use of the friction in the re-entrant U cavity (e.g. Slot 140 in FOC-PA 100 or Slot 1940 in EC-PA 1940) of the FOC-PA or EC-PA. In this new embodiment, the force is transferred to the PC sheath through the connector boot which is bonded onto the sheath. The re-entrant U cavity of the FOC-PA or EC-PA then becomes a simple cable guide for convenience and within embodiments of the invention has no effect in transferring the pulling force onto the PC unlike the embodiments of the invention described with respect to FOC-PA 100 and EC-PA 1900 for example. However, within other embodiments of the invention the re-entrant U cavity of the FOC-PA or EC-PA may also provide part of the overall transfer of the pulling force to the sheath of the PC such as with FOC-PA 100 and EC-PA 1900 for example. Such embodiments may support use with PCs with multiple designs where in some designs the connectors have bonded connector boots and in other designs they do not.

The inventors have demonstrated that this new embodiment may allow pulling forces in excess of 75 pounds (approximately 34 kilograms) to be transferred by the FOC-PA or EC-PA onto the PC sheath through the PC connector boot. Such pulling forces are in excess of three times that specified for a UTP cable by the American National Standards Institute (ANSI)/Telecommunications Industry Association (TIA) ANSI/TIA-568 (T-568) standard. Accordingly, it would be evident that mechanisms to engineer deliberate “failure” (pulling force limiting) mechanisms within an FOC-PA or EC-PA may be appropriate to avoid pulling forces in excess of one or more standards being applied to the PCs.

For example, such a pulling force limiting mechanisms (e.g., to prevent a pulling force exceeding 25 pounds being applied to a UTP cable per the T-568 standard) added to a PA according to embodiments of the invention may be through engineering a an external threaded Fitting 410 (see second Image 400B in FIG. 4) or threaded fitting on a pulling means coupled to an internal threaded Fitting 410 (see first Image 400A in FIG. 4) to shear at pulling forces exceeding 25 pounds such that the Fitting 410 is disengaged.

Within other embodiments of the invention other a pulling force limiting mechanisms may be engineered allowing a portion of the FOC-PA of EC-PA, e.g. Front 130 of FOC-PA 100 or Front 1930 of EC-PA 1900 to detach from the remainder of the FOC-PA or EC-PC when a pulling force exceeds an engineered value, such as the 25 pounds limit for UTP cables in the T-568 standard. This may be implemented in different manners as would be apparent to one skilled in the art including, but not limiting to, thinning one or more features in the molding of the front and/or body portions of the FOC-PA or EC-PA to a define not only a defined pulling force limit but a defined detachment point.

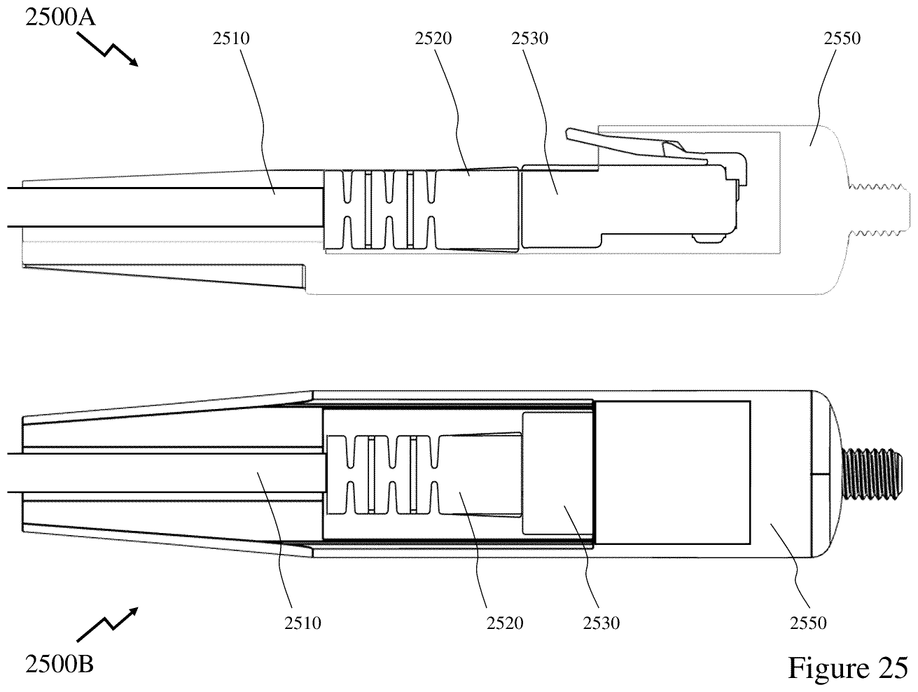

Referring to FIG. 25A there are depicted cross-section and plan views 2500A and 2500B respectively of an exemplary EC-PA 2550 with an Ethernet connector comprising according to an embodiment of the invention wherein the EC-PA 2550 engages against the connector boot to retain the connector rather than the cable and force from the pulling attachment is directed to the connector boot. The EC-PA 2550 when pulled engages against the Connector Boot 2520 over-molded to the Ethernet Connector 2530 and Cable 2510. The Ethernet Connector 2530 being retained with the front portion of the EC-PA 2550, e.g., Front 1930 of EC-PA 1900 in FIGS. 19-20 and 22, respectively.

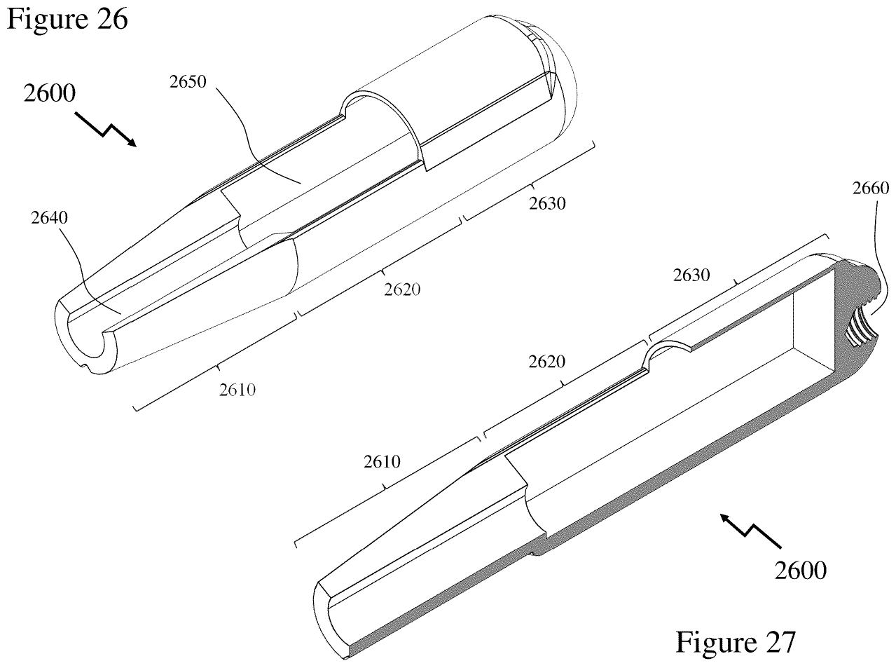

Now referring to FIGS. 26 and 27 there are depicted perspective and cross-sectional perspective views respectively of a pulling attachment (PA) 2600 according to an embodiment of the invention wherein the PA engages the rear of the connector (not shown) to retain the connector during a pulling operation. PA 2600 being an example of EC-PA 2550 in FIG. 25. The PA 2600 comprising a Front 2630, Body 2620 and Boot 2610. Within the Boot 2610 is a Slot 2640 within which the cable of the EC or FOC fits but is not retained as with the FOC-PA 100 and EC-PA 1900 in FIGS. 1 and 19, respectively. The inner of the Front 2630 and Body 2620 is Recess 2650 within which the connector and boot of the electrical connector (or fiber optic connector) fits. The rear of the connector boot of the electrical connector (or fiber optic connector) is pushed against the interior portion of the PA 2600 where the Body 2620 transitions to the Boot 2610.

Within PA 2600 the Slot 2640 within the Boot 2610 is designed to be larger than the cable. However, within other embodiments of the invention the Slot 2640 may be designed to fit against the cable as discussed and depicted above with respect to FOC-PA 100.

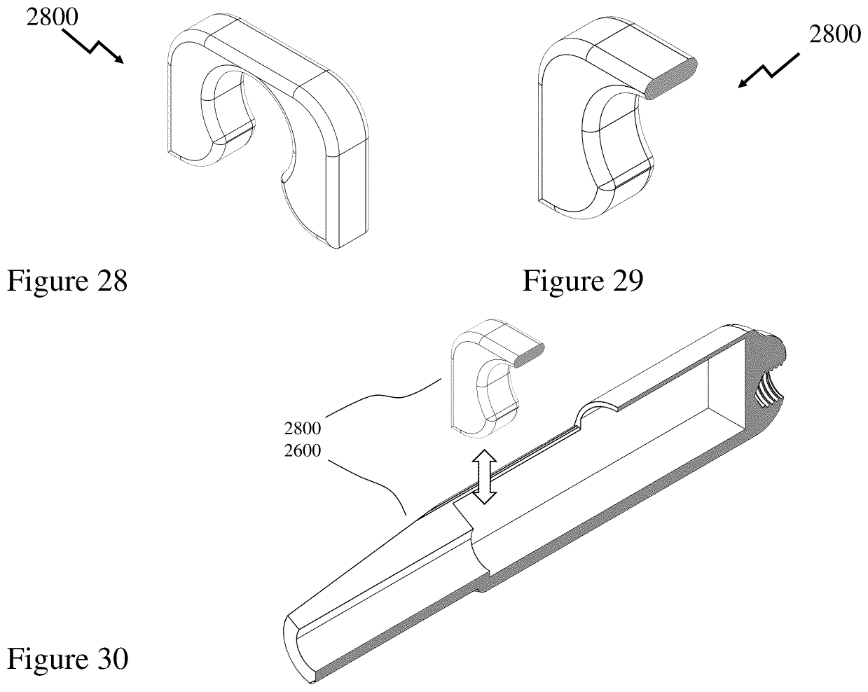

In order to retain the boot of the connector and cable in position within the PA 2600 the inventors have established a Retaining U-Component (RUC) where FIGS. 28 and 29 depict perspective and cross-sectional perspective views of a RUC according to an embodiment of the invention for use in conjunction with a PA as depicted in FIGS. 26 and 27, respectively. FIG. 30 depicts a cross-section exploded view of the RUC and PA wherein it is evident that the RUC is intended to be pushed over the boot and/or cable of the EC or FOC used in conjunction with the PA 2600 or other PAs according to other embodiments of the invention.

The RUC is an optional spacer which may be employed discretely or in multiples to ensure that the PC boot remains fully inserted into the FOC-PA or EC-PA and cannot slip backward as the pulling force is transferred onto the PC sheath. The RUC whilst not a required element does help with the conflicting design tradeoff for the FOC-PA or EC-PA between having a cavity which is large enough to ensure easy insertion of the PC connector into the FOC-PA or EC-PA, whilst securing the PC into the FOC-PA or EC-PA in its maximally forward position without there being any significant gap at the back of the PC boot portion which would allow for the PC to slip back under forward motion. The RUC negates this slipping back as within embodiments of the invention where there is no frictional retention of the PC into the FOC-PA or EC-PA via the re-entrant U-clamp, which is acting simply as a cable guide, which prevents the PC from slipping back under forward pulling force.

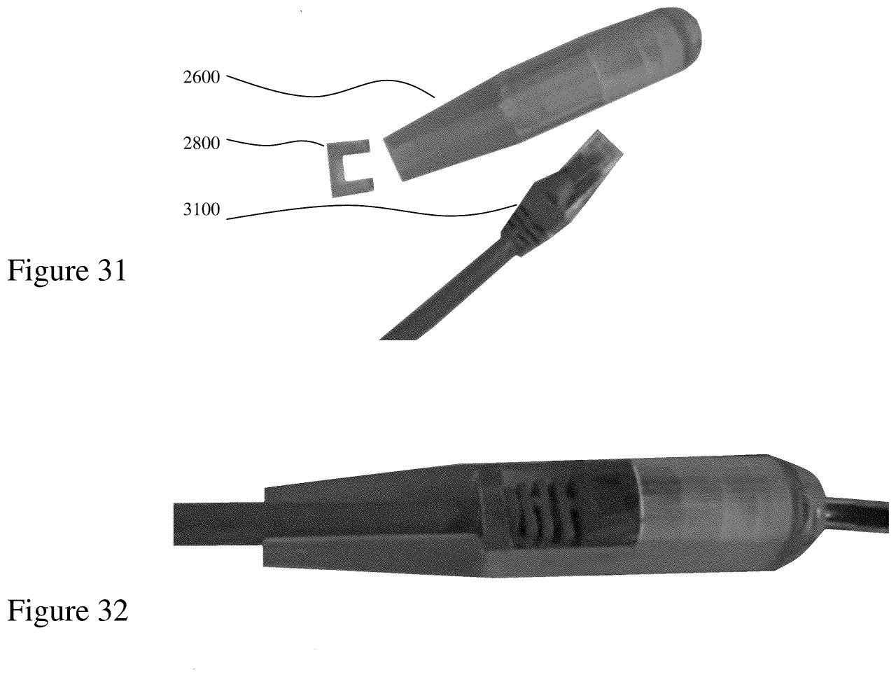

Accordingly, the user inserts the connector into the PA and then pushes the RUC over. This assembly being depicted in FIGS. 31 and 32 where an RUC 2800, PA 2600 and UTP Ethernet cable assembly (UTP-CA) 3100 are depicted unassembled and assembled, respectively. Within FIG. 32 the RUC 2800 is evident assembled over the UTP-CA 3100 and fitting at the rear of the body portion of the PA 2600. Removal of the UTP-CA 3100 by pulling may release the RUC 2800 or this may be removed discretely prior to the removal of the UTP-CA 3100.

Within FIGS. 14 to 18 there are depicted images of a helical attachment (HELIX) 1400 according to embodiments of the invention wherein the HELIX 1400 is employed as a dimensional attachment between the inner body of a pulling assembly (PA) and the outer diameter of a cable, e.g. a fiber optic cable, electrical cable, coaxial cable etc. The inventors have extended the concept further to establish a helical pulling attachment (HELI-PA) according to an embodiment of the invention.

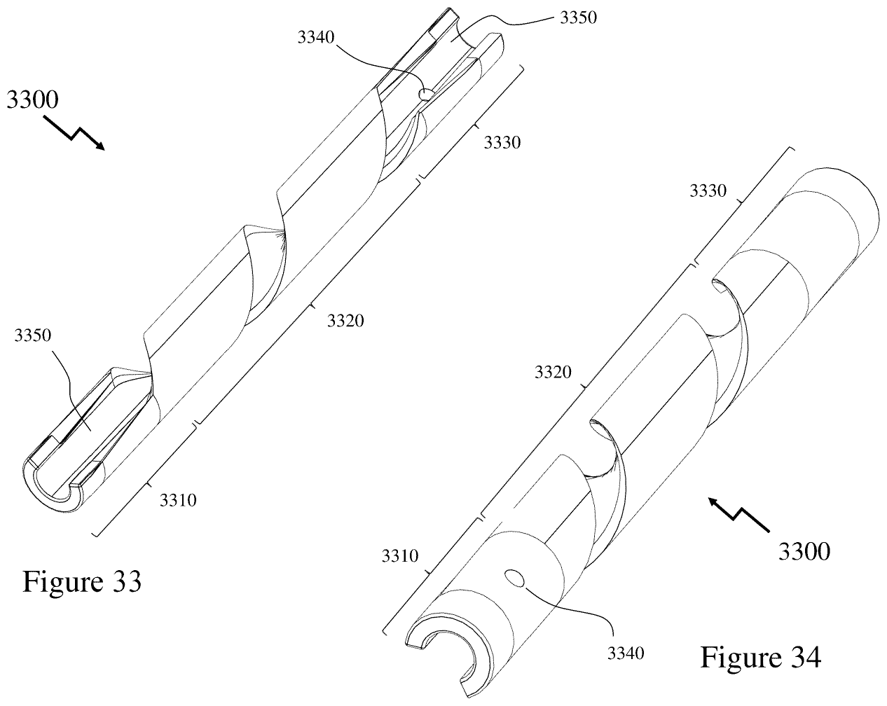

Accordingly, referring to FIGS. 33 and 34 there are depicted upper left and lower right perspective views respectively of an inline helical pulling attachment (HELI-PA) 3300 according to an embodiment of the invention. As depicted the HELI-PA 3300 comprises a first end Portion 3310, a central Portion 3320 and a second end Portion 3330. The central Portion 3320 comprises a helical member with a U-groove or re-entrant U-groove into which the cable is wound. The first and second end Portions 3310 and 3330 each comprise a central Groove 3350 within which the cable sits when the HELI-PA 3300 is attached to the cable. The central Grooves 3350 at the two distal ends is preferably re-entrant allowing the cable to snap into the groove. The central Grooves 3350 extend into the central portion 3320 such as to provide a smooth transition between the helical groove and the central Grooves 3350. Within second end Portion 3330 a Hole 3340 is disposed to support the attachment of a pulling mechanism, e.g. a string, fishing line, etc.

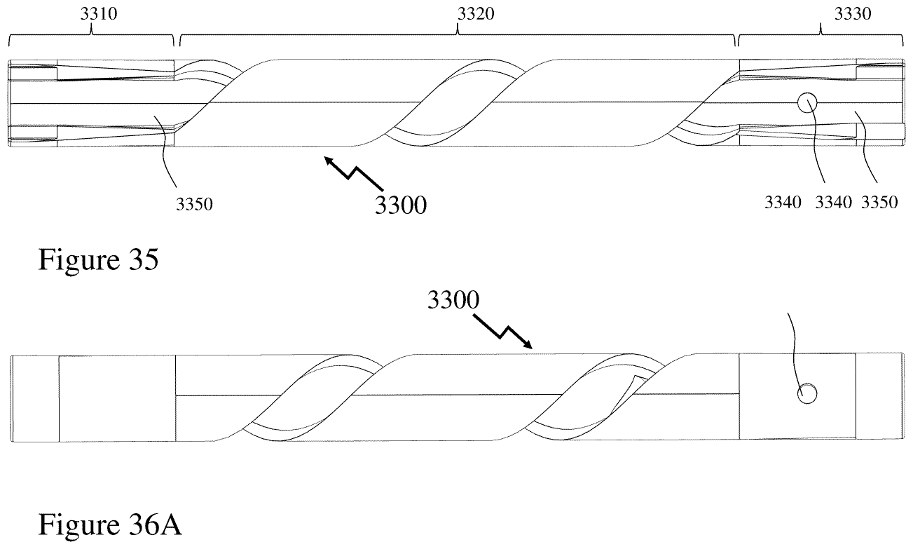

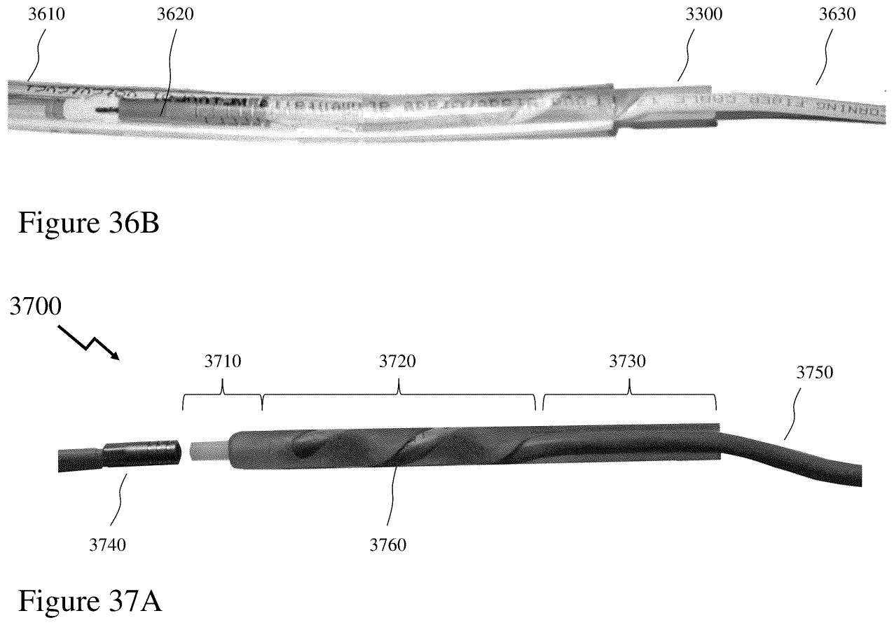

Referring to FIGS. 35, 36A and 36B there are depicted plan and bottom views the inline HELI-PA 3300 according to an embodiment of the invention as depicted in FIGS. 33 and 34. In FIG. 36B the inline HELI-PA 3300 according to an embodiment of the invention as depicted in FIGS. 33-36 is depicted in use. In this image a cable terminated with a SC connector Sub-Assembly 3620 is being pulled within a clear 9.5 mm (⅜ inch) inner diameter Tube 3610 where the inline HELI-PA 3300 is attached via the Hole 3340 to fishing line (not visible as transparent filament) to pull the HELI-PA 3300 through the Tube 3610. The HELI-PA 3300 being attached to the Cable 3630 which is terminated with the SC connector Sub-Assembly 3620. Because the pre-terminated cable 3630 is being pulled into a tube of small diameter, there is no need to hold the connector in a cavity in head of the PA as described in other embodiments of the invention.

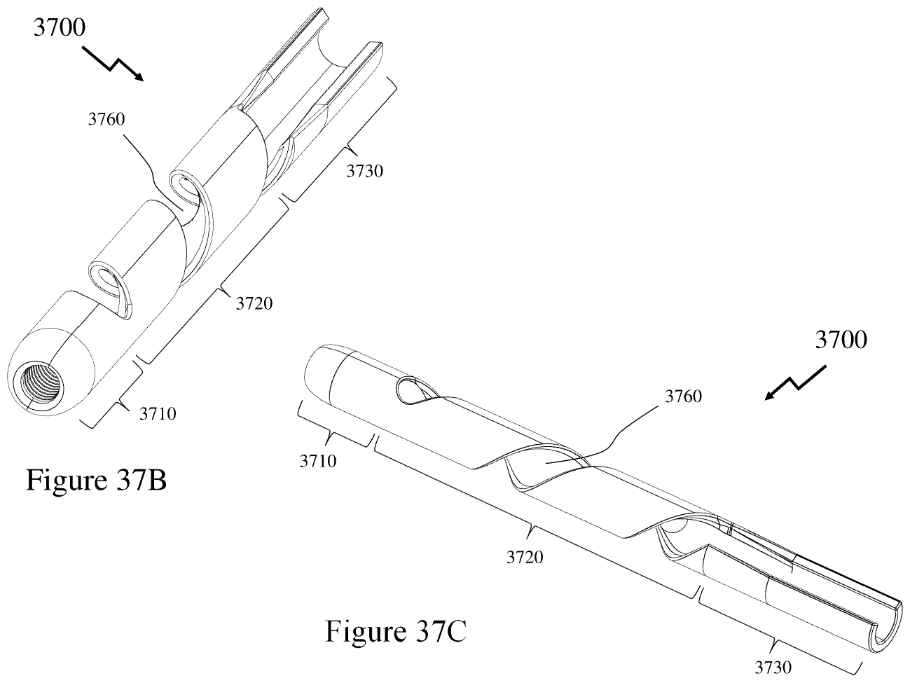

Now referring to FIGS. 37A, 37B and 37C respectively there is depicted a HELI-PA 3700, according to an embodiment of the invention. As depicted in FIG. 37A the HELI-PA 3700 comprises a Threaded Head 3710 ready for attachment to a pulling Stick 3740. Accordingly, the HELI-PA 3700 rather than being inline and having two re-entrant U-grooves, in both the first end Portion 3310 and second end Portion 3330 as depicted with HELI-PA 3300 in FIG. 33, the HELI-PA 3700 now has the Cable 3750 terminating in a cavity in the Threaded Head 3710 of the HELI-PA 3700.

A UTP Cable 3750, for example, is wound in the Helical Groove 3760 in Body 3720 of the HELI-PA 3700. The UTP Cable 3750 is then “clamped” into the Boot 3730 of the HELI-PA 3700 in a re-entrant U-groove. The depth of the Helical Groove 3760 may be configured to be deeper than the center of the HELI-PA 3700 at a depth set to provide a relaxation of the grip force to a predetermined threshold value, for example 25 pounds (11.3 kg). This predetermined threshold value being the maximum force permitted in the ANSI T-568 standard for pulling on Ethernet UTP cables. Accordingly, pulling harder than 25 pounds (11.3 kg) will cause the cable to slip out of the HELI-PA 3700 such that the maximum pulling force is not exceeded. Other threshold values may be set by other standards etc. The outer diameter of the HELI-PA 3700 can thus be reduced relative to other embodiments of the invention.

In the embodiment of the invention depicted in FIG. 37A, the outer diameter of the HELI-PA 3700 as manufactured by the inventors is 8.85 mm (0.35″), with the Helical Groove 3760 being established deeper than the center of the HELI-PA 3700 and thus sufficiently deep to allow a 6 mm (0.24″) diameter UTP cable to be inserted and sit fully “buried” inside the helical U-groove upon being wound into the Helical Groove 3760 of the HELI-PA 3700

Alternatively, within other embodiments of the invention the limiting depth of the Helical Groove 3760 to the diameter of the Cable 3750 in a HELI-PA 3700 which would have an outer diameter twice that of the cable has been proven to provide a grip of more than 25 pounds (11.3 kg), which is excessive for pulling on UTP cables and exceeds the ANSI T-568 standard.

The configuration depicted in FIGS. 37A, 37B and 37C may also be configured for optical fiber cables rather than electrical cables. In such instances threshold value of the force, pulling force, may be set at a higher value than 25 pounds (11.3 kg) by setting the depth of the Helical Groove 3760 accordingly to the depth that intersects with the center of the HELI-PA 3700, at which point the grip would be maximal.

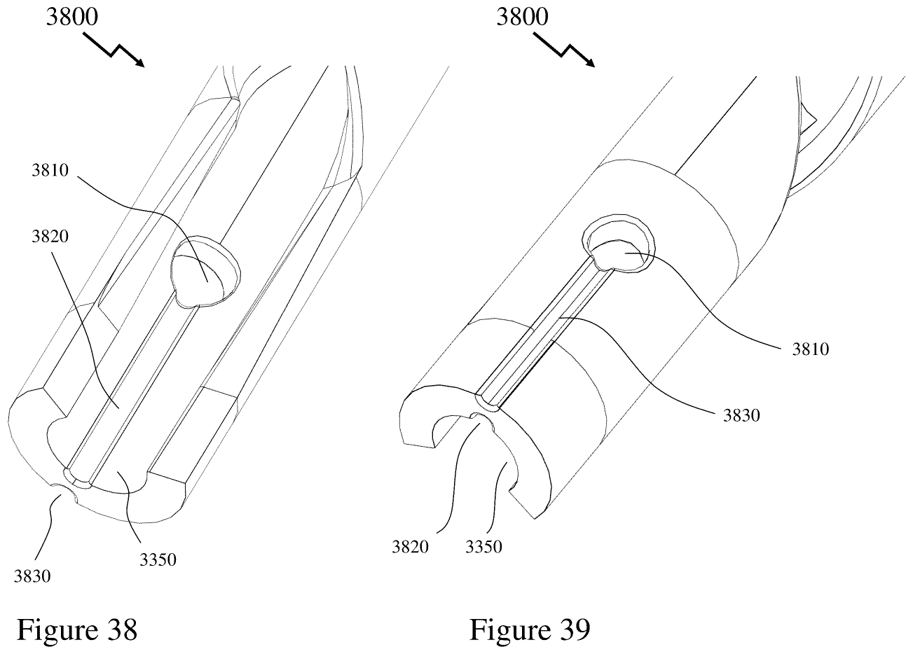

Now referring to FIGS. 38 and 39 there are depicted upper and lower perspective views of an end of a HELI-PA 3800 according to an embodiment with grooves for the pulling cable to fit within. The end of the HELI-PA 3800 being the second end Portion 3330 for example in FIG. 33. Accordingly, on the inside of the HELI-PA 3800 an Inner Groove 3820 is formed which accepts the pulling mechanism, e.g. a string, fishing line, etc., so that its footprint within the Groove 3350. Similarly, on the outside of the HELI-PA 3800 an Outer Groove 3830 is formed which accepts the pulling mechanism, e.g. a string, fishing line, etc., so that its footprint outside of the HELI-PA 3800 is reduced. Furthermore, the Outer Groove 3820 and 3830 allows for the string or fishing line to slit through the groove if pulling too hard and the depth of these grooves serve to set the strength of the material left between the grooves to retain the string to the HELI-PA 3800 through the Hole 3810.

Within other embodiments of the invention both ends of the HELI-PA may be configured with Holes 3340 discretely or in combination with Inner and/or Outer Grooves. The Holes 3340 and the Grooves 3820 and 3830 may be rectangular to accommodate a mule tape for instance. Within other embodiments of the invention an end or ends of the HELI-PA may incorporate a tab with a hole for the attachment of the pulling mechanism rather than it being within a portion of the HELI-PA engaging against the cable. Such a tab may, for example, resemble a ring terminal as known in the art.

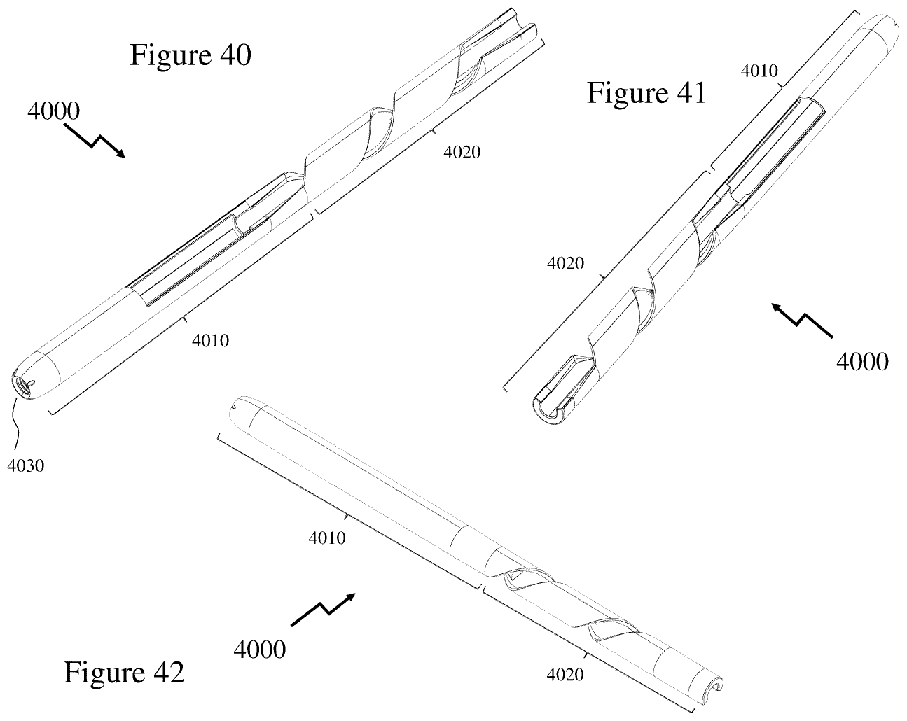

Referring to FIGS. 40 to 42 there are depicted perspective views of a pre-terminated fibre-optic cable pulling attachment (PA) according to an embodiment of the invention with a helical retention for the cable (referred to as a PA-HELR). Accordingly, within FIGS. 40 to 42 a pulling attachment with helical retention (PA-HELR) 4000 is depicted comprising a Body Portion 4010 and a Helical Portion 4020. The Body Portion 4010 may be as described above in respect of Pulling Attachments (Pas) according to embodiments whilst the Helical Portion 4020 acts in a similar manner to a HELI-PA, such as HELI-PA 3300 in FIGS. 33 to 37 or HELI-PA 3800 in FIGS. 38 and 39. As depicted the Body Portion 4020 includes a Threaded Hole 4030 for the attachment of a pulling means. The boot portion 4030 will preferably include a re-entrant U-groove allowing the cable to be retained snapped into place. The central grooves of the Body portion 4010 and the boot portion 4030 are extended into Helical Portion 4020 to provide a smooth transition of the cable wound in and out the Helical Portion 4020.

Within another embodiment of the invention the Helical Portion 4020 may include a hole, such as Hole 3340 within FIGS. 33 to 36 allowing the attachment of a second pulling means such that should an issue arise with the pulling means attached to the Body Portion 4010 to pull the PA-HELR 4000, and the cable/connector it is attached to, through a hole, tube etc. then the second pulling means can be employed to pull the PA-HELR 4000 and the cable/connector it is attached to back through the hole or tube in the reverse direction. For example, the pulling means attached to the Body Portion 4010 may be a threaded rod, for example, whilst the second pulling means attached to the Helical Portion 4020 is fishing line, for example.

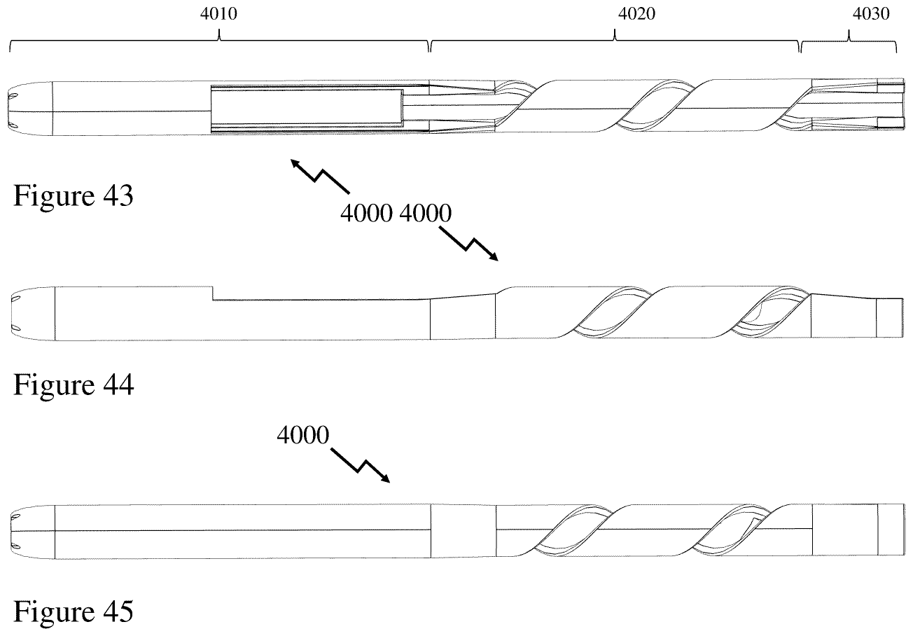

Now referring to FIGS. 43 to 45 there are depicted top, front, and bottom views of the PA-HELR 4000 according to the embodiment of the invention as depicted in FIGS. 40 to 42 respectively. The PA-HELR 4000 in FIGS. 40 to 45 has been designed for use with an SC connector Sub-Assembly, such as SC connector Sub-Assembly 3720 in FIG. 37 having its outer body removed, thus allowing to pull through a ⅜ inch (9.5 mm) hole or conduit, which would not be possible if the SC connecter outer body were left on Sub-Assembly 3720. However, it would be evident that other PA-HELR according to embodiments of the invention may be designed for other specific optical or electrical connector types in conjunction with defined cable diameters or that the PA-HELR may be design to work with multiple optical or electrical connector types in conjunction with a defined cable diameter or range of cable diameters.

Within the preceding description with respect to embodiments of the invention the various pulling attachments (PAs) have been described and depicted with respect to pulling a single cable with a single connector, although the connector and cable may have support multiple elements, e.g. an optical fiber ribbon connector with optical ribbon fiber (such as 4, 8 or 12 fiber ribbons) or a CAT Ethernet connector/RJ45 connectors with up to 8 connections. However, within many installation scenarios there is a requirement to pull multiple cables through a common hole and/or tube.

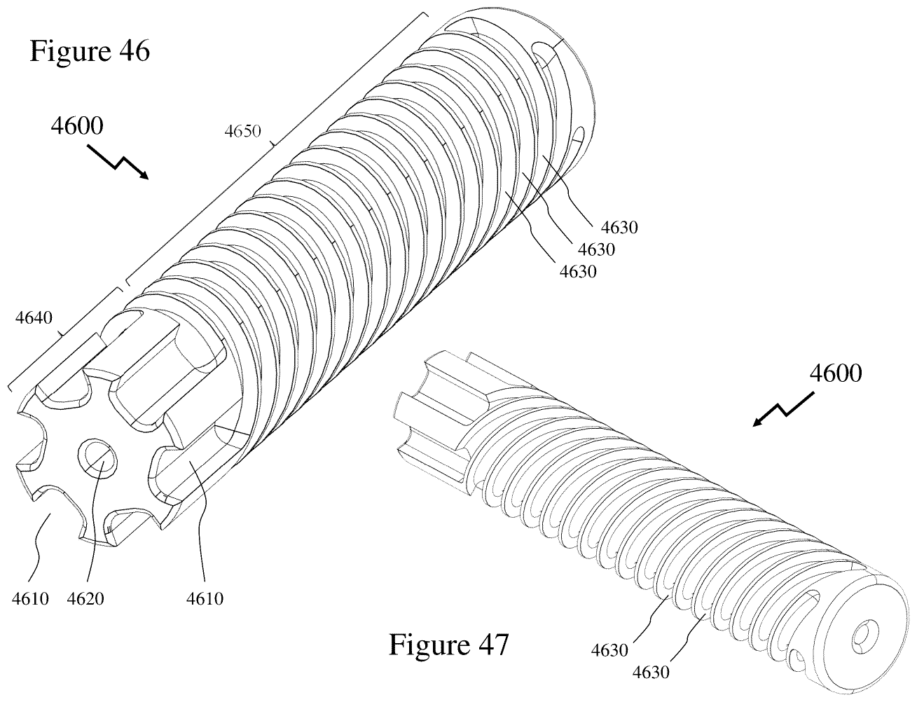

Accordingly, the inventors have established designs for PAs that support pulling multiple cables concurrently. An example of such as multi-cable pulling attachment (MC-PA) is depicted in FIGS. 46 and 47. These depict upper left and upper right perspective views of a MC-PA 4600 according to an embodiment of the invention supporting the attachment and pulling multiple cables. As depicted in FIG. 46 the MC-PA 4600 has an end Portion 4640 and a body Portion 4650. The end Portion 4620 has a central Attachment Point 4620, e.g. a threaded hole, and around the periphery of the MC-PA 4600 there are a set of N Recesses 4610. Each Recess 4610 being designed to accommodate a connector of a defined type or a series of types. The body Portion 460 has disposed around it a set of N Grooves 4630 where each Groove 4630 is designed to accommodate a cable. Each Groove 4630 of the N Grooves 4630 has one end opening into a predetermined Recess 4610 of the set of N Recesses 4610.

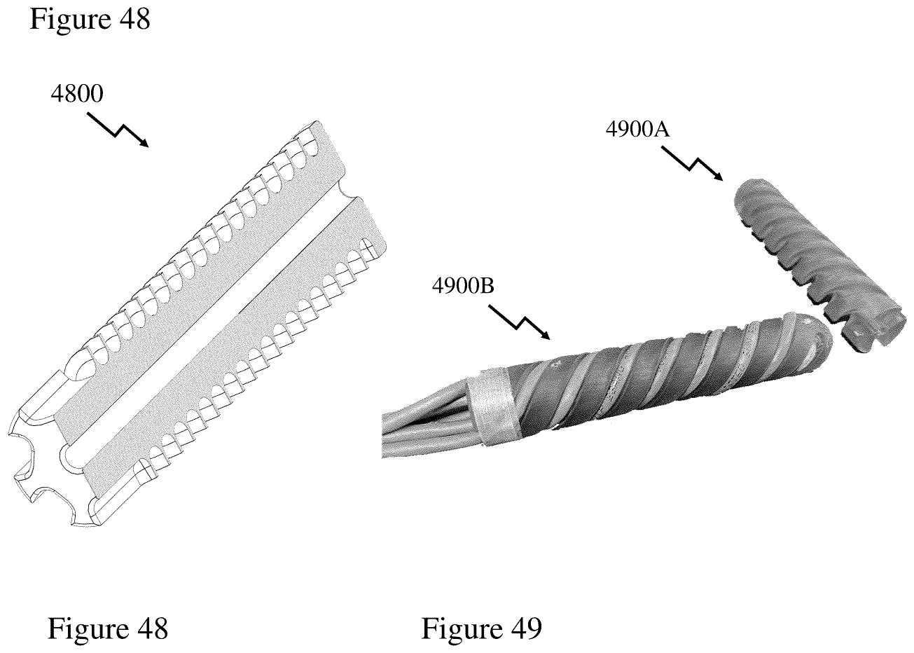

Now referring to FIG. 48 depicts a cross-section of the MC-PA according to the embodiment of the invention as depicted in FIGS. 46 and 47 respectively.

Whilst, as evident from FIGS. 46 and 47 each Groove 4630 terminates before the end of the MC-PA 4600 it would be evident that within other embodiments of the invention distal end of each groove from the body Portion 4610 may comprise another recess such that the cable exits the MC-PA 4600 within the external geometry of the MC-PA 4600. Within embodiments of the invention N may be 2, 3, 4, 6, 8 etc. according to one or more factors including, but not limited to, the dimensions of the MC-PA 4600, the connector type(s) being mounted into the N Recesses 4610.

Now referring to FIG. 49 there are depicted first and second Views 4900A and 4900B of a MC-PA according to an embodiment of the invention. In first View 4900A the MC-PA is depicted prior to assembly with a set of N cables whilst in second View 4900B the MC-PA is depicted with the set of N cables mounted to the grooves within the outer surface of the MC-PA. The ends of the unterminated cables may be within each groove or they may within another embodiment of the invention be inserted through an opening in the lower surface of a groove to a cavity within the central portion of the MC-PA. In this manner an MC-PA may be employed to pull multiple cables prior to their termination.

It would be evident that the grooves within the MC-PA in FIG. 49 may be designed to support two or more cables within each stacked upon one another.

It would be evident that the grooves within the MC-PA in FIG. 49 may be designed with different geometries to allowing pulling cables of different geometry at the same time, such as pulling both a fiber-optic cables and a low-voltage cables at the same time.

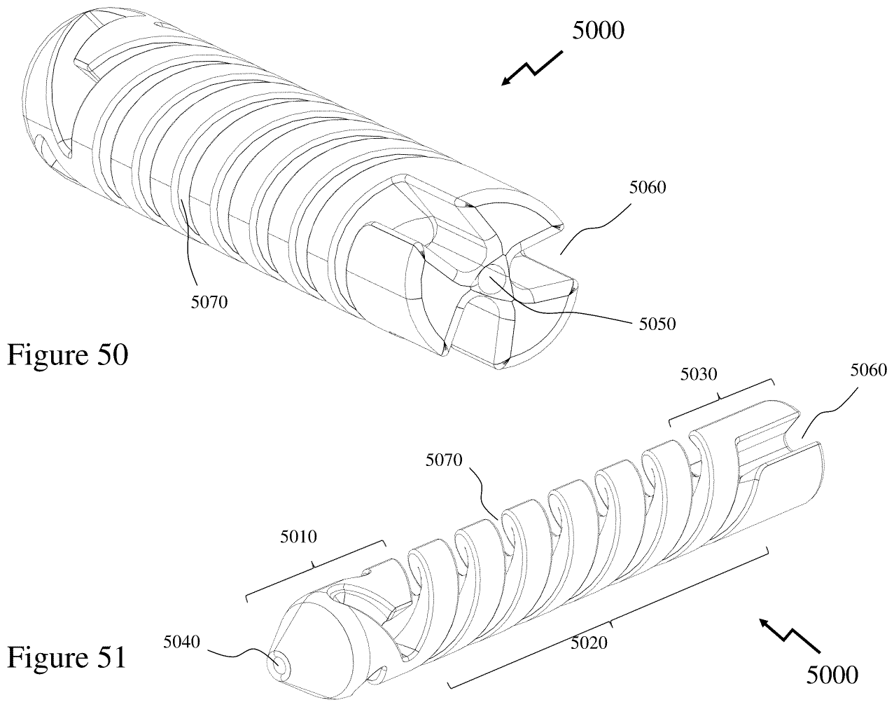

Referring to FIGS. 50 and 51 there are depicted perspective views of a multi-cable pulling attachment (MC-PA) 5000 according to an embodiment of the invention as depicted in FIG. 49 supporting the attachment and pulling multiple cables. As depicted the MC-PA 5000 has a series of spiral Grooves 5070 around the outer surface of the Body 5020 of the MC-PA 5000 which run from a Tip 5010 to End 5030. At the End 5030 each Groove 5070 terminates in a Slot 5060. The MC-PA 5000 has a first Mounting 5040 at the Tip 5010 for attaching a pulling mechanism to the MC-PA 5000 and a second Mounting 5050 at the End 5030 which may be employed for attaching another pulling mechanism allowing the MC-PA 5000 to be pulled in the opposite direction to that when pulled via the first Mounting 5040.

The extension of the grooves of Body 5020 into Tip 5010 may be done such as that Tip 5010 may include a cavity preventing the cable ends from falling out of the grooves 5070. Alternatively Tip 5010 may include multiple cavities large enough to accommodate connectors, thus for instance allowing to pull a fan-out cable with say 12 LC ends from the fan-out end rather than the MTP connector end, while securing each of the 12 LC ends, say 4 per groove into 3 grooves with 3 cavities large enough to accommodate 3 LC connectors.

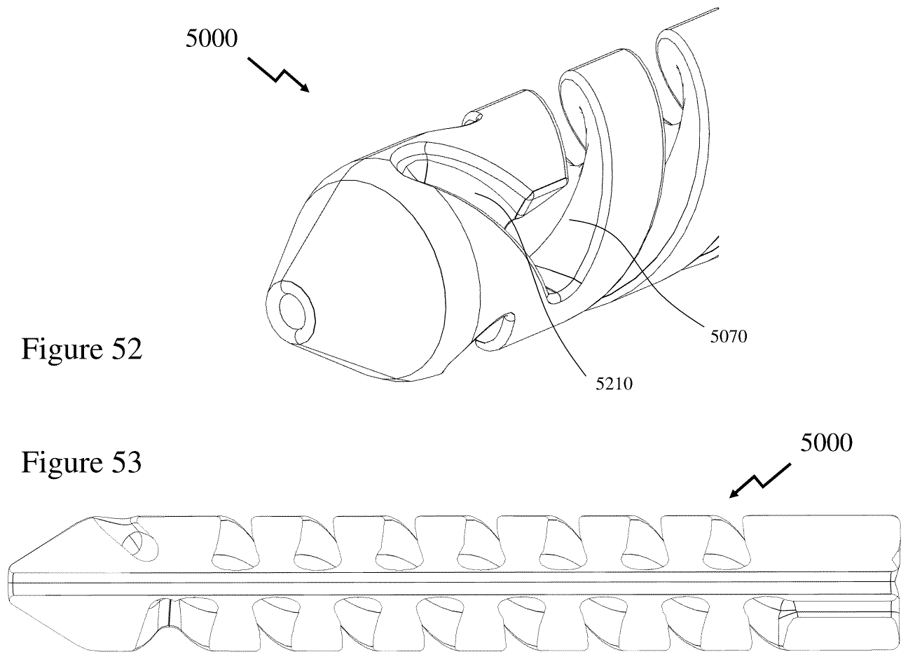

Now referring to FIGS. 52 and 53 there are depicted an expanded perspective front end view and cross-section view of the MC-PA according to an embodiment of the invention as depicted in FIGS. 49 to 51 respectively. Within FIG. 52 the tip portion, e.g. Tip 5010 in FIG. 50, is depicted in expanded form wherein the Groove 5070 terminates in a Groove End 5210 such that a cable when inserted into the Groove 5070 and Groove End 5210 is not only retained through the re-entrant design of the Groove 5070 but through the combination of the Groove End 5210 and Groove 5070, providing a mechanism for securely attaching the cables while beginning the winding operation around Body 5020 while preventing the cables from slipping out as the cables are wound. Alternatively, Groove Ends 5210 may also serve to originate a transition to a helical groove wound in opposite direction, which would provide greater grip force than one set of grooves all wound in the same direction.

greater grip force Tip 5010 may extend the helical grooves of Body 5020 in a counter direction to provide additional grip force or to allow a starting position for winding cables in each groove of body 5020 which does not slip out

As depicted in FIG. 53 the MC-PA 5000 comprises a hole through the middle which has the first Mounting 5040 and second Mounting 5050 at either end, not identified for clarity allowing for a rod with a dead end, to traverse entirely the MC-PA and pull the MC-PA from the back. Alternatively, the MC-PA with a long rod attached to mounting 5040 could traverse a MC-PA in front of it this allowing two or more MC-PA's to be pulled together at the same time.

The diameter of the of the first MC-PA according to an embodiment of the invention as depicted in FIGS. 49 to 51 respectively may be set such as to fan out the cables around another smaller diameter MC-PA being pulled behind a first MC-PA by the attachments of Mounting 5050. Alternatively, the mounting 5050 could be of such large diameter as to allow another MC-PA to fit inside of it like Russian dolls. Other mechanisms to pull multiple MC-PA's behind one another, or jointly with one another would become apparent to one skilled in the art without departing from the fundamentals of the present invention.

Within another embodiment of the invention if the Tip 5010 is replaced with a second End, like End 5050 in FIG. 50, then the MC-PA may function as a Multi-Cable Organizer Element (MC-OE) allowing multiple cables to be wound around such that part of all of their length is within each Groove. Optionally, the Slots 5060 at the End 5050 may be dimensioned to accommodate a specific connector geometry. For example, the cables may be USB Type A (UWB-A)-USB Type A, UWB-A to USB Type C (USB-C), USB-C to Lightning, USB Micro-B to USB-A. Other electrical and optical connectors may be supported within other embodiments of the invention.

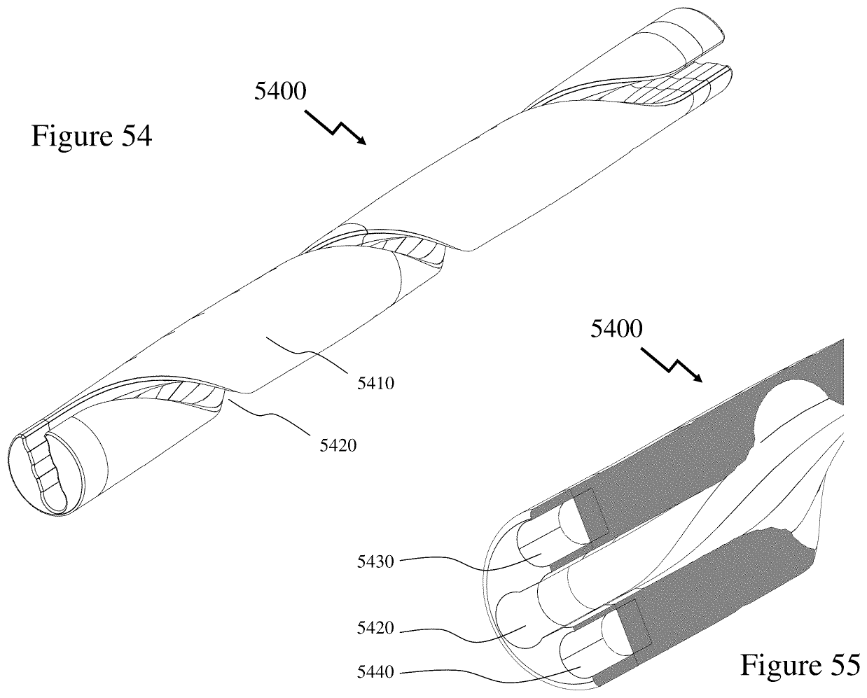

Referring to FIGS. 54 and 55 there are depicted perspective and cross-sectional perspective views of multi-cable pulling attachment (MC-PA) or Multi-Cable Organizer Element (MC-OE) 5400 according to an embodiment of the invention. As depicted the MC-OE 5400 comprises a Body 5410 with a single Groove 5420 along its length where the Groove 5420 is significantly deeper than the grooves with the preceding embodiments of the invention such that each Groove 5420 can support multiple cables.

Referring to FIG. 54, this embodiment has been designed such that the middle slot of a stack of 3 cables is closely aligned with the center of the HELIX. This effectively creates a helix with a hollow center which provides not only a relaxation of the grip as identified in the embodiment of FIG. 37A, but a flat out escape channel which makes it possible to pull on the middle of the 3 cables first, and then the cables above and below can follow the same escape as the middle cable. This makes it possible to quickly remove all cables without needing to unwind them from the MC-PA.

In FIG. 55 the cross-section depicts the Groove 5420 together with first and second Holes 5430 and 5440 respectively. Considering the MC-OE 5400 in FIG. 54 then the first and second Holes 5430 and 5440 respectively are in the end not visible. Within an embodiment of the invention the first and second Holes 5430 and 5440 respectively may be threaded allowing the attachment of a pulling mechanism or within another embodiment of the invention the first and second Holes 5430 and 5440 respectively may interface with a pair of pins to hold the MC-OE 5400 in position, e.g. vertically, horizontally etc. Optionally, within another embodiment of the invention the distal end to the end with the first and second Holes 5430 and 5440 respectively may have a pair of pins such that two or more MC-OE 5400 may be jointed together such that for example, a pair of MC-OE 5400 each supporting cables of length 0.5 m (approximately 20 inches) may be managed together cables of Im length (approximately 39.5 inches). Optionally, a U-shaped fitting with two pairs of pins may allow the pair of MC-OE 5400 to be disposed adjacent to one another rather than longitudinally such that the pair or other assemblies of more MC-OEs 5400 can manage long cables within a small compact footprint.

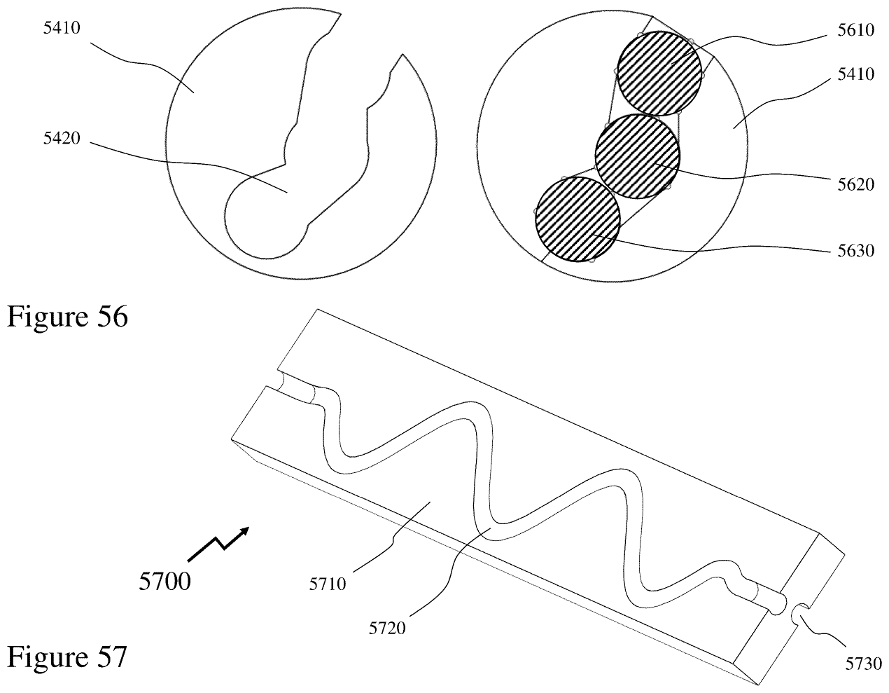

Now referring to FIG. 56 there are depicted cross-sectional views of the MC-PA/MC-OE according to the embodiment of the invention depicted in FIGS. 54 and 55 respectively. As evident in FIG. 56 the first to third Cables 5610 to 5630 respectively are disposed within the Groove 5420 within the Body 5410. Within other embodiments of the invention the Groove 5420 of an MC-OE 5400 may support 2, 4 or other numbers of cables. The Groove 5420 may be designed to provide a re-entrant geometry where each of the first to third Cables 5610 to 5630 respectively fits. Alternatively, only the outermost portion of the Groove 5420 may be re-entrant such that only the outermost first Cable 5610 is retained physically.

The geometry of the groove in FIG. 56 rather than being linear may follow a J pattern which makes it possible to further reduce the outer diameter of the MC-PA, while still allowing a re-entrant design for each level of the groove for cable in the stack inside the groove.

Referring to FIG. 57 there are depicted a perspective view of a MC-OE 5700 according to an embodiment of the invention. The MC-OE 5700 comprises a Planar Body 5710 within which are formed first and second Grooves 5720 and 5730 on either side Planar Body 5710. Optionally, a groove or grooves may be formed within only one side of the Planar Body 5710 whilst within other embodiments of the invention a first number of grooves are formed on one side of the Planar Body 5710 and a second number of grooves are formed on the other side of the Planar Body 5710.

Within other embodiments of the invention an MC-OE may be non-planar with a cross-section geometry such as that defined by a triangular pyramid, a square, a rectangle, a parallelogram, a regular or irregular N-sided polygon where N is a positive integer greater than or equal to 5, etc. where grooves are formed within one or more surfaces of the non-planar MC-OE.

Whilst within FIG. 57 each groove is depicted running from one end of the MC-OE 5700 to a distal end of the MC-OE 5700 it would be evident that one or both ends of a groove may terminate on another surface of the MC-OE 5700.

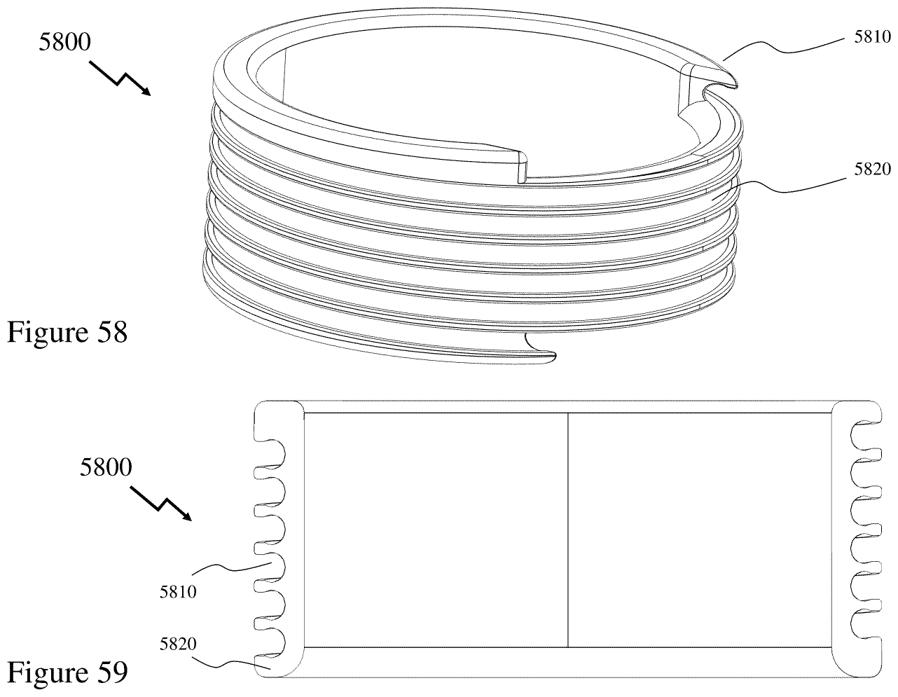

Now referring to FIGS. 58 and 59 there are depicted perspective and cross-section views of a MC-OE 5800 according to an embodiment of the invention as a cable storage, organizer, transportation device, or bend radius protector (for fiber optic patch cord spools). As depicted the Body 5810 of the MC-OE 5800 is a portion of a cylinder where a single helical Groove 5820 is formed within the outer surface of the Body 5810 of the MC-OE 5800. Within other embodiments of the invention the MC-OE 5800 may have 2 or more grooves. Accordingly, the MC-OE 5800 allows for a long cable to be stored within a small footprint without making possible to wind the cable in a dedicated groove and never onto itself like on a cable reel, making it possible to unwind the cable without it being entangled by the unwinding operation. Where the MC-OE-5800 is made with a softer elastomer, not only can the grooves be re-entrant and allow the cable snap into the groove, but they may fully subsume a softer cable that may not be hard enough to snap into the groove. Where the groove would be deep enough, it would be possible to wind one cable over one another within the same groove.

Within other embodiments of the invention the MC-OE 5800 may have a different geometry such a portion of a cone, e.g. a truncated cone, a full cone, a hyperboloid, or a sphere for example. Within other embodiments of the invention the outer geometry of the MC-OE 5800 may be a hexagonal prism, octagonal prism, cube, etc. provided that the geometry of the groove(s) formed within the other surface has an inner geometry that is circular, elliptical or another smoothly varying geometry that avoids sharp transitions in the cable, particularly for optical cables.

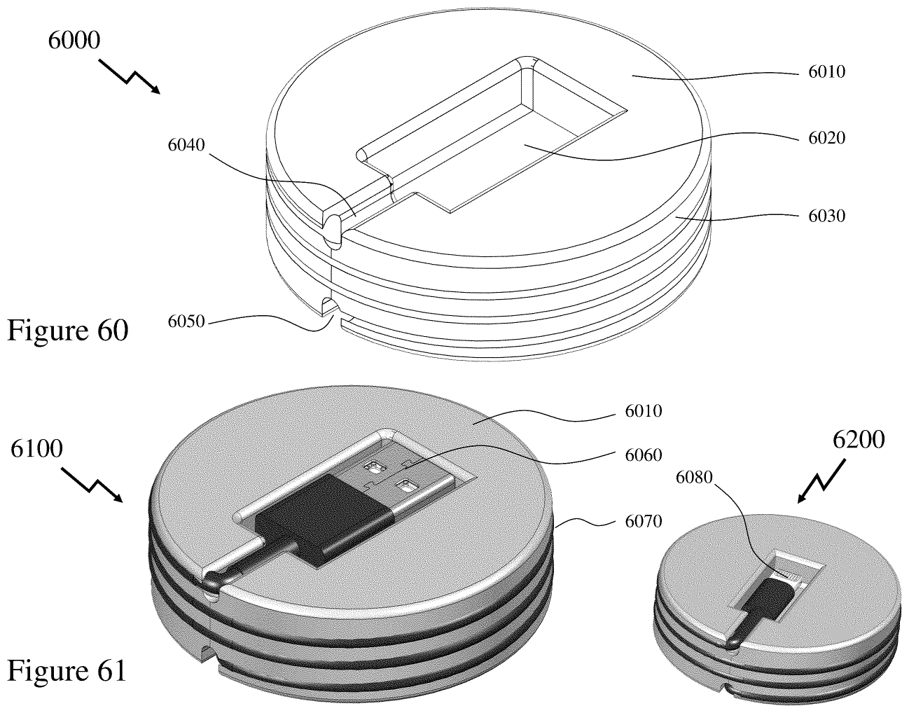

Referring to FIGS. 60 and 61 there are depicted perspective views of a MC-OE 6000 according to an embodiment of the invention with and without the connectorized cable. As depicted the MC-OE 6000 comprises a Body 6010 of cylindrical geometry wherein on one end a first Recess 6020 is formed allowing the insertion of a connector where a second recess is formed on the other end of the MC-OE 6000, not depicted for clarity. The outer cylindrical surface of the MC-OE 6000 has a Groove 6030 formed within it which transitions via a first Guide 6040 to the first Recess 6020 where a second Guide 6050 is formed on the other end of the MC-OE 6000 which links to the other recess.

Within FIG. 61 in first and second Images 6100 and 6200 the MC-OE 6000 depicted in FIG. 60 is shown in upper and lower perspective views with a Cable 6070 inserted having a first Connector 6060, a USB-A on one end, and a second Connector 6080 on the other, a Lightning connector. Within other embodiments of the invention other connector types may be employed. Within other embodiments of the invention two or more recesses may be formed on each end of the MC-OE 6000 where the multiple cables supported by the MC-OE 6000 each run in their own groove terminating in a recess on each end of the MC-OE 6000.

Within other embodiments of the invention the MC-OE 6000 may have a different geometry such a portion of a cone, e.g. a truncated cone or a full conc. Within other embodiments of the invention the outer geometry of the MC-OE 6000 may be a hexagonal prism, octagonal prism, cube, sphere, etc. provided that the geometry of the groove(s) formed within the other surface has an inner geometry that is circular, elliptical or another smoothly varying geometry that avoids sharp transitions in the cable, particularly for optical cables.

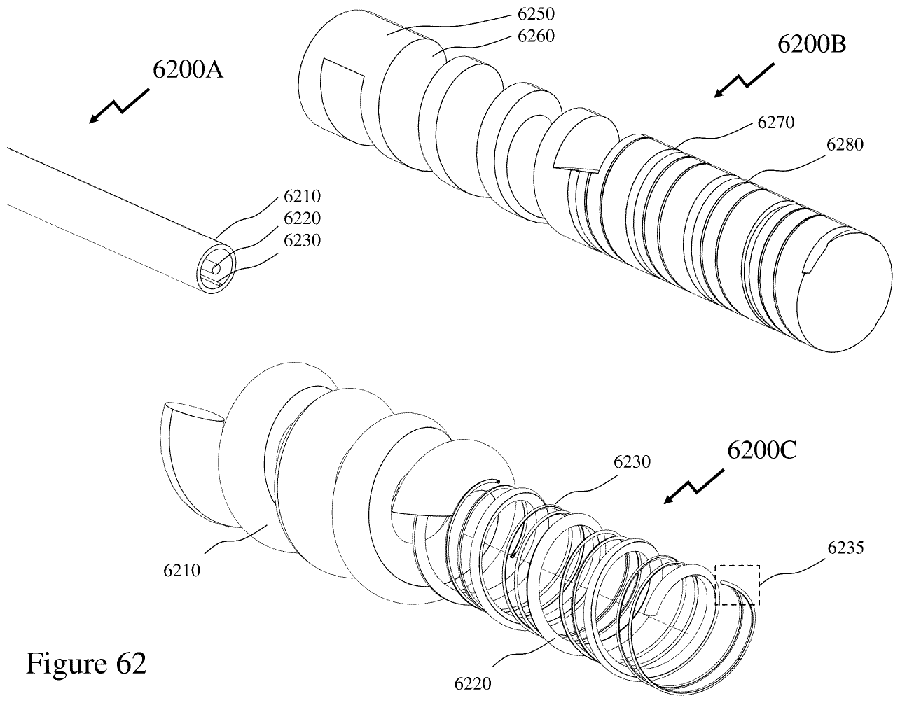

Within the descriptions above in respect of FIGS. 1 to 32 and 36B have been directed to pulling assemblies for connectorised cables, the descriptions above in respect of FIGS. 33-36A and 37A-45 directed to pulling assemblies for single non-connectorised cables, the descriptions above in respect of FIGS. 47-55 directed to pulling assemblies for multiple non-connectorised cables, and the descriptions above in respect of FIGS. 55 to 61 directed to cable management structures for connectorised cables. Within the following description with respect to FIGS. 62 to 72 the embodiments of the invention are similarly directed to non-connectorised cable pulling assemblies (NC-PAs). However, within the embodiments of the invention depicted in FIGS. 62 to 72 specific elements of the NC-PAs are provided to manage central strength members and/or strength elements. Such central strength members may be, for example, Kelvar™ reinforced plastic (KRP) whilst strength elements may include Kevlar™ yarn(s) or aramid yarn(s) for example.

Referring to FIG. 62 there is depicted a non-connectorised cable pulling assembly (NC-PA) according to an embodiment of the invention in first to third Images 6200A to 6200C. First image 6200A depicts an exemplary cable, for example an electrical cable, microwave cable or fiber optic cable, comprising Outer Jacket 6210 within which is disposed a Central Strength Member (CSM) 6220 and Aramid Yarn (AY) 6230. Whilst a single AY 6230 and CSM 6220 are depicted it would be evident that the cable may comprise multiple CSM 6220 and/or multiple AY 6230 which for case are herein referred to as AY 6230 as well. Commonly, the AY 6230 is a plurality of yarns which must be utilized when pulling on the cable as otherwise, pulling on the cable sheath will lead to plastic deformation of the cable structure and potential damages to the optical fiber.

Second Image 6200B depicts the NC-PA according to the embodiment of the invention wherein the NC-PA 6250 has a series of grooves of varying dimensions (and potentially geometry) formed within the outer surface. These grooves comprising first Groove 6260 which is dimensioned to accept the Outer Jacket (OJ) 6210, second Groove 6270 which is dimensioned to accept the CSM 6220, and third Groove 6280 dimensioned to accept the AY 6230. Third Image 6200C depicts the OJ 6210, CM 6220 and AY 6230 as wound onto the NC-PA 6250 but without the NC-PA 6250 being depicted for clarity. Accordingly, it is evident in third Image 6200C that the AY 6230 loops back in Region 6235 and winds back along the NC-PA 6250 in the reverse direction for part of the length of NC-PA 6250. In this manner the NC-PA 6250 primarily pulls upon the AY 6230 of the cable.

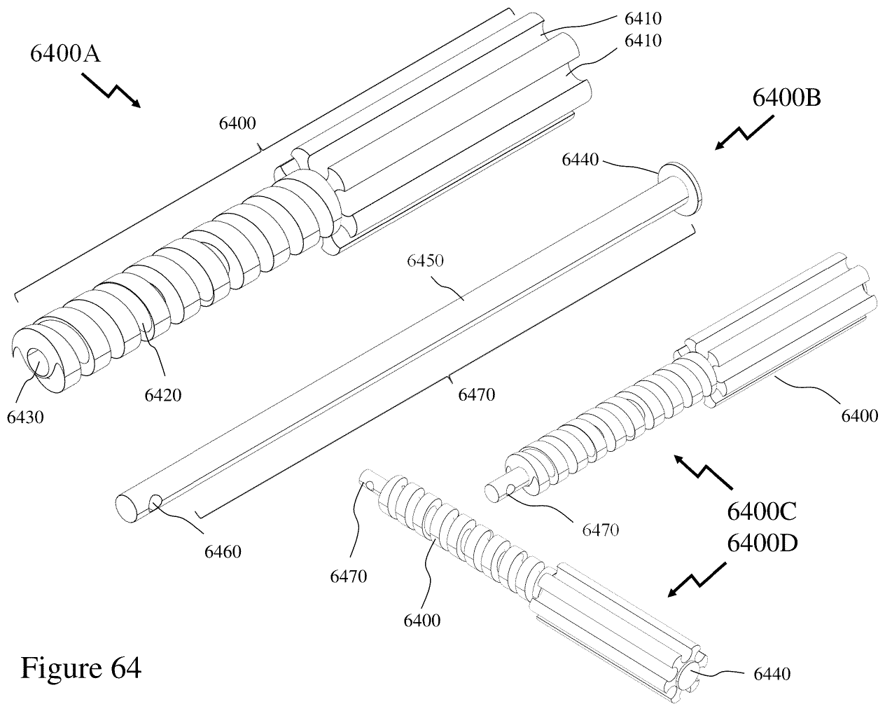

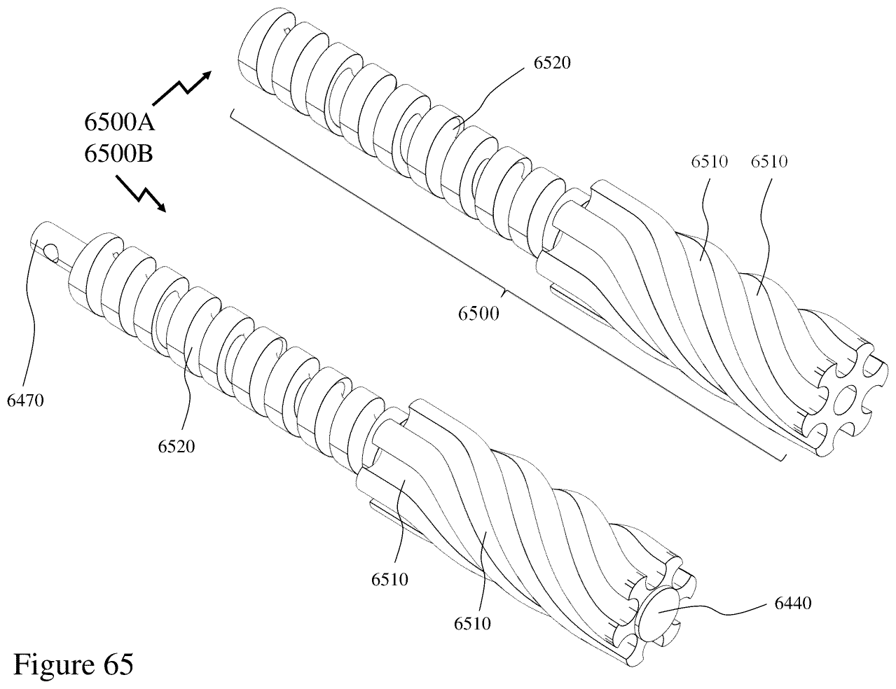

The NC-PA 6250 may include a fitting such as described above for the attachment of a pulling rod, pull rope etc. However, it may also support a demountable Pulling Rod (PullRod) such as described below in respect of FIGS. 64 and 65 respectively.

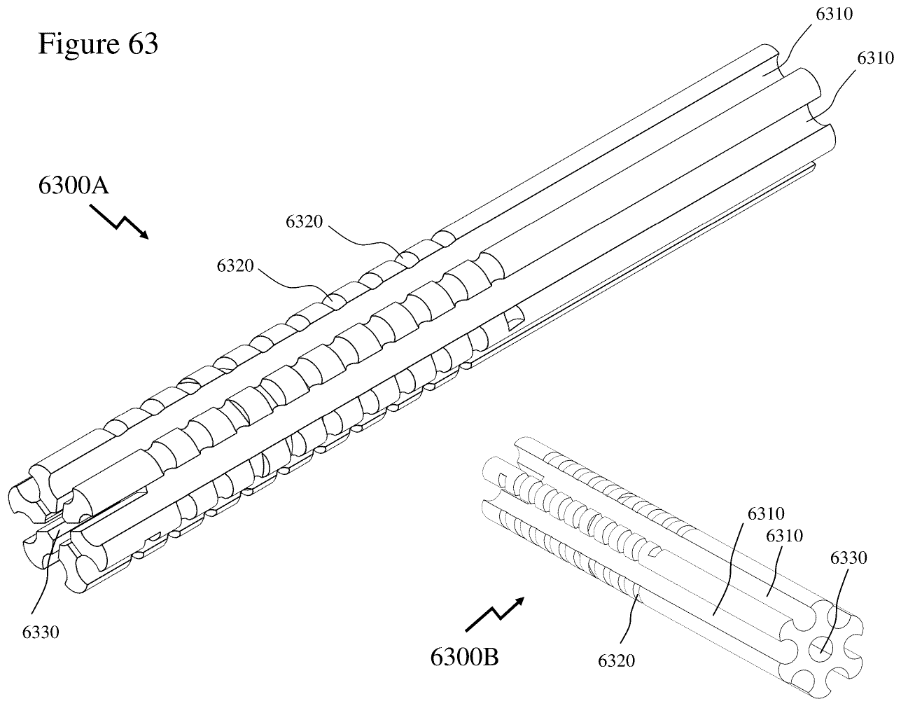

Now referring to FIGS. 63 to 65 there are depicted NC-PAs according to embodiments of the invention supporting multiple non-connectorised cables. Within FIG. 63 in first and second Images 6300A and 6300B a multiple NC-PA (MNC-PA) is depicted comprising a body within which are formed, at one end, a series of Cable Grooves 6310, which are dimensioned to accept the outer jacket of the cable(s) to be mounted to and pulled with the MNC-PA, such as Outer Jacket 6210 in FIG. 62. Then a Spiral Groove 6320, or a series of Spiral Grooves 6320, are disposed along a portion of the MNC-PA within which are wound and accordingly disposed the aramid yarns (AYs, such as AY 6230 in FIG. 62) of the cable(s) assembled with the MNC-PA. Opening 6330 at the distal end of the MNC-PA to the Cable Grooves 6310 may support the attachment of a pulling rod, pull rope etc. as described above or it may be a bore through the MNC-PA to support a PullRod such as depicted in second Image 6300B.

Accordingly, the OJ, such as OJ 610 in FIG. 62, and CSM, such as CSM 6210 in FIG. 62, are trimmed back from the point at which the cable is cut leaving the AY, such as AY 6230 in FIG. 62. The OJs of the cables are inserted into the Cable Grooves 6310 of the MNC-PA and then AY of each cable are wound into the Spiral Groove 6320 such that the MNC-PA when pulled pulls upon the AYs of the cables.

In FIG. 64 there are depicted first to fourth Images 6400A to 6400D of an MNC-PA 6400 and PullRod 6470 according to an embodiment of the invention. In first Image 6400A the MNC-PA 6400 is depicted comprises a portion disposed at one end comprising a series of Cable Grooves 6410 around the periphery of that portion of the MNC-PA 6400. The other end of the MNC-PA 6400 comprises a Spiral Groove 6420 and disposed in this other end of the MNC-PA 6400 is a Bore 6430 which goes through the length of the MNC-PA 6400. Second Image 6400B depicts the PullRod 6470 which comprises Central Rod 6450, End 6440 and Lateral Borc 6460.

In third and fourth Images 6400C and 6400D the MNC-PA 6400 and PullRod 6470 are depicted assembled together from two different perspectives. As evident the PullRod 6470 goes through the Bore 6430 of the MNC-PA 6400 where the End 6440 of the PullRod 6470 engages against the end of the MNC-PA 6400 when the PullRod 6470 is pulled from the distal end of the MNC-PA 6400. The PullRod 6470 may be attached to a pulling rope which is attached through the Lateral Bore 6460 of the PullRod 6470.

Within other embodiments of the invention the Lateral Bore 6470 may be provided discretely or in combination with a threaded fitting or the Lateral Bore 6470 may be omitted and that end of the PullRod 6470 may have a threaded fitting only. The AY of cables assembled onto the MNC-PA 6400 are wound into the Spiral Groove 6420 discretely or they may be wound into the Spiral Groove 6420 and tied around the portion of the PullRod 6470 projecting through the MNC-PA 6400, such as depicted in FIG. 72. In this manner the PullRod 6470 pulls upon the MNC-PA 6400 and the AYs of the cables pull the cables without applying force onto the active elements of the cables and/or outer jacket.

Referring to FIG. 65 there are depicted first and second Images 6500A and 6500B of an MNC-PA 6500 with and without PullRod 6470. The MNC-PA 6500 comprises a series of Cable Grooves 6510 around the periphery of an end of the MNC-PA 6500 that engages with the End 6440 of the PullRod 6470. The MNC-PA 6500 comprises a Spiral Groove 6520 on the other end of the MNC-PA 6500. The MNC-PA 6500 functions in the same manner as MNC-PA 6400 but now the grooves for the cables, Cable Grooves 6500, spiral around the MNC-PA 6500 rather than being longitudinal and axial as depicted with MNC-PSA 6400.

Whilst the MNC-PAs depicted in FIGS. 63 to 66B respectively support six cables, the six Cable Grooves, e.g. Cable Grooves 6310 in FIG. 63, Cable Grooves 6400 in FIG. 64 or Cable Grooves 6500 in FIG. 65, it would be evident that the number of cables supported by an MNC-PA according to an embodiment of the invention may vary within other embodiments of the invention in dependence upon one or more factors. Such factors may include, but not be limited to, the diameter of hole or conduit the MNC-PA is to be pulled through and the diameter of the cables. For example, the number of cables may be 1, 2, 3, 4 or more.

Whilst the MNC-PAs depicted in FIGS. 63 to 66B respectively support a number of cables of common diameter it would be evident that within other embodiments of the invention an MNC-PA may employ cable grooves for 2 or more diameter cables. Optionally, within other embodiments of the invention a cable groove may comprise two or more sections where each section is designed for a specific cable diameter. The groove may therefore step from the largest to smallest wherein larger diameter cables stop nearer the end of the MNC-PA and the narrower grooves beyond accept the AY (and/or CSM) before the AY enters the spiral groove(s).

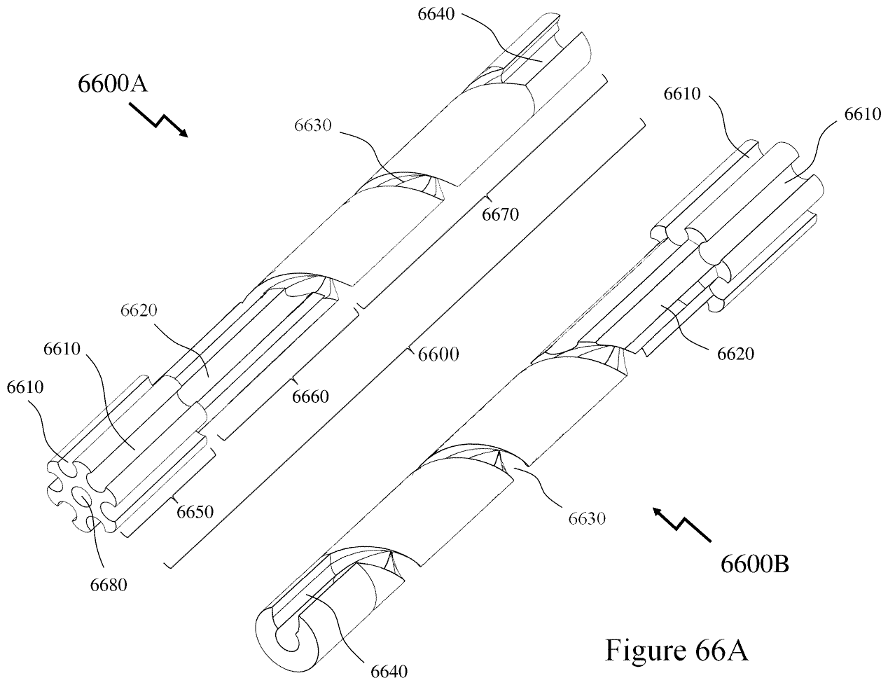

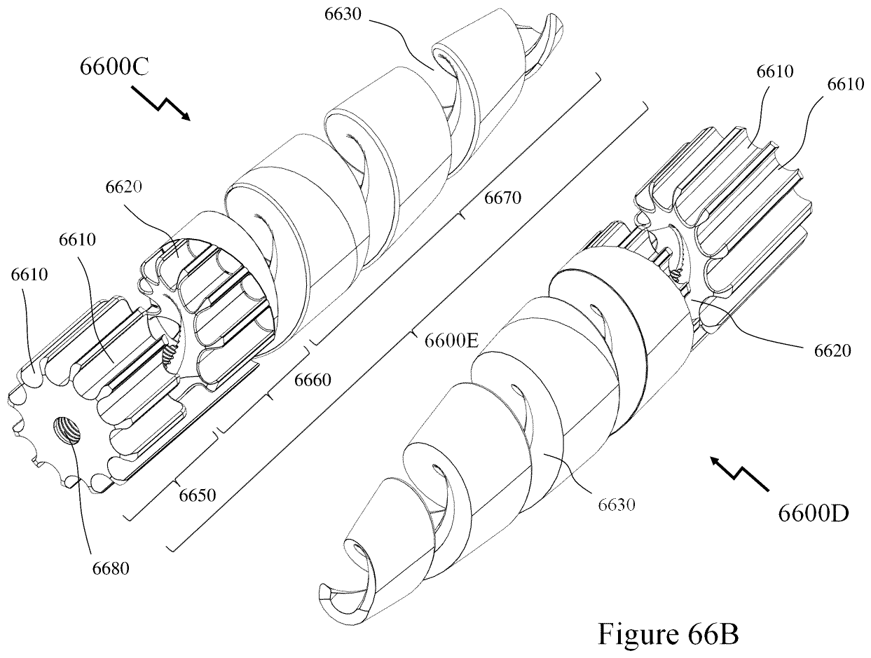

Referring to FIG. 66A there is depicted an MNC-PA 6600 according to an embodiment of the invention supporting multiple non-connectorised cables. As depicted the MNC-PA 6600 comprises a first Portion 6650, second Portion 6660 and third Portion 6670. The first Portion 6650 comprises a series of Cable Grooves 6610 which are dimensioned to accept the outer jacket of the cables. The second Portion 6660 extends the inner portions of the Cable Grooves 6610 through Partial Grooves 6620 where the Partial Grooves 6620 are not re-entrant on the cable jacket when assembled. The third Portion 6670 comprises a Spiral Groove 6630 which terminates in a Slot 6640. The Spiral Groove 6630 accommodates the AYs of the cables. A Bore 6680 extends through the length of the MNC-PA 6600 allowing a PullRod such as PullRod 6470 to be inserted allowing the ends of the AYs to be optionally tied around the projecting end of the PullRod 6470. Alternatively, the third Portion 6470 may support a threaded portion to provide a fitting such as described and depicted above or a hole such as Hole 3810 in FIG. 38 allowing the attachment of a rope or fishing line etc.

Now referring to FIG. 66B there is depicted an MNC-PA 6600E according to an embodiment of the invention supporting multiple non-connectorised cables wherein the MNC-PA 6600E is profiled at the end initially engaging with a region of conduit, hole etc. As depicted the MNC-PA 6600E comprises a first Portion 6650, second Portion 6660 and third Portion 6670. The first Portion 6650 comprises a series of Cable Grooves 6610 which are dimensioned to accept the outer jacket of the cables. The second Portion 6660 extends the inner portions of the Cable Grooves 6610 through Partial Grooves 6620 where the Partial Grooves 6620 are not re-entrant on the cable jacket when assembled. The third Portion 6670 comprises a Spiral Groove 6630 but does not terminate with a slot, e.g. Slot 6640 in FIG. 66A. The Spiral Groove 6630 accommodates the AYs of the cables. A Bore 6680 extends through the length of the MNC-PA 6600E allowing a PullRod such as PullRod 6470 to be inserted allowing the ends of the AYs to be optionally tied around the projecting end of the PullRod 6470. Alternatively, the third Portion 6470 may support a threaded portion to provide a fitting such as described and depicted above or a hole such as Hole 3810 in FIG. 38 allowing the attachment of a rope or fishing line etc. The Bore 6680 may be threaded to allow a threaded PullRod to be engaged with the MNC-PA 6600E.

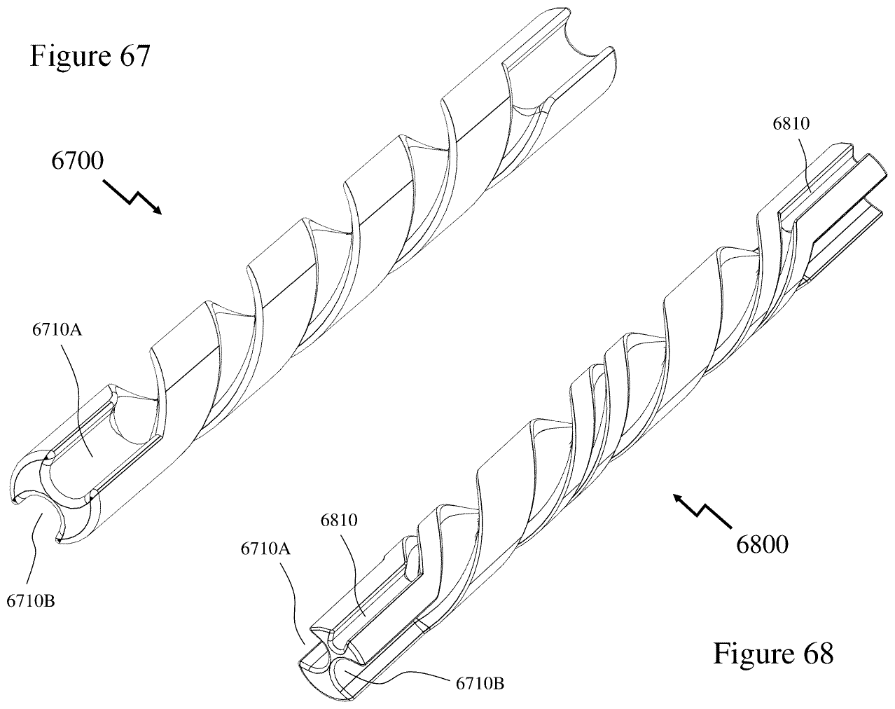

Now referring to FIGS. 67 and 68 there are depicted helical non-connectorised cable puller assemblies (HEL-NC-PA) 6700 and 6800 according to an embodiment of the invention. In FIG. 67 the HEL-NC-PA 6700 comprises a first Groove 6710A and a second Groove 6710B which run along the length of the HEL-NC-PA 6700. Each of the first and second Grooves 6710A and 6710B comprises a straight section at either end with a central spiral portion between the pair of straight sections.

In FIG. 68 the HEL-NC-PA 6800 again comprises the first and second Grooves 6710A and 6710B respectively but now a third Groove 6810 is disposed along the length of HEL-NC-PA 6800. The third Groove 6810 supports the mounting of a pulling cord (rope) along the length of the HEL-NC-PA 6800. The pulling cord may be employed upon a discrete HEL-NC-PA 6800 or in conjunction with multiple HEL-NC-PAs 68000 such as with the exemplary deployment depicted in FIG. 70.

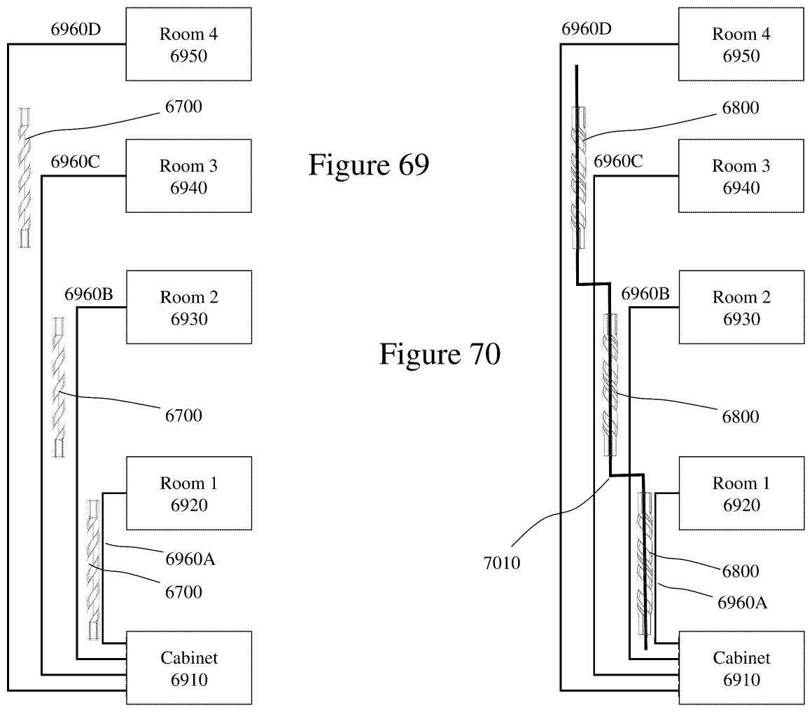

Referring to FIGS. 69 and 70 there are depicted exemplary deployment scenarios for the HEL-NC-PA designs depicted in FIGS. 67 and 68 respectively. Within FIG. 69 the deployment scenario employs three HEL-NC-PAs 6700 are employed at three locations in a cascade of 4 cables that are to be deployed from a Cabinet 6901 to first to fourth Rooms 6920-6950 respectively. First Cable 6960A will be deployed from Cabinet 6910 to first Room 6920, second Cable 6960B will be deployed from Cabinet 6910 to second Room 6930, third Cable 6960C will be deployed from Cabinet 6910 to second Room 6930 and fourth Cable 69060D will be deployed from Cabinet 6910 to fourth Room 6940.

The first HEL-NC-PA 6700 is deployed a first distance from the end of the fourth Cable 6960D and connects the third Cable 6960C to the fourth Cable 6960D. The second HEL-NC-PA 6700 is deployed a second distance from the end of the fourth Cable 6960D and connects the third Cable 6960C to the second Cable 6960B. The third HEL-NC-PA 6700 is deployed a third distance from the end of the fourth Cable 6960D and connects the second Cable 6960B to the first Cable 6960A. Accordingly, pulling the end of the fourth Cable 6960D to which a pulling assembly according to an embodiment of the invention may be attached results in not only the fourth Cable 6960D being pulled but also the first to third Cables 6960A to 6960C respectively. Accordingly, once the pulling operation is completed or steps in the pulling operation are completed each of the three HEL-NC-PAs 6700 can be removed and the first to fourth Cables 6960A to 6960D connectorised and/or otherwise connected to equipment within each of the first to fourth Rooms 6920 to 6950 respectively.

In contrast, in FIG. 70 the three HEL-NC-PAs 6700 are replaced by three HEL-NC-PAs 6800. A common pull Cord 7010 is also connected from the first HEL-NC-PA 6800 to the last HEL-NC-PA 6800 such that the pulling operation can employ this common pull Cord 7010 rather than the cables themselves.

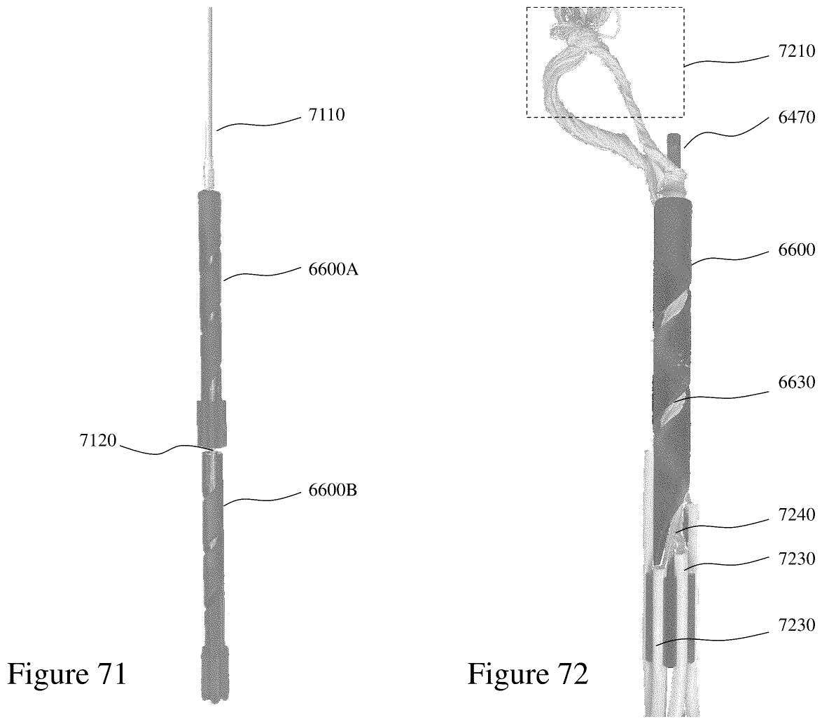

Now referring to FIG. 71 there is depicted an exemplary stacked NC-PA according to an embodiment of the invention employing a pair of NC-PAs, first and second NC-PAs 6600A and 6600B respectively, according to the design depicted in FIG. 66. Within this embodiment of the invention a PullRod 7120 is employed upon which the first NC-PA 6600A and second NC-PA 6600B are assembled. The end of the PullRod 7120 is connected to a Pull Stick 7110 whilst the distal end of the PullRod 7120 retains the first and second NC-PAs 6600A and 6600B respectively by a feature such as End 6440 in FIG. 64 for example. Accordingly, each of the first and second NC-PAs 6600A and 600B respectively can accommodate 6 cables, using the design depicted in FIG. 66, such that the combination depicted in FIG. 71 allows pulling of 12 cables concurrently.

It would be evident that different length pulling rods, e.g. PullRod 7120, could support 1, 2, 3 or more NC-PAs within embodiments of the invention. Within other embodiments of the invention an NC-PA 6660 may have threaded fittings at either end, e.g. male at one end and female at the other end, such that the NC-PAs 6600 may be assembled together and attached to a pulling stick, for example, without the requirement for a PullRod, such as PullRod 7120 or PullRod 6470 in FIG. 67 for example. It would be evident that with different NC-PAs assembled to each other or upon a common PullRod that a single pulling operation could pull one or more cables of one geometry concurrently with one or more cables of another geometry.

Referring to FIG. 72 there is depicted an exemplary NC-PA 600 according to the design depicted in FIG. 66 assembled with cables and PullRod 6470. Accordingly, Cables 7230 are assembled upon the NC-PA 6600 with the outer jacket removed from where each Cable 7230 is mounted to the NC-PA 6600 to where the Cable 7230 was cut thereby exposing the AYs 7240 within the cable. The AYs 7240 are wound into the Groove 6630 of the NC-PA 6600, tied around the PullRod 6470, and then together to form Loop 7210. The NC-PA 6600 may be pulled by attaching an eye, hook or pull rope etc. to the Loop 7210. In other embodiments of the invention the AYs are only long enough to be wound into the Groove 6630 and the NC-PA 6600 is pulled via the PullRod 6470.

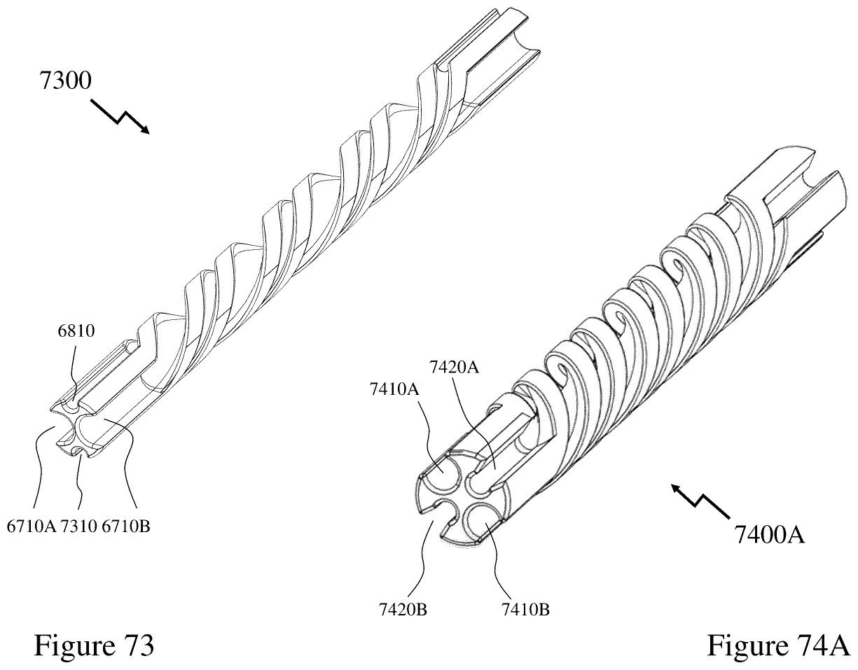

Now referring to FIG. 73 there is depicted a helical non-connectorised cable puller assembly (HEL-NC-PA) 7300 according to an embodiment of the invention which extends the design of HEL-NC-PA 6800 wherein a fourth Groove 7310 is depicted along with the first and second Grooves 6710A and 6710B respectively and third Groove 6810. The fourth Groove 7310 also supports the attachment of another pulling cord (rope) to the pulling cord (rope) attached to the third Groove 6810.

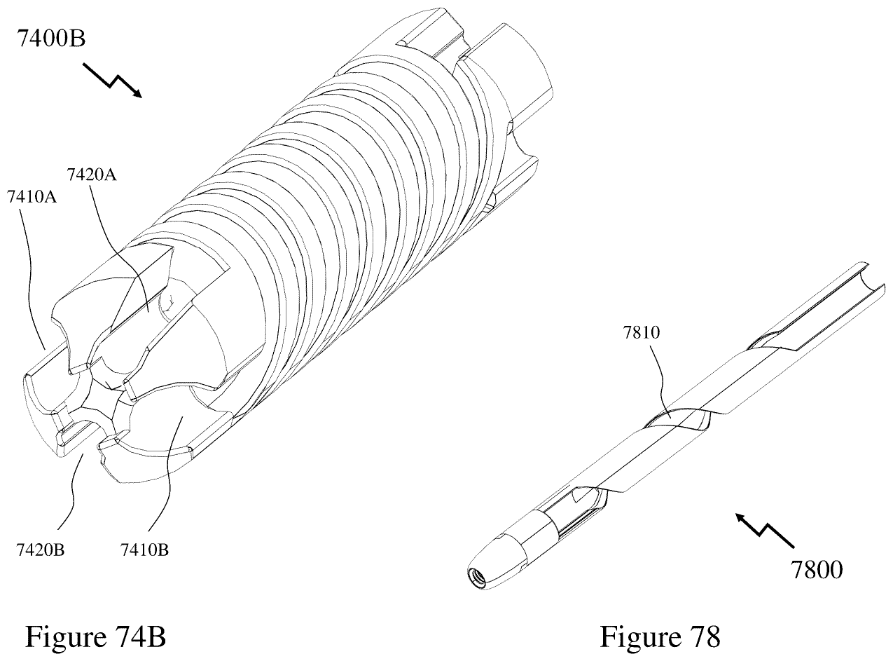

Now referring to FIG. 74A there is depicted another helical non-connectorised cable puller assembly (HEL-NC-PA) 7400A according to an embodiment of the invention which extends the design of HEL-NC-PA 6800. In contrast to HEL-NC-PA 7300 in FIG. 73 whilst the first and second Grooves 7410A and 7410B are depicted as being re-entrant such that the opening of these grooves at the surface of the HEL-NC-PA 7400A have an opening less than 180 degrees, e.g. 120-degrees or 150-degrees for example. The third and fourth Grooves 7420A and 7420B respectively are similarly deeper than the third Groove 6810 and fourth Groove 7310 in HEL-NC-PA 7300 wherein each of the third and fourth Grooves 7420A and 7420B respectively comprises a circular portion and linear portion wherein the circular portion is re-entrant such that the opening of these grooves of the HEL-NC-PA 7400A have an opening less than 180 degrees, e.g. 120-degrees or 150-degrees for example. The linear portion of these grooves exhibit a geometry that increases in width from the inner region abutting the circular portion to the surface of the HEL-NC-PA 7400A.

Now referring to FIG. 74B there is depicted another helical non-connectorised cable puller assembly (HEL-NC-PA) 7400B according to an embodiment of the invention which has a similar geometry as that of HEL-NC-PA 7400A in FIG. 74A but now has profiled end which will engage with the conduit, hole etc. first. The HEL-NC-PA 7400B in FIG. 74B similarly comprising first and second Grooves 7410A and 7410B which are depicted as being re-entrant such that the opening of these grooves at the surface of the HEL-NC-PA 7400B have an opening less than 180 degrees, e.g. 120-degrees or 150-degrees for example. The third and fourth Grooves 7420A and 7420B respectively comprise a circular portion and linear portion wherein the circular portion is re-entrant such that the opening of these grooves of the HEL-NC-PA 7400B have an opening less than 180 degrees, e.g. 120-degrees or 150-degrees for example. The linear portion of these grooves exhibit a geometry that increases in width from the inner region abutting the circular portion to the surface of the HEL-NC-PA 7400B.

Accordingly, the HEL-NC-PAs 7300, 7400A and 7400B allows for daisy chaining several HEL-NC-PAs 7300, 7400A and 7400B in a similar manner to that described with respect to FIGS. 69 and 70 but now one pulling rope can be connected to all the HEL-NC-PAs 7300, 7400A and 7400B in the daisy chain whilst other pulling ropes are attached between sequential pairs of HEL-NC-PAs 7300, 7400A and 7400B. This dual rope attachment methodology allows for a single rope to HEL-NC-PAs 7300, 7400A and 7400B pull all the HEL-NC-PAs 7300, 7400A and 7400B where the AYs of each cable are attached to the grooves in the appropriate HEL-NC-PAs 7300, 7400A and 7400B, such as depicted in FIG. 72, and/or tied to the common rope so that the common rope and not the cable sheathes/AYs of each cable within the chain taking the pulling load.

In this manner N cables, N≥2 and an integer, can be pulled with N−1 HEL-NC-PAS 7300, 7400A and 7400B within the overall constraints of the holes/conduit the cables are being pulled through and the geometries of the cables themselves where the overall maximum diameter of the pulled bundle is approximately equal that of hexagonal close packing N+2 cables together. For example, with 12 cables of 4.8 mm (0.19″) diameter, which minimally pack to a diameter of 16.6 mm (approximately 0.65″), but with HEL-NC-PAs according to an embodiment of the invention the cables pack to a diameter of 14 cables, i.e. 18.0 mm (approximately 0.71″), adding only approximately 1.4 mm (approximately 0.055″) to the overall bundle such that the 12 cables of 4.8 mm diameter can be pulled through a 25 mm (approximately 1″) diameter hole.

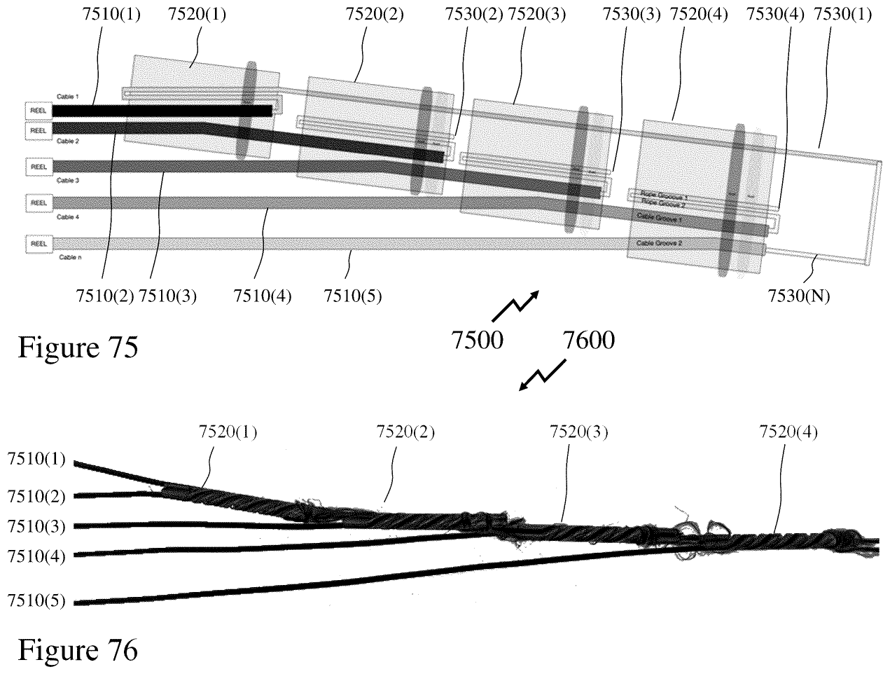

Now referring to FIGS. 75 and 76 respectively there are depicted a Schematic 7500 and Photograph 7600 respectively of a staggered cable pulling configuration employing HEL-NC-PAs according to an embodiment of the invention such as HEL-NC-PA 7300 or HEL-NC-PA 7400 according to embodiments of the invention. Accordingly, in each of Schematic 7500 and Photograph 7600 respectively there are depicted a series of HEL-NC-PAs 7520(1) to 7520(4) together with first to fifth Cables 7510(1) to 7510(5) respectively. Accordingly, within Schematic 7500 and Photograph 7600 respectively N=5 wherein N−1=4 HEL-NC-PAs, such as HEL-NC-PAs 7300 and/or 7400A and/or 7400B respectively, are employed in a daisy chain configuration for pulling the N cables.

As evident from Schematic 7500 the AYs 7530(2) to 7530(4) of each of the second to fourth Cables 7510(2) to 7520(4) are looped backwards and forwards within one of the two grooves for the AYs, e.g. one of third and fourth Grooves 7420A and 7420B respectively in HEL-NC-PA 7400 or one of the third Groove 6810 and fourth Groove 7310 in HEL-NC-PA 7300, of their respective HEL-NC-PA, i.e. HEL-NC-PAs 7520(2) to 7520(4). The AY 7530(1) of the first Cable 7510(1) is fed through the other groove of each of the HEL-NC-PAs, e.g. the other of third and fourth Grooves 7420A and 7420B respectively in HEL-NC-PA 7400 or the other of the third Groove 6810 and fourth Groove 7310 in HEL-NC-PA 7300. The end of AY 7530(1) is tied into a knot or knots with the AY 7530(5) of the fifth Cable 7510(5) such that the knot(s) can form a pulling means for the assembly directly or alternatively the ends of AY 7530(1) and AY 7530(5) may tie to a cable pulling means discretely.

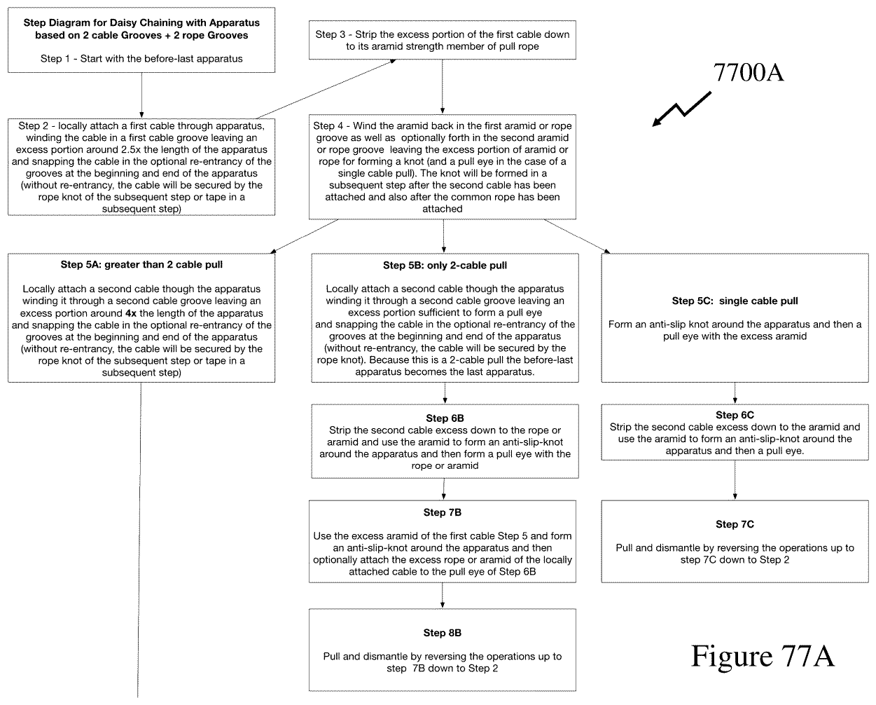

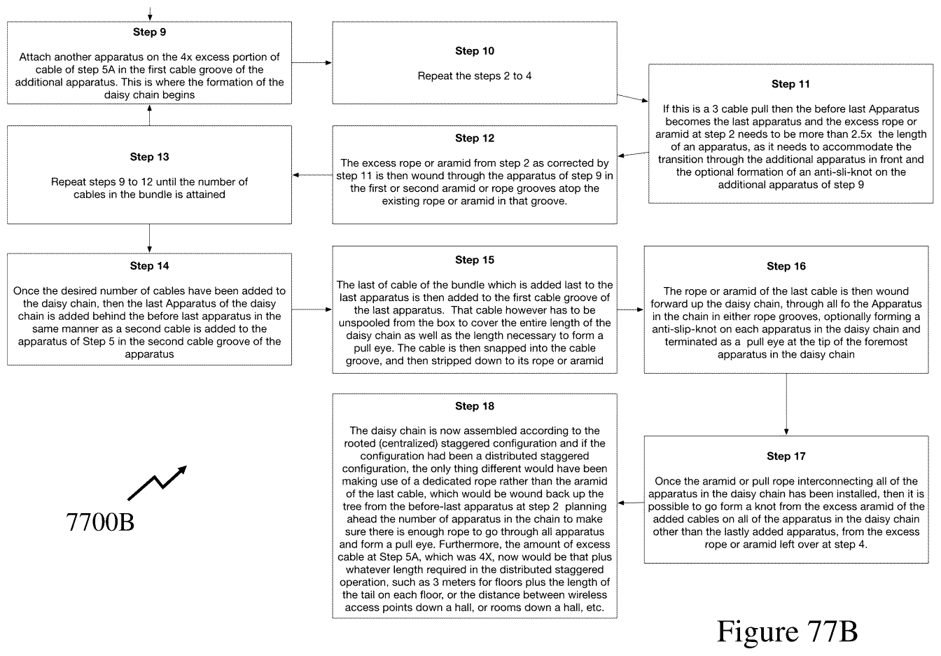

Referring to FIGS. 77A and 77B there are depicted first and second Flows 7700A and 7700B outlining a step by step process for the implementation of a staggered cable puller configuration with a daisy chain of HEL-NC-PA's, which is further described in details in the next paragraphs. This daisy chained configuration being referred to by the inventors as one embodiment of a rooted staggered configuration of cable pulling devices according to embodiments of the invention.

Referring to FIG. 78 there is depicted a PA 7800 according to an embodiment of the invention for a single cable, such as described and depicted in FIGS. 37A, 37B and 37C respectively wherein the Groove 7810 provides for the cable to be re-entrant within the PA 7800.

The rooted staggered configuration is implemented with the following description using a common embodiment of the HEL-NC-PA, i.e. by using multiple instances of a single HEL-NC-PA piece part in a daisy chain. This provides the benefit of a single stock keeping unit (SKU) to order, to keep in stock and to provide spares. However, it would be evident that within other embodiments of the invention two or more different designs of the HEL-NC-PA may be employed.

The embodiments of the HEL-NC-PA 7400A and 7400B depicted in FIGS. 74A and 74B within the following description comprise 2 cables grooves, first and second Grooves 7410A and 7410B respectively, designed for 4.8 mm cables for example, which may be re-entrant and 2 rope grooves, third and fourth Grooves 7420A and 7420B, which may or may not be re-entrant. However, these cable grooves could serve as re-entrant grooves for 3 mm cables and at the same time serve as rope grooves. Accordingly, a HEL-NC-PA with four grooves may be employed with 4 cables or a pair of cables and a pair of AYs or sets of AYs or three cables and a single AY or set of AYs. Referring to FIG. 74B HEL-NC-PA 7400B the PA is

In this example, with a 2nd HEL-NC-PA in the daisy chain (from the tip), it is possible to pull on 3 cables. With 3 cables, on a lightweight pulling operation, it may not be necessary to pull with the insertion of the aramid inside the dedicated grooves for the ropes. In fact, the dedicated grooves for the ropes may be entirely omitted and it would still be possible to knot the aramid rope around the HEL-NC-PA. However, the hiding of the aramid ropes in the helical grooves provides 3 more benefits, a) additional grip force, and b) preventing the rope from interfering with the pulling operation and c) should tape be used around the device, easier removal of the tape which would not be glued up in the aramid rope.

It is beneficial that a single cable does not take the load of all other cables down the daisy chain. Accordingly, the simplistic configuration where the longest cable goes through all of the multiple HEL-NC-PA's in the daisy chain through one of the two cable grooves in each of the HEL-NC-PA, does provide a reasonable pulling force for all for the added cables on each of the HEL-NC-PA. However, this configuration has the longest cable take all of the load and subjects the cable to potential plastic deformation of its sheath and potential damage to the optical fiber(s) or electrical conductor(s) in the cable.

Within another embodiment of the invention would be possible to wind a separate common rope through each of the two rope grooves across all HEL-NC-PAs in the daisy chain, leaving the other rope groove for a local attachment. However, that discrete rope would have to be procured separately. It would also be possible to use the aramid yarn(s) of each added cable as a common rope and tie all the rope ends together between instances of the HEL-NC-PA in the daisy chain However, this is a time consuming process.

To overcome these limitations, the inventors have established HEL-NC-PAs as an efficient way to achieve a rooted (centralized) staggered configuration where all of the HEL-NC-PA are back to back in a local daisy chain, and where instead of using a separate rope, it is the aramid of the longest drop which ties all of the HEL-NC-PAs into the daisy chain together such that the aramid yarns take the load of the pull and release the load from the cables. In a similar way, the devised configuration and installation procedure ensures that one HEL-NC-PA does not transfer the load applied to a given cable beyond no more than one (the next one) HEL-NC-PA in the daisy chain. From thereon, a cable has only to support its own pulling, and since it will be pulled by the AYs attached to the subsequent HEL-NC-PA in the daisy chain This configuration means that the load for any given cable is one HEL-NC-PA hop away from being transferred to the common rope linking all HEL-NC-PA together.

The grooves within pulling attachments which are formed helically may have a re-entrant profile, wherein the opening of the groove is less than 180 degrees, e.g. a groove has an opening of about 120-degrees at the top, or about 150-degrees at the top, for example, thus allowing the cable to be press-fit and snapped into the groove of the HEL-NC-PA, at one of the entrances, exit or along the path of the helical groove in the HEL-NC-PA.

The grooves formed helically serving to hold the aramid or rope can have a re-entrant shape with a narrower slit opening at the top (narrower than 180 degrees), thus allowing the rope to be press-fitted and fitted entirely within the groove, where the re-entrant portion of the groove is at one or more of an end of the pulling device, a distal end of the pulling device, or a predetermined portion of the path of the helical groove in the HEL-NC-PA.

The grooves can intersect one another within the HEL-NC-PA, allowing a cable groove where the cable is stripped to the aramid to have its aramid jump into a rope groove at an interim location than at the extremity of the HEL-NC-PA, thus allowing the HEL-NC-PA to have a profiled ends within each HEL-NC-PA without needing to have the diameter of the HEL-NC-PA make room for the pull rope transitioning from one cable groove to the other cable groove. The profiled ends (not illustrated but similar to FIGS. 51 and 52 for example), reducing a likelihood of the pulling device catching being caught or stuck on a discontinuity of a surface which the pulling device contacts during the pulling operation. The profiled end(s) may also provide for the elimination of the need to use a tape, e.g. electrical tape, at the interfaces of HEL-NC-PAs in a daisy chain of HEL-NC-PA.

The inventors view this installation procedure as an invention which provides the benefits of scalability, expandability, casiness of use, reliability, and predictability in the outcome of pulling operations, which are essential attributes for anyone to be willing to make use of such a tool.

Within an embodiment of the invention the inventors also consider a commercialization process for pulling devices according to embodiments of the invention wherein a purchase of a pulling device according to an embodiment of the invention provides a license to employ an installation process, such as that depicted by first and second Flows 7700A and 7700B in FIGS. 77A and 77B respectively, for a number of installation instances. As a pulling device according to an embodiment of the invention may have a substantial lifetime, the number of deployments, installations, uses would clapse over time, and the end-users would be able to re-license the right to use the installation procedure with the pulling device according to an embodiment of the invention.

The procedure described and depicted in first and second Flows 7700A and 7700B in FIGS. 77A and 77B respectively may also be employed without AYs for other cables, such as Cat X cables for instance, or other cables which do not have an aramid strength member inside, without need for the grooves for the aramid attachment. However, it is expected that given the availability of this solution, many will strive to take advantage of the opportunity to attach to both the cable and the aramid, in a convenient and inexpensive way, to ensure that installations do not lead to cable failure, which especially relevant for optical fiber cables which can be pulled much more strongly that other cables, such as Cat X cables which are limited to 25 pounds in the T568 standard. The inventors also believe these other reasons, namely convenience of installation and stronger pulls, which will favor use of optical fiber instead of Cat X in the future even discounting the fact that copper is more expensive than optical fiber at present.

This configuration with two cable grooves per HEL-NC-PA, scales linearly minus 1, with the number of cables to pull, with N−1 HEL-NC-PAs employed for pulling on N cables. This is because the HEL-NC-PA has only 2 cable grooves of single depth. However, should the HEL-NC-PA have 2 cables of double depth, it would be possible to pull on twice as many cables potentially. Should the HEL-NC-PA have 3 cable grooves of triple depth, it would be possible to pull on 9 cables, per HEL-NC-PA, allowing fanning out to 9 other HEL-NC-PA, which if also having 3 cabling grooves of triple depth, could enable pulling on 8 cables at the 2nd stage, allowing for 63 cables to be pulled in only 2 stages. The staggered pulling configuration makes it possible to assemble a large pulling configuration with a copy of the same HEL-NC-PA in potentially few stages.

However, one of the principal goals in a pulling operation is to minimize the diameter of the overall bundle of cables. Necessarily, the HEL-NC-PA increases the overall diameter of the bundle of cables because the cables are inserted in a helical groove which means that a device with 2 cable grooves plus 2 rope grooves, occupies the cross-section area of between 4 and 6 cables. However, by daisy-chaining the same configuration of the HEL-NC-PA, the worst diameter of the bundle remains proportional to the number of cables. That is roughly proportional to the number of cables plus 4 to 6 more cables, at any point in the daisy chain. This makes it possible to pull a lot of cables in a small diameter conduit, which otherwise may not be possible to achieve with a single stage HEL-NC-PA with a large diameter. Furthermore, the length of the device can be minimized, which makes it possible to pull through 90-degree bends of a smaller radius which may not be possible to pull through with a longer device required to have more grooves for more cables. Truly, the staggered configuration must be studied and optimized in the case of pulls with many cables. However, for the bulk of pulls with few cables, the length of the staggered setup can remain manageable, for instance with an HEL-NC-PA measuring 14 cm, a pulling operation of 11 cables of 4.8 mm, with aramid attachment would require 11 unit daisy chain plus a gap of 2 cm between devices, so roughly 16 cm*11=176 cm. While this may be long, it is manageable and the overall bundle would be equal to at best 16.63 mm=SQRT (4*(12*(PI*4.8\hat{ } 2/4))/PI), which means that the overall bundle would increase by 4 to 6 more cables, so the overall bundle, at the worst location, would then become based on 6 more cables 20.36 mm=SQRT (4*((12+6)*(PI*4.8\hat{ } 2/4))/PI), which means that it would be possible to pull a bundle of 12 cables of 4.8 mm in a ¾ inch pipe.

One alternative to a staggered configuration that results in a long daisy-chain, is to divide it into parallel sections. For instance, with the same HEL-NC-PA with 2 cable grooves and 2 rope grooves, if one were to build two parallel trees of 6 cables to pull on 12 cables, then the daisy chain would only need to have 5 HEL-NC-PA each. The initial start diameter would be twice as large as before. With the same logic, pulling on 12 cables with 4 parallel trees would require 8 HEL-NC-PA of this configuration of 2 cable grooves, but the initial diameter would be 4 times larger.

Since the HEL-NC-PA can be manufactured with a material that is flexible and since the helical grip retains its grip force although bent, this makes it possible to pull through a 90 bend with a small bend radius.

The staggered configuration provides a naturally profiled tip, which means that when wanting to use one's hand to grab on the cable bundle as opposed to a pulling device attached to the pulling eye, the staggered configuration enables the overall bundle at the worst location to be further away and consequently, the smaller bundle diameter of the profiled tip, is able to fit in a user's hand. Accordingly, as user's hand sizes vary the staggered configuration allows users to size the bundle to their hand. The naturally pulling device according to an embodiment of the invention tip also favorizes steering the bundle tip during a pulling operation by placing the tip into tension with a pulling rope attached to the pulling eye formed at the tip of the bundle with the aramids inside the cables.

The embodiment of the pulling attachments, such as HEL-NC-PA presented here, and other embodiments of the invention are referred to as “HeliPullers” by the inventors.

A HEL-NC-PA according to an embodiment of the invention provides four grooves helically formed around a cylindrical shaped body. The grooves are made to be optionally re-entrant profile at the ends of the HEL-NC-PA and optionally re-entrant between these ends. The re-entrant angle may be set to allow the cable to be press snapped into the opening, e.g. a 120-degree or 150-degree opening for example, at the top of the re-entrant groove, preventing it from falling out of the groove and thus avoiding needing to secure the cable in the groove with tape such as electrical tape. The dimensions of the grooves are set to be 4.8 mm and 3 mm, which are the two most popular cable diameters for single fiber ruggedized bend insensitive and potentially self-bend limiting cables used for fiber-to-the-home (FTTH) installations. The proposed embodiment is configured with 2 helical grooves of 3 mm diameter and 2 more helical grooves of 4.8 mm in diameter. The idea is that the same SKU of HeliPuller can be used with either 3 or 4.8 mm cables. In the case where 3 mm cable is to be pulled, the 4.8 mm grooves would serve to wind the aramid into. In the case 4.8 mm cables are used, the aramid would be wound in the 3 mm grooves.

The idea is to build the tree from the bottom by unspooling from the next box, a little bit longer than what has been unspooled from the last box of cable, to extend beyond the frontmost HEL-NC-PA in the daisy chain. This way the tree is built by daisy chaining yet one more in front of another instance of the HEL-NC-PA, towards the tip of the daisy chain (i.e. towards the furthest distance from the root). Upon deciding to add another cable to the bundle of cables to pull, it shall be easy to just unspool, from box of the cable that is meant to be the longest drop, a little bit more length to cover the length of one more HEL-NC-PA at the front of the daisy chain, and which will become the first HEL-NC-PA in the chain. The cable meant to be the longest cable of the bundle, will then be stripped to the Aramid for a length corresponding to the length of the first HEL-NC-PA in the chain optionally multiple by two for double wounding around the HEL-NC-PA, plus the length of anti-slip knots and the excess aramid serving to form pulling eye at the front of the chain.

The method for adding cables the bundle involves adding HEL-NC-PA's in a daisy chain by letting a portion of a cable added to the bundle exceed the length of the HEL-NC-PA to which it is attached, by a little more than the length of the HEL-NC-PA for the sheath section and by up to triple the length of the HEL-NC-PA for the portion of the cable that will be stripped to the aramid.

The method ideally starts by attaching cables to the before last HEL-NC-PA in the daisy chain and building the daisy chain upwards to the tip of the daisy chains. One cable locally attaches to the HEL-NC-PA and the other cable transits through the local HEL-NC-PA and is ultimately attached to the next HEL-NC-PA, both by inserting them in the cable groove of the next HEL-NC-PA as well as optionally attaching that same cable by their aramid by lopping them either backward, or backward and forward, in one or both cabling grooves. When the cables are loop backwards and forward, backward in the first cabling groove, and forward in the second cabling groove, it enhances the grip, where then a single knot will lock the cable in place. However, the knot must be made once the second cable is attached to the other cabling groove.

The last cable is also attached at the tail of the daisy chain, the one going in for the first drop (floor or the first room or access point in a hall), is stripped of its sheath and optical fiber, skinned to the rope, to provide the longest rope, attaching the last cable to the last HEL-NC-PA in the daisy chain, but allowing that rope to also loop back across the last HEL-NC-PA in the daisy chain (so total rope length=(N+1*(HEL-NC-PA+Gaps between+(Anti-slip Knots*2))) and then whirled into all of the other HEL-NC-PA in the chain to then become the main rope for the pull eye at the tip of the daisy chain. For greater grip, one or more anti-slip knot can be formed on each HEL-NC-PA at one of the beginning, middle or end of each HEL-NC-PA, optionally taking advantage of the helical cable groove otherwise used to locally attach a cable into an HEL-NC-PA.

So far, we have been describing a rooted staggered tree where minimal distance separates each HEL-NC-PA. However, it may be desirable to implement a distributed staggered tree, (where each HEL-NC-PA is attached at set offset from the first one, corresponding to the distance between two drops plus their drop tails (the height of a floor, or the distance between two rooms or access points in a hall, plus the tail for that drop). Given the distance separating the HEL-NC-PA in the daisy chain, it may not be desirable to strip the last drop in the daisy chain from this much sheath to get to the aramid which would interconnect all to the HEL-NC-PA to one another in the daisy chain. Accordingly, it may be preferable to make use of a dedicated rope to interconnect all the HEL-NC-PA in the daisy chain. Doing this will work best by unspooling the rope from the opposition direction from which the cable locally attached to the HEL-NC-PA is unspooled from its box. This way, as more HEL-NC-PA are being added to the chain, more rope is unspooled from its box. It will be necessary to undo all of these rope attachments and to re-do them later if wanting to make use of anti-slip knots, so for this, a forward, backward and re-forward winding across each HEL-NC-PA, as they get added to the chain, will provide sufficient grip such that anti-slip knots will not be required for the common rope. This is one of the reasons where the rope grooves in the HEL-NC-PA need to be potentially bigger than the diameter of the cable itself, due to the multiple back and forth across the rope grooves. This is another reason where the flat ends of the HEL-NC-PA serve as a good anchor for the aramid or rope to go around and may be preferable than intersections between cabling grooves and rope grooves accompanied by pointy tips on the HEL-NC-PA, as they would accommodate a common pull rope of a distributed staggered configuration.

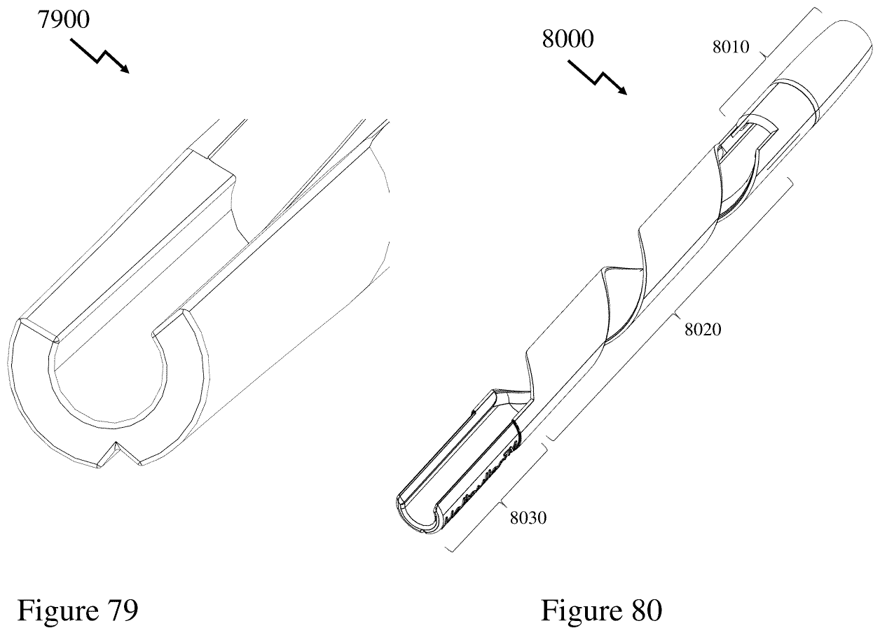

According to embodiments of the invention a HEL-PA provides a longitudinal grip in the form of a groove for a cable. Referring to FIG. 79 there is depicted a perspective view of a rear groove of a HEL-PA according to an embodiment of the invention with a 120° opening to “pinch” the cable rather than a 180° opening. With such a 120° opening the groove provides an improved “grip” through pressure and/or friction between the round cable in the U-groove when compared a groove with a 180° opening. The cable is incrementally forced into the pinched U-groove during assembly with the HEL-PA which leverages the elasticity of the material forming the HEL-PA to expand whilst the cable is inserted and then seek to return back to its original form after the cable is inserted. A moderate Young's modulus being required to allow the HEL-PA to flex but return and grip for the material of the HEL-PA in this region whilst the insertion of the cable does not result in that region of the HEL-PA being “forced” past its clastic deformation limit.

Alternatively, the soft sheath of the cable will also perform the same task of being contracted as the cable is pushed into the U-groove grip and expand back within the U-groove grip when materials of lower elasticity (higher Young's modulus). If the U-groove did not expand and/or the cable sheath not compress then it would be very difficult to push a cable into the U-groove of a HEL-PA. The inventors refer to this 120° reentrant groove design as “PULR-Grip” and it is employed with a range of HEL-PAs according to embodiments of the invention for gripping cables where the HEL-PA then provides for attachment to pulling or pushing sticks, rope eyes, rotating heads, etc. A PULR-Grip can also be formed at the beginning or end, or both ends of a normal “HelicalGrip” (a HelicalGrip being the name given by the inventors to a helical groove within a HEL-PA without a re-entrant U-groove profile), thus preventing the cable from falling out of the HelicalGrip by keeping it under slight retentive pressure and/or friction within the HelicalGrip. Each groove within a HEL-PA according to an embodiment of the invention may have one or more portions comprising PULR-Grips and one or more portions comprising HelicalGrips.

FIG. 80 there is depicted a perspective view of a HEL-PA 8000 according to an embodiment of the invention with “pinch” regions at the entrance to the helical grip nearest the head of the HEL-PA as well as at the rear. Accordingly, HEL-PA 8000 comprises a Head Portion 8010, Groove 8020, and Rear Portion 8030. The end of the Head Portion 8010 as it transitions to the Groove 8020 comprises a region designed as PULR-Grip as does the Rear Portion 8030. The Groove 8020 being designed as a HelicalGrip.

The inventors has established that the PULR-Grip can be injection molded without the need for a core pin during molding. This is achieved via the re-entrant mold profile mimicking a 240° coverage of the cable circumference held on a 120° wide base. The mold can be formed through AM or non-AM processes and has been shown by the inventors to be easily 3D printed as opposed to machined. The resulting PULR-Grip dues to its elasticity can be ejected from the mold in a similar manner to that if it was being unsnapped from a cable, allowing for high-throughput injection molding.

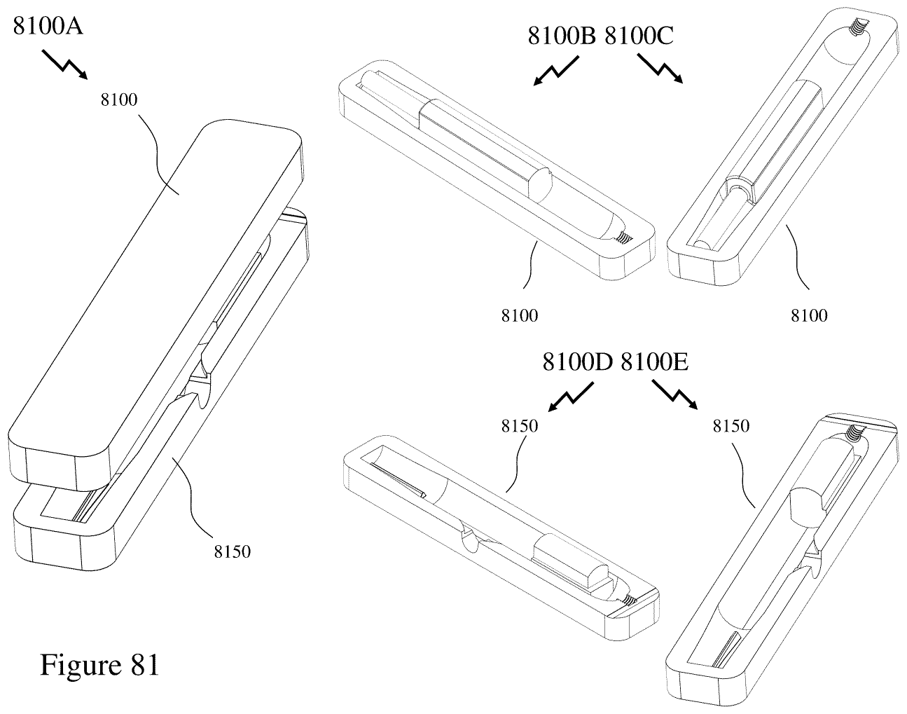

Now referring to FIG. 81 there are depicted perspective views of a 2-part injection molding mold for fabrication of a HEL-PA according to an embodiment of the invention such as depicted in FIG. 80 wherein the requirement for a core pin is removed. First Image 8100A depicts the upper and lower Mold Portion 8100 and 8150 respectively. Second and third Images 8100B and 8100C respectively depicted front and rear perspective views of the upper Mold Portion 8100. Fourth and fifth Images 8100D and 8100E respectively depicted front and rear perspective views of the lower Mold Portion 8150.

The PULR-Grip (the longitudinal 120° opening pinched U-groove) and HelicalGrip (helically wound U-groove, pinched or not) allow for single handed use and operation by a single installing operative of a HEL-PA with respect to a cable in contrast to prior art approaches of using electrical tape to attach a cable to a pulling stick which is generally a two handed operation, or even two person operation. Single hand operation to wind electrical tape around a cable to secure it to a pulling stick or to compress the metal mesh of a Vivien and Kellems Grip onto the soft cable sheath, is generally impossible and two handed operation is necessary. The invention as described herein is unique in their ability to enable an installation technician able to use only one hand to install the HEL-PA onto a cable, either through a disability of the installation technician or the installation technician currently using their other hand for another function such as holding a ladder, a joist, etc.

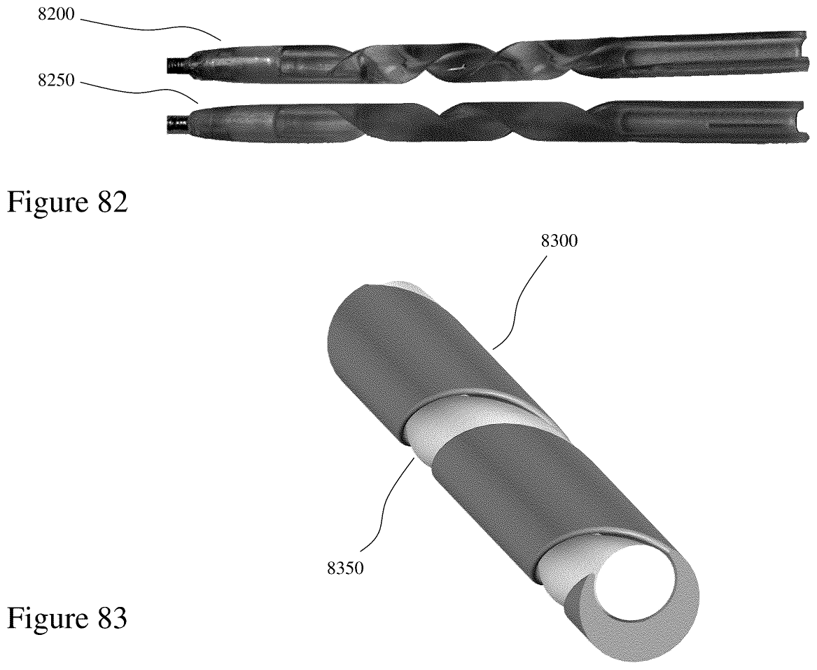

Accordingly, the inventors have established as depicted in FIG. 82 HEL-PAS according to embodiments of the invention with counter-clockwise and clockwise grooves. A clockwise formed HelicalGrip allows for intuitive and convenient right-handed winding of the cable in the HelicalGrip, whether singlehanded or not, whilst a counter-clockwise HelicalGrip allows for intuitive convenient left-handed winding of the cable in the HelicalGrip, whether single handed or not. Accordingly, an installation technician can employ HEL-PAs according to embodiments of the invention with HelicalGrip that is optimized for either left-handed or right-handed people or which they find easier to use independent of their handedness.

The inventors have extended the improvement to the HelicalGrip allowing for a re-entrant profile by employing the same 120° opening re-entrant profile of the PULR-Grip, but formed on the longitudinal helical path of HEL-PAs according to embodiments of the invention. This provides, not only the benefit of increased retention force longitudinally, but also prevents the cable from falling out of the groove without requiring for a PULR_Groove at an end of both ends. This improved HelicalGrip would be exceptionally hard to machine with a 4-axis CNC ball-nosed end-mill, due to the re-entrant profile of the HelicalGrip. However, the inventors have successfully and cost-effectively manufactured this improved HelicalGrip with a re-entrant profile, using a combination of parametric 3D design and additive manufacturing techniques. For example, the inventors manufacture routinely over 100 devices printed vertically, at the same time, on a 10-inch platter MSLA printer with UV-curable photo polymeric oligomer-based resin.

Referring to FIG. 83 there is depicted a perspective view of a HEL-PA according to an embodiment of the invention upon a cable depicted a re-entrant profile of the HEL-PA with 120° opening in a similar manner to that depicted in FIG. 80 along the main longitudinal portion of the HEL-PA. As depicted the Cable 8350 is within the HEL-PA 120° recentrant helical Groove 8300 of the HEL-PA according to an embodiment of the invention. Within FIG. 83 the opening was specifically reduced to 80° to make it visually easy to see the re-entrant profile of the HelicalGrip. In a normal PULR-Grip, a 120-degree opening is sufficient to allow for a good snap. An 80-degree opening is perhaps excessive but could be implemented as can other angles achieving the desired reentrant profile with low force insertion. For example, the reentrant profile may be any angle between 120° and 180°, any angle between 100° and 150°, any angle between 90° and 120° etc.

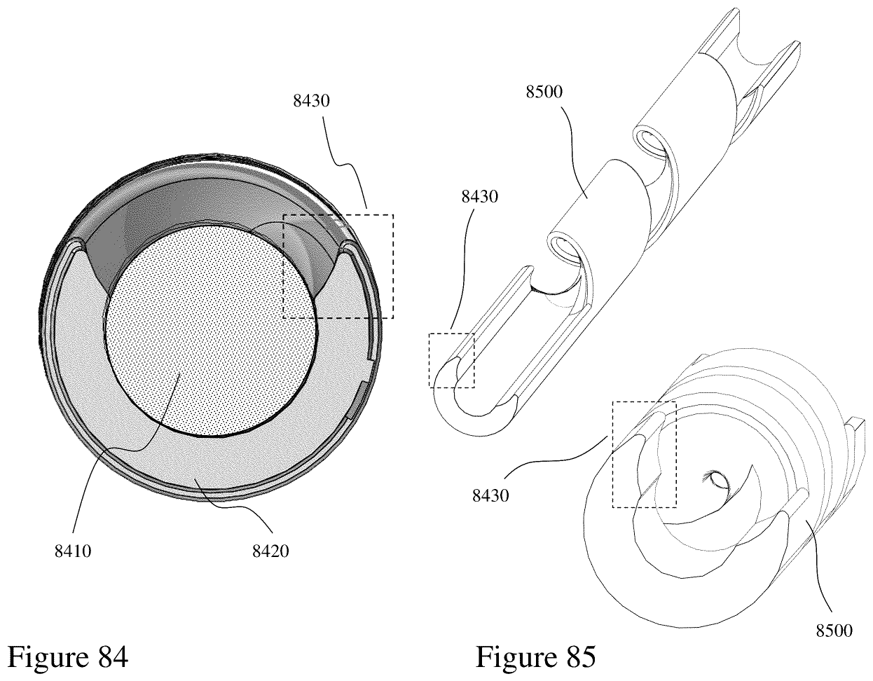

An improvement for the HelicalGrip, referred to a “Re-entrant HelicalGrip” by the inventors, adds the same re-entrant pinched profile of the PULR-Grip, but at the top of the Helical U-groove, while at the same time having the axis of the Helical U-groove offset from the axis of the HEL-PA such that the Helical U-Groove is into the HEL-PA than when it is formed as the HelicalGrip. However, the axis of the HelicalGrip of a HEL-PA may also be offset in a similar manner without departing from the scope of the invention. This decentering provides for a relaxation of the HelicalGrip, which can be controlled geometrically by adjusting the depth of the HelicalGrip. FIG. 84 depicts an end view schematic of a HEL-PA according to an embodiment of the invention with a reentrant profile such as described and depicted with respect to FIGS. 80 and 83 wherein the position of the cable has been offset from the centre of the HEL-PA so that the cable sits deeper within the HEL-PA. This depicts the HEL-PA 8420, Cable 8410 and the profile of the groove where the cable is inserted is highlighted by Region 8430.

A nominally circular cable sitting in a deeper HelicalGrip is effectively i) much “looser” in the HelicalGrip and ii) placed in a manner that is less out of axis (i.e. straighter) and iii) makes contact with less of the HelicalGrip core surface. These are contributing factors to less retention between the HEL-PA and the cable using such as offset HelicalGrip. This reduction in retention be configurable through the geometrical design of the HelicalGrip rather than by material selection. This grip relaxation mechanism through the re-entrant pinched profile at the top of the U-groove prevents the cable from falling out, without need for a PULR groove at the beginning, or end or both ends to secure the cable in the HelicalGrip. Referring to FIG. 85 there are depicted full and detailed perspective views of a HEL-PA according to an embodiment of the invention exploiting the design depicted in FIG. 84 for the groove of the HEL-PA. Accordingly, the HEL-PA 8500 is shown two full perspectives at different viewer orientations where in each the Region 8430 is depicted.

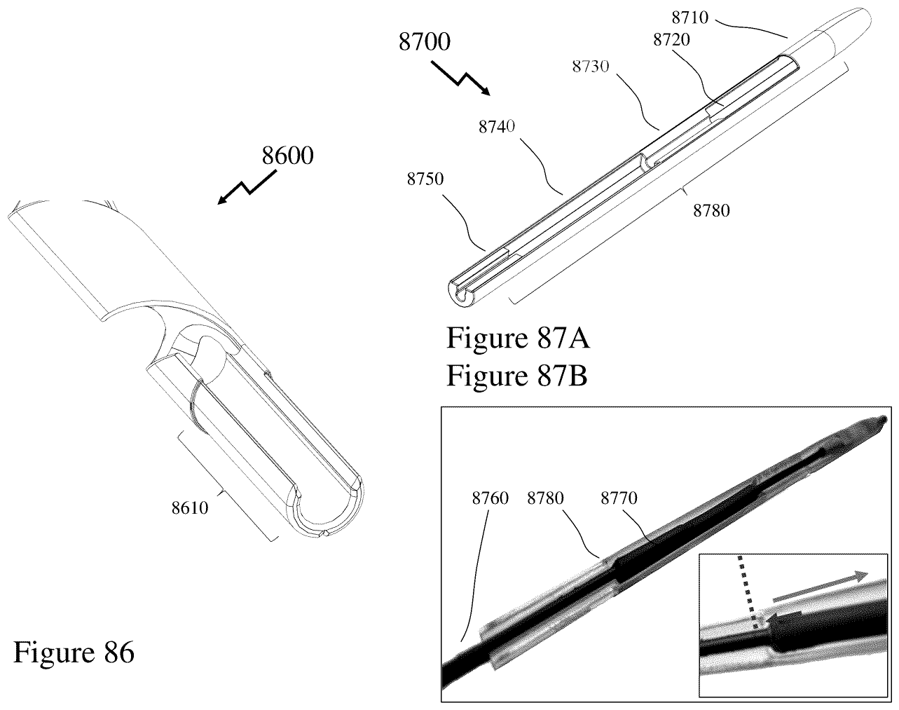

Whilst a PULR-Grip allows a cable of diameter approximating the diameter of the PULR-Grip to snap into the re-entrant groove of the PULR-Grip, a cable of much smaller diameter will not snap (as if inside a U-groove with a 180° opening). In order to secure a cable in such a U-groove, it was expected by the inventors that installers would add a short roll of tape (electrical or other) around the PULR-Grip section entering or exiting or both entering or exiting the HelicalGrip, to close the opening of the PULR Groove in order to prevent a smaller diameter cable from falling out. However, doing so, would increases the diameter of the overall diameter of the cable pulling assembly such that the tape would interfere with the pulling operation inside a hole or conduit very close to the diameter of the cable pulling adapter. The inventors have therefore as depicted in FIG. 86 designed a variant HEL-PA wherein a region of the HEL-PA outer diameter is reduced. Accordingly, in FIG. 86 the HEL-PA 8600 has a Region 8610 with reduced external diameter.

This reduced diameter is designed to be a multiple of a thickness of a tape being applied around the HEL-PA to retain the cable. This Region 8610 may be, for example, on the sections of entering or exiting a HelicalGrip portion of a HEL-PA, such that a length of tape up to some maximum (as defined by the thickness of the tape) when wound around the Region 8610 it does not increase the overall diameter of the assembly beyond the that of the other sections of the HEL-PA. This would make it possible to avoid having the electrical tape being one or more points of enlargement preventing the HEL-PA fitting inside the intended hole or conduit or having the tape getting caught up on the walls of the hole or conduit.

Within the description above HEL-PAs according to embodiments of the invention for a pre-terminated patch cable take advantage of the molded boot as a “back hook” for pulling on the cable without applying pressure on the connectorized portion of the patch cable. The HEL-PA engaging on the rear portion of the molded boot providing this “back hook.” However, some pre-terminated fiber optical cables employ heat-shrink tubing or similar to make the transition between the front section, referred to as a flat drop section, and the rear, referred to as a round section, in a similar manner as heat-shrink tubing would protect cables at a furcation unit. The heat-shrink tubing having a diameter larger than the flat drop section thereby provides a similar back-stop as a boot, and being heat-shrunk (heat activated glued+shrinking) has similar properties to that of an over-molded boot (i.e. rigid) and can effectively serve as a back-stop onto which a HEL-PA can engage and providing greater pulling force than the grip force of the HEL-PA itself on the flat drop portion of the cable.

Referring to FIG. 87A there is depicted a perspective view 8700 of a “flat-drop” HEL-PA (FD-HEL-PA) according to an embodiment of the invention for use upon cables with heat shrink tubing protecting a transition from cabled to non-cabled portions of the cable. Accordingly, the FD-HEL-PA comprises a Front Portion 8710, a first Region 8720 within which that portion of the connector not accommodated within the Front Portion 8710 fits, a Middle Portion 8730 that guides or grips the inner cable section of the cable, a second Region 8740 within which the portion of the cable with heat-shrink tubing (or whatever tubing/elements are used to protect the transition) are disposed and End Region 8750 which grips the end of the cable.

Now referring to FIG. 87B there is depicted a photograph of the “flat-top” HEL-PA according to an embodiment of the invention as depicted in FIG. 87A assembled with a Cable 8760 and Heat-Shrink Tubing 8770 disposed with the FD-HEL-PA 8780.

Amongst the challenges in molding the groove within a HEL-PA or PULR is the creation of the cavity to transition from a section of a tubular section with a slit opening at the top to enter connector/cable into which transitions to a fully tubular section without a slit opening at the top and which is then capped at the end to form the head of the cable pulling adapter, which makes the transition to the point of attachment to the pulling means. This requires creating a complex mold with an actuated core which must be actuated on two axes, (e.g. pulled back then pulled up). In order to avoid having to perform such complicated and potentially low yield actuated core pulls inside multi-cavity molds, the inventors have created a simpler mold design where the bottom half section of the mold has a section for the cable pulling adapter body that extends above the parting line to form the “roof” of the cavity section protecting the connector, effectively creating a “hole” in the floor of the cable puling adapter in the tubular body, opposite it the “roof”, i.e. the “chicane”.

It would then be evident that one can create multiple transitions between holes at the bottom and roofs at the top, which is called a “multi-chicane”, but this creates multiple locations where “flashing” can occur and will wear the mold quickly where the top half and the bottom half of the molds meet up to create the “chicane”. The chicanes approach create holes in the roof or floor of the body section of the cable pulling adapter and this is not desirable as it creates failure points on the contiguous sides.

The inventors have encountered and address this manufacturing challenge by establishing a cost effective high-yield manufacturing alternative to the chicanes and multi-chicanes. In this alternative the HEL-PA is made as a two-part component, where the two parts would be joined together as a subsequent manufacturing step after injection molding, e.g. by ultrasonic welding for example. Such a two-part design also allows for the head to be manufactured separately from the rest of the cable pulling adapter, allowing a common body to be employed with different heads conforming to the desired method of attachment such that the appropriate parts ordered are manufactured by pulling inventory of the appropriate parts and joining or fabricating the piece parts and joining.

In generally, the inventors have to date made threaded ends with male threaded studs conforming to various well known pulling sticks employed in the market such as #8-32, M5×0.8 mm and ¼ UNC 20 TPI. However, in this manufacturing methodology each head may be a different SKU which are all joined to a common SKU for the common HEL-PA across all head variants. Alternatively, a large number of final products can be made from a number of head part SKUs and body portion SKUs.

As the body section of the cable pulling adapter being no longer capped would allow for a core pull to be employed to form the tubular section with normal tapering to facilitate an easy core pull. The head section would similarly be molded as uncapped on the section mating the tubular section of the body of the cable pulling adapter, thus also allowing the use of a core pull operation to manufacture this end.

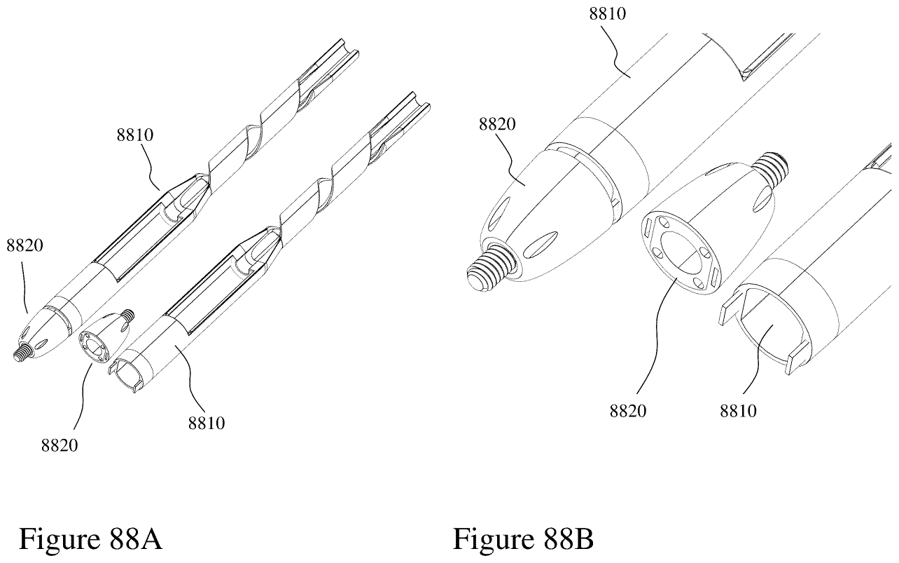

Accordingly, whilst in this specification most HEL-PAs may be described as being manufactured as single piece part it would be evident that two or more piece parts may be employed without departing from the scope of the invention. For example referring to FIGS. 88A and 88B there are depicted perspective views of a two-part HEL-PA according to an embodiment of the invention in assembled and unassembled form allowing different “head portions” for attachment to different pulling means to be mounted to a common HEL-PA body or different HEL-PA bodies according to an embodiment of the invention. As depicted in FIGS. 88A and 88B a HEL-PA Head 8820 is depicted together with HEL-PA Body 8810 as discrete elements and as partly assembled towards the final HEL-PA. For example, ultrasonic welding, thermo-compression welding, laser welding, epoxies, glues, resins or other mechanical jointing mechanisms may be employed to join the HEL-PA Head 8820 with the HEL-PA Body 8810. Optionally, a second “molding” process may be employed to join the piece-parts together.

It would also be evident that different adapters between a pulling means and the HEL-PA may be attached to the threaded end of the HEL-PA. Within other embodiments of the invention a HEL-PA with a male threaded end, for example, is fabricated and different heads are attached allowing for pull-eyes, female threaded couplings, different male threaded ends etc. In this manner a single SKU HEL-PA can be employed and adapted in the field to suit the particular pulling by a technician adding the appropriate adapter to the HEL-PA. Accordingly, the HEL-PA may be a single piece-part or multiple piece-parts and still remain within the scope of the invention.

Within embodiments of the invention the HEL-PA Head 8820 may encompass a first portion of a connector of a pre-terminated cable and the HEL-PA Body 8810 a second portion of a connector of the pre-terminated cable. For example, the body of an optical connector may be within the HEL-PA Body 8810 whilst a ferrule of the optical connector is within the HEL-PA Head 8820. Optionally, the first portion of the connector may be 0% or a non-zero percentage.

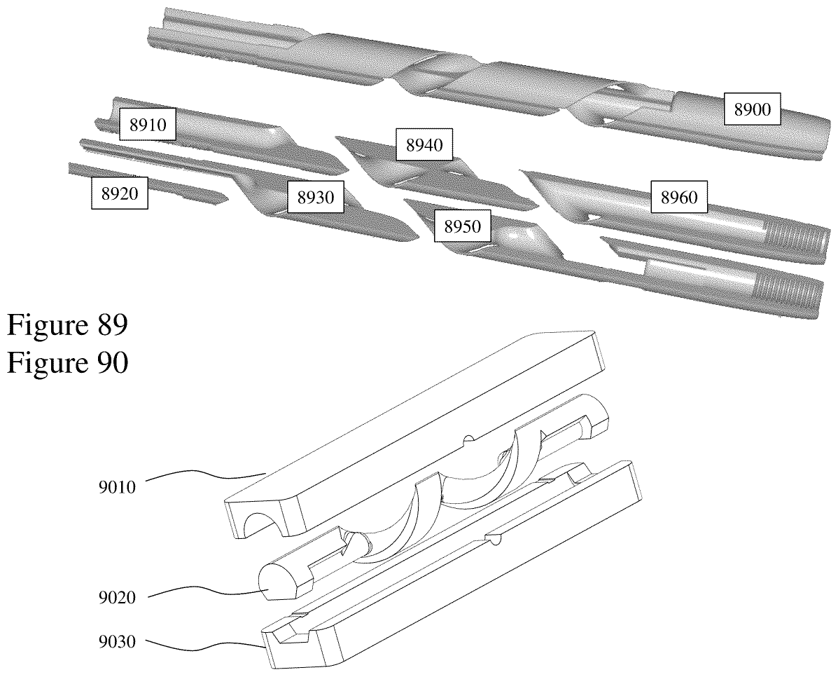

The inventors have also formed HEL-PAs according to embodiments of the invention as a number of discrete piece-parts which were molded individually and subsequently assembled using ultrasonic or laser welding, for example, to form the final HEL-PA. Referring to FIG. 89 there is depicted such a multi-element injection molding strategy for a HEL-PA according to an embodiment of the invention wherein the multiple molded elements are subsequently joined to form an HEL-PA according to an embodiment of the invention. Within FIG. 89 the HEL-PA was designed for a Category 6 cable assembly. Initially first to sixth piece-parts (PPs) 8910 to 8960 are formed individually. Then, for example, first PP 8910 and second PP 8920 are jointed together. Then third PP 8930 is flipped onto first PP 8910 forming third PP 8930-first PP 8910-second PP 8920, then fourth PP 8940 is flipped onto third PP 8930-first PP 8910-second PP 8920, forming a fourth PP 8940-third PP 8930-first PP 8910-second PP 8920 interim assembly, then fifth PP 8950 is further flipped on to the fourth PP 8940-third PP 8930-first PP 8910-second PP 8920 subassembly, forming a fifth PP 8950-fourth PP 8940-third PP 8930-first PP 8910-second PP 8920 subassembly then have finally sixth PP 8960 is flipped onto the fifth PP 8950-fourth PP 8940-third PP 8930-first PP 8910-second PP 8920 subassembly forming the whole structure, HEL-PA 8900, ready for a subsequent joining, welding, molding or consolidation process. It would be evident that the sections may incorporate structural alignment features or features for enhancing a subsequent joining process. It would be evident that within other embodiments of the invention the HEL-PA may be formed as single piece part or N piece parts where N≥2 and is an integer.

The inventors have described within this specification cable pulling adapters for pulling on fiber optical cables containing both longitudinal PULR-Grips for the cable sheath and fiber optic core transitioning to a HelicalGrip for the cable stripped to its aramid where the aramid is wound in the HelicalGrip extending the PULR-Grip, for one or cables in the same apparatus. However, this can be extended by treating the metallic conductor(s) of an electrical cable in the same manner as aramid fiber(s) and having the electrical cable stripped to its metallic conductor(s) which are then wound in a HelicalGrip extending the PULR-Grip for both the cable sheath and metallic conductor. As many electrical pulling techniques require stripping electrical cables to the metallic conductor and performing an attachment on the metallic conductors this allows the cable to be stripped, pulled and then the connector added.

The inventors have described within this specification variants for cable pulling adapters formed with multiple longitudinal PULR-Grips or multiple HelicalGrip grooves, potentially with different geometries to accommodate the simultaneous pulling of cables with different geometries. The methods and devices can be extended to multi-domain installations, such as the pulling of one or more fiber-optic cables at the same time as one or more electrical cables, using the same cable pulling adapter (HEL-PA), in one go, or multiple adapters (HEL-PAs) daisy chained together by a common core such as a common pulling threaded rod. Further, the applicability of such multidomain pulling and multi-domain HEL-PAs would allow the fiber optical cable to be attached into a longitudinal groove extending into a helical groove for its aramid while the electrical cable would have its copper/metallic conductor wound in a helical groove in the same manner as the aramid of a fiber optical cable whilst having its sheath and copper conductor attached to the longitudinal groove.

The inventors have also established a manufacturing method for affixing a threaded rod (metal or nylon) to a threaded hole of a MLSA additively manufactured part by dipping the threaded rod in light curable resin before screwing it into the threaded hole of a AM manufactured HEL-PA part (formed itself from a light curable resin) and then using the appropriate optical illumination to “grow” more plastic in the gap of the threads, thus increasing the friction, but not creating a mechanical bond between the metal and the plastic.

The inventors have determined, through extensive experimentation, that the HelicalGrip (i.e. the helical portion of a HEL-PA) should extend for at least 720° (i.e. two full turns of the cable around the center line of the HEL-PA) to the required grip force. This is provided that the HelicalGrip helical pitch remains a low multiple of the cable diameter. If this multiple gets too large, the HelicalGrip will lose its grip strength. If on the other hand, the pitch of the helix is too low of a multiple of the cable diameter, the cable will have a small bend radius in the helix which risks damaging the cable. For certain cables, which are not very flexible, the pitch of the helix of the HelicalGrip needs to accommodate this lack of ability to flex the cable. The inventors expecting a mathematical model to be established that relates the helical length to at least a measure of cable flexibility (a cable Young's modulus equivalent).

As noted within this specification the inventors have fabricated HEL-PAs according to embodiments of the invention with injection molding in a single molding step through the means of sacrificial cores reproducing a cable in curled configuration suspended inside the mold, where the core is either a dissolvable core, crushable, peelable, or a combination thereof. The inventors have further fabricated HEL-PAs by injection molding by separating the injected molded HEL-PA part from a 3D metal printed core reproducing a cable in curled configuration suspended inside the mold. Use of various injection molding materials with various durometers have enabled to make parts that are functional can be separated from the metal mold insert in various automated manners.

FIG. 90 there is depicted a perspective view of an injection mold for forming the molded HEL-PA according to an embodiment of the invention in a single molding step.

In accordance with an embodiment of the invention there is provided a method of attaching a cable itself by the sheath in a helical grip device according to an embodiment of the invention.

In accordance with an embodiment of the invention there are provided devices and methods of pulling cables by employing an aramid rope or aramid strength member of one or all cables to the same cable pulling device with helical grip(s).

In accordance with an embodiment of the invention there is provided a cable pulling device with two or more grooves formed helically, with a portion of the grooves serving to attach cables and another portion of the grooves serving to attach one of the aramid strength members of the locally attached cable or a common pull rope interconnecting all cable pulling devices within a daisy chain

In accordance with an embodiment of the invention there is provided a cable pulling device with one or more grooves wherein the grooves are formed helically and have a re-entrant shape with an opening less than 180 degrees in order to allow press-fitting and snapping of the cable into the cable pulling device, at one of a beginning, end or intermediate point along the path of the helical groove in the cable pulling device.

In accordance with an embodiment of the invention there is provided a cable pulling device with one or more grooves wherein the grooves are formed helically and have a re-entrant shape with an opening less than 180 degrees in order to allow press-fitting and snapping of a pulling rope into the cable pulling device, at one of a beginning, end or intermediate point along the path of the helical groove in the cable pulling device.

In accordance with an embodiment of the invention there is provided a method of using the aramid strength member of the shortest cable in a bundle of cables as the pulling rope for a daisy chain of pulling devices according to an embodiment of the invention whereby the aramid strength member of the shortest cable is employed to form a pulling eye allowing the transfer of pulling force from device to device within the daisy chain

In accordance with an embodiment of the invention there is provided a method of implementing a staggered configuration of pulling devices according to an embodiment of the invention which minimizes the overall diameter of the bundle of cables towards the tip of the bundle thereby providing greater maneuverability through sharp or small radius conduit bends, discontinuities in conduit bore diameter and easier handling for smaller hands.

In accordance with an embodiment of the invention there is provided a method of implementing a rooted staggered configuration of pulling devices according to an embodiment of the invention where all cables are pulled from one end with the pulling force being applied sequentially through the staggered configuration of pulling devices from that end to the other end.

In accordance with an embodiment of the invention there is provided a method of implementing a distributed staggered configuration of pulling devices according to an embodiment of the invention where cables are incrementally dropped through the staggered configuration.

In accordance with an embodiment of the invention there is provided a pulling method which avoids stretching cables, by making it possible to pull not only on the cable, but principally on the aramid strength members inside the cables, thus avoiding plastic deformation of the cable sheath and excessive strain on one of the optical fiber or copper conductors inside the cable, thus avoiding either potential breakage of the optical fiber or loss of optical performance on fiber optic cable or disrupting the twisting configuration of twisted pair cabling and potential or loss of performance on twisted pair cables or increased crosstalk.

In accordance with an embodiment of the invention there is provided a method of pulling cables which either reduces or eliminates the need for wrapping of a tape around the cable(s) thereby providing faster set-up and dismantlement of cable pulling assemblies.

In accordance with an embodiment of the invention there is provided a method which of pulling cables which removes the scrapping of a section of cable due to the cost or time in removing of a tape and/or residue on the cable arising from the from the use of the tape to bind the cable as part of a pulling assembly.

In accordance with an embodiment of the invention there is provided a method which eliminates the requirement for coiling back cables resulting from the unspooling from cable storage, e.g. cable boxes or cable drums, of longer sections than required where the correct length is unspooled by implementing a distributed staggered configuration of pulling devices according to an embodiment of the invention.

In accordance with an embodiment of the invention there is provided a cable pulling device which minimizes the number of stocks keeping units (SKU's) required and associated spares whereby the pulling device according to an embodiment of the invention supports pulling operations of bundles of cables containing more than one cable by daisy-chaining multiple instances of the pulling device according to an embodiment of the invention within a single daisy chain or multiple daisy chains in parallel to one another.

In accordance with an embodiment of the invention there is provided a method of reducing an overall length of a daisy chain of pulling devices according to an embodiment of the invention by employing multiple daisy chains in parallel.

In accordance with an embodiment of the invention there is provided a pulling device according to an embodiment of the invention with a helical groove of a shape which is designed according to different cable geometries like round, square, rectangle, peanut shape flat drop, figure-eight Siamese cables, hybrid cables, duplex cables, cable arrays, etc.

In accordance with an embodiment of the invention there is provided a pulling device according to an embodiment of the invention which can pull different cable geometries at the same time with multiple grooves or grooves of multiple configurations in the depth or lateral axis

In accordance with an embodiment of the invention there is provided a pulling device according to an embodiment of the invention which can secure the cable geometry in one groove and its aramid strength member, or rope, in another groove of the same apparatus, where the grooves are helically formed in the apparatus.

In accordance with an embodiment of the invention there is provided a pulling device according to an embodiment of the invention wherein helically formed grooves in the pulling device according to an embodiment of the invention intersect with other grooves thereby allowing aramid strength members of the cables or an aramid rope of a cable to transition from a cable groove to a rope groove or vice-versa.

In accordance with an embodiment of the invention there is provided a pulling device according to an embodiment of the invention comprising one or more cable groove(s) and no rope grooves wherein an attachment of one or more aramid strength members is made by knotting the aramid strength members around the pulling device according to an embodiment of the invention using one or more knots such as anti-slip knots whereby the aramid strength members upon pulling the pulling device according to an embodiment of the invention do not crush the cable which is secured inside a groove of the pulling device according to an embodiment of the invention.

In accordance with an embodiment of the invention there is provided a pulling device according to an embodiment of the invention comprising one or more rope grooves where aramid rope or aramid strength members of the cable are locally attached or passed through to form a common rope across a daisy chain of pulling devices according to an embodiment of the invention.

In accordance with an embodiment of the invention there is provided a pulling device according to an embodiment of the invention comprising two or more cable grooves formed helically around an outer surface of the pulling device according to an embodiment of the invention.

In accordance with an embodiment of the invention there is provided a pulling device according to an embodiment of the invention comprising two or more cable grooves formed helically around an outer surface of the pulling device according to an embodiment of the invention wherein the pulling device supports multiple cable geometries.

In accordance with an embodiment of the invention there is provided a pulling device according to an embodiment of the invention with cable grooves which intersect one another within the pulling device according to an embodiment of the invention allowing a cable groove to accept a cable stripped to one or more aramid strength members wherein the aramid strength members transition into a rope groove at an interim location along the length of the pulling device according to an embodiment of the invention between the ends of the cable pulling device such that the pulling device according to an embodiment of the invention comprises at least a profiled end for reducing likelihood of the pulling device catching and/or allow for reduced gap between two cable grooves formed upon the pulling device to accommodate a pull rope between the two cable grooves.

In accordance with an embodiment of the invention there is provided a method of daisy chaining a series of pulling devices according to embodiments of the invention in order to provide an M×N staggered configuration where a first pulling device according to an embodiment of the invention with M grooves serves to pull cables attached to the pulling device according to an embodiment of the invention each with N cable grooves, thus allowing pulling of M×(N−1) cables in a single pulling operation.

In accordance with an embodiment of the invention there is provided a method for adding common rope through a daisy-chain of pulling devices according to embodiments of the invention without need for providing one or more anti-slip-knots on each pulling device according to an embodiment of the invention whereby a common pull rope is being unspooled from the opposite direction as the cables are being unspooled as the daisy chain gets assembled and where the common rope is wound forward, then backward, then forward again across first, second and then first rope grooves thus avoiding the requirement to dismantle or break the common pull rope to create the one or more anti-slip-knots onto pulling device according to an embodiment of the invention.

In accordance with an embodiment of the invention there is provided an apparatus which enables the pulling operation to be implemented entirely dielectrically without any metal part, allowing pulling to be done inside epoxy covered conduits without scratching them or in explosive environments.

Beneficially the embodiments of the invention reduce the prior art approaches of cutting cables, bundling them together with tape and then applying a prior art tool such as a Kellem grip for example. Such prior art approaches being time consuming and wasteful of cable.

Within the preceding description with respect to embodiments of the invention reference has been made to aramid (aromatic polyamide) yarns (AYs) forming part of cables to provide strength members. Common aramid yarns are known by brand names including Kevlar™, Nomex™, and Twaron™. However, it would be evident that the embodiments of the invention may support other cables using other strength members including, but not limited to, metallic fibers, ceramic fibers, carbon fibers, phenolic resin fibers, glass fibers, and other polymer fibers.

Within the preceding description with respect to embodiments of the invention reference has been made to a groove or grooves within an outer surface of embodiments of the invention. These have been depicted as having cross-sectional geometries that are circular. However, it would be evident that within other embodiments of the invention the cross-sectional geometry may be square, rectangular, polygonal, regular, irregular etc. provided that it enables the insertion and/or retention of a cable, strength member(s), pulling rope etc. to the groove. Such grooves may also be referred to as slots, recesses etc. without departing from the scope of the invention.

Within the embodiments of the invention described above in respect of helical grooves within an MC-PA the high gripping force of the Pas, referred to hereinafter as a helical cable pulling attachment, are a reduced case of a cable being pulled out of a conduit with multiple bends in series with the specificity of an abnormally high fill factor approaching 100% (i.e. cable outer diameter is equal to the conduit inner diameter). A better analogy is that of attempting to pull a conduit away from the cable by attaching one end of the cable and pulling on the conduit. By winding the cable into the helical groove, it is as if the not pulled into the conduit, but pressed into the conduit from a slot at the top. The friction forces due to the multiple bends prevent the conduit from sliding away from the cable. Now, given that the conduit is helical (a helical groove), the bend radius per unit length of the cable is increased. The opening in the slot of the U-shaped entry in the groove represents a reduction of the “pipe area.” From a materials perspective, the cable typically has a PCV sheath which if mated to a “slicker” plastic in the forming the helical groove in the cable pulling attachment, would also naturally affect the effective coefficient of friction.

Whereas a single cable contacts the bottom of the-U shaped groove or the cable below another cable in the case of a groove with multiple cables stacked onto one another this affects the coefficient of friction which becomes a function of the cable contacting the walls of the U-shaped groove and surfaces of the cables above and below

Whereas a cable or multiple cables in a stack contact the walls of a re-entrant U-shaped groove, this results in a decrease of the frictional forces (when compared to a round conduit enclosing the cable) due to the “conduit” having less of a “slot” at the top and bottom of the top and the middle cable or cables in a stack (e.g., the 2^{nd} of 3, the 2^{nd} & 3^{rd} of 4, the 2^{nd}, 3^{rd} and 4^{th} of 5 cables, etc.).

Within embodiments of the invention the pitch of the helical groove within each advancement of the rotational angle of the helix may be continuous or it may vary.

The number of revolutions per unit of distance of the helical groove (also referred to as a “helix”) also impacts both the effective grip force of the helical cable pulling attachment as well as the imprint on the cable after being removed from the helical groove of the helical cable pulling attachment. A complete 360 degrees revolution in the helix which would occur across too great of a distance would reduce drastically the conversion of linear forces into compressive/friction forces rendering the grip force of the helical cable pulling attachment ineffective. Accordingly, the inventors have determined that for a 4.8 mm cable, the 4.8 mm wide helical groove in the cable pulling attachment should complete 720 degrees of revolution in about 8 centimeters in a diameter of 9 millimeters, providing a good balance between a) the compactness of the helical cable pulling attachment, b) its gripping force, and c) the imprint left onto the cable when removing it from the helical cable pulling attachment.

The helix can have a variable pitch within the limitations that too small of a pitch will leave an imprint or damage the cable beyond its minimum bend radius, and too large of a pitch will nullify the gripping force of the helical cable pulling attachment.

The compactness of the helical cable pulling attachment allows it to go across a conduit with a sharp bend radius.

The helix can be advantageously configured to case in and case out such as to transition a groove such that it begins or ends co-linear to the pulling axis at either distal end of the helical cable pulling attachment to then make its way within the limits of the minimum bend radius of the cable into a helix with a diameter which also respects the minimum bend radius of the cable inserted into the helical groove.

The helix can be right-handed or left-handed, without impact on the performance of the helical cable pulling attachment.

It may be possible for the helical groove of a re-entrant U-groove shape to be flattened onto a surface, for example, an S shape with large or small bend radius (too small a bend radius will create a cable pinch point which may damage it irreversibly) and rely strictly on the friction within the U-groove to provide the pull grip rather than the constriction force stemming from the linear pull force being converted to a compression force within the helical groove or grooves. Then the flattened surface may become the surface of an N-degree polygonal body (one S per side on 6 sides, 2 S per side on a triangle, etc.)

It may be possible for the re-entrant U shaped groove to be nearly closed at the top such as that when pressing the cable in the groove, the cable will disappear into the groove

It may be possible to employ grooves of different width, such as to enable pulling different cable types at the same time within the same MC-PA.

A Helical Cable Pulling Attachment may have groove paths that change into a counter-rotating helix thus breaking the slip out motion or providing a start point that avoids the cable from slipping as it is placed into a groove. Such a reversal of helix rotation being depicted in FIG. 52.

A Helical Cable Pulling Attachment may have a cone shaped end in the same way one skilled in the art of cable pulling would stagger multiple cables pulled with a rope such as to create a coned nose geometry facilitating the pulling and avoiding the head from catching on obstacles.

A Helical Cable Pulling Attachment may have a first portion of the groove in the axis of the cable state from portion of the groove with a roof over it, thus preventing the cables from ejecting outside of the groove.

A Helical Cable Pulling Attachment will usually one or more helical groove path(s) which is (are) cased in or cased out or both to a longitudinal path that is in the same axis as the pull, thus avoiding a pinching point by a sharp bend from the axis of the helix path to a longitudinal path in the axis of the pull.

It may be possible to revolve the helical groove about the center of the cable pulling attachment without the groove going deeper than the center, thus ensuring that there is no open central channel, thereby not reducing the pulling force.

It may be possible to relax the grip force of the cable pulling attachment by diminishing the amplitude where the U shape groove or re-entrant U shape groove is deeper than the center point of the Cable Pulling Attachment, which results in a reduction of the amplitude of the helical path and thus decreases the pulling grip accordingly.

Whereas one of the channels is about the same diameter as the cable and revolves around the helical path forming a linear hollow path through the helix, this allows pulling the cable following that channel first and making it then possible to pull all other cables, like a castle of cards falling. In a Groove of 3 cables, pulling the middle cable, which if following the center of the Helix, achieves this.

A Helical Cable Pulling Attachment groove design can be multiple times re-entrant with an opening of about 120-degrees, not only at the top, but at the transition from one cable to another cable stacked atop one another in the same groove, allowing each cable stacked to snap in place in each depth position of the same groove, noting that the groove may not need to be entirely vertical and be curved, allowing an optimal off-center path if required, and minimizing the overall diameter of the cable pulling attachment.

A Helical Cable Pulling Attachment groove design can accommodate a Siamese cable design which is a figure 8 style, such as a bigger coaxial bottom of the 8 and a smaller optical fiber top of the 8, which can fit upside down inside the groove, where the bottom of the groove would accommodate the optical fiber portion of the figure 8 cable and the top portion of the groove would accommodate the coaxial cable portion of the figure 8 cable.

A Helical Cable Pulling Attachment may allow grooves to intersect one another provided that the crossing is only employed once at a set cable depth in the groove.

A Helical Cable Pulling Attachment need not having a perfectly round shape on the exterior, for instance it may be octagonal, preventing the attachment from rolling on the table like a Pelican police flashlight. The outer shape could also be having the same kinds of bumps found on a golf club handle providing a more comfortable hand feel than a simple flat cylinder.

It may be possible for a Cable Pulling Attachment with N grooves of M cables to fit into another Cable Pulling Attachment of N groves of M cables, which would have a cavity for a first cable pulling attachment to fit inside. The first would be pulled by the 2^{nd}. And so on . . . .

It would be possible for a first cable pulling attachment of N groove of M cables to fan-out the cable exit such as to accommodate the size of a daisy-chained additional pulling attachment to be pulled at the back of a first one like a train pulling multiple wagons.

It would be possible for the pulling rod attached to the last Cable Pulling Attachment to be traversing through all parent Cable Pulling Attachments, such as to allow that pulling on the last one pulls all parent ones at the same time, and so on. It would also be possible to add other interim pulling locations as well.

A Helical Cable Pulling Attachment may be manufactured with additive manufacturing with resin or filament printers, metal printing, or machined with its groove patterned with a 4-or-greater-axis CNC mill, with injection molding through advanced dissolvable cores or very economically with a plastic extruder with a rotating die synchronized with the extrusion speed.

A Helical Cable Pulling Attachment with one or many grooves, with or without a cavity for a connector, may be co-linear, permanently, or temporarily attached to a pulling or pushing stick.

A Helical Cable Pulling Attachment may employ a U shape groove or re-entrant U shape which fully subsumes the cable or cables in the groove when manufactured into a softer elastomer which will spring back and cover the U cavity entrance.

Embodiments of the invention support a method for inserting a cable into a groove of a helical cable pulling attachment by winding the cable around the helical cable pulling attachment, thus gradually inserting it into the groove minimizing the cable cross-section contacting the walls of the groove.

Embodiments of the invention support a method for inserting subsequent cables into the same groove of a helical cable pulling attachment by winding a subsequent atop another cable already present in the groove, thus gradually inserting a subsequent cable minimizing the cable cross-section contacting the walls of the groove.

Embodiments of the invention support a method removing a cable from a helical cable pulling attachment by unwinding it from a groove of the helical cable pulling attachment.

Embodiments of the invention support a method removing a cable from a helical cable pulling attachment removing the cable which is most colinear with the center of the helix first, thus creating an escape channel for all other cables subsequently by pulling the cables left and right of the cable closest to the center, drawing cables towards the center and allowing them to be easily removed.

Multiple cable pulling attachments with cavities for connectors may be combined and staggered linearly within a single body with a single pulling head, making it possible to pull multiple pre-terminated cables at the same time.

Whereas any of the methods described above may serve the purpose of cable storage or cable transportation device, where the cable or cables would be wound inside one or a plurality of helical grooves for storage or transportation rather than cable pulling, taking advantage of the many disclosures in the present application.

A cable wound in a helical groove of a length equal or greater than the cable itself, would never wind onto itself like on a cable drum, thus never risk entangling when unspooling the cable from the helical groove.

It may be possible to use the helical groove to build a pre-terminated cable storage device such as a USB to Lightning cable, where the groove terminates onto cavity matching the connector size.

In a cable storage device for wired headphones such as the famous Apple™ wired EarPods, which have a Y-junction linking the common sheath connecting into the phone and the two separate sheaths going into each car. For this device, the Y-junction could be middle of the Cable Storage Attachment which would employ one helical groove for storing the single sheath with the 3.5 mm or lightning connector at the end and 2 separate helical groove on the other side of the middle section storing the Y shape, for each sheath of each earbud.

The FOC-PA and EC-PA according to embodiments of the invention transfers the tension from its head, from the pulling stick or pulling cable etc., to its boot bonded onto the PC sheath and therefore to the cable sheath. Whilst at the present time over molding is common for electrical cables it has at the present times, not yet been proven convenient for fiber optic cables. Hence at this point in time fiber optic pre-terminated cable assemblies are typically manufactured within the connector boots bonded onto the pre-terminated cable sheath such as through injection molding mechanisms. However, such over molding of connector boots on fiber optical cables can be envisioned in the future. Accordingly, it would be possible for fiber optic pre-terminated cable assemblies to be manufactured for easier pulling through use of the described FOC-PA according to this new embodiment, which would allow for the pulling force applied to be transferred onto a fiber-optic PC sheath through a fiber-optic connector which has a connector boot over molded or otherwise bonded to the fiber-optic PC sheath with sufficient bonding strength.

Within the preceding description the FOC-PA and EC-PA has been described with respect to fiber optic cables and electrical uniaxial cables except for reference to Cat 8 cable. However, embodiments of the invention may be applied to electrical twisted pair pre-terminated cables such as Cat 6A, 7 as well as Cat 8, required for greater 10GBaseT distances, 25GBaseT and 40GBaseT, also have a rounder and harder sheaths, which makes it possible for an EC-PA to clamp on those cable sheaths. Embodiments of the invention may also be applied to twin-axial cables used in direct attach and break out cables for datacenter applications. Embodiments of the invention may also be employed with fiber optic cables with two or more optical fibers with a multi-fiber connector.

Within the preceding description the FOC-PA and EC-PA has been described with respect to fiber optic cables and electrical uniaxial cables which are terminated with a connector. However, it would be evident that alternate embodiments of the invention may support pulling of unterminated cables or that the pulling attachment may support housing multiple connectors.

Specific details are given in the above description to provide a thorough understanding of the embodiments. However, it is understood that the embodiments may be practiced without these specific details. The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

1. The device according to claim 45, wherein
the demountable device is for attachment to a pre-terminated cable and comprises:
a boot portion disposed at a first end of the device having a slot formed therein for insertion and removal of a cable forming part of the pre-terminated cable;
a front portion disposed at a distal end of the device comprising an inner portion for housing a first portion of a connector terminating the pre-terminated cable and a fitting for attachment of another device with which the device and pre-terminated cable are pulled; and
a body portion disposed between the boot portion and the front portion comprising an opening for housing a second portion of the connector and allowing insertion and removal of the connector into the front portion and body portion of the device.

2. The device according to claim 1, wherein
at least one:
the slot within the boot portion is re-entrant and dimensioned such that the cable of the pre-terminated cable is retained within the slot;
the fitting is a threaded insert; and
a lower exterior surface of the boot portion on a side of the boot portion opposite that within which the slot is formed has a recess formed therein

3. (canceled)

4. The device according to claim 1, further comprising
a joint comprising a first fitting on one end of the joint and a second fitting on another end of the joint; wherein
the fitting of the device is attached to the first fitting of the joint;
the puller is attached to the second fitting of the joint; and
either:
the joint allows rotation of the fitting relative to the puller;
or:
the joint is a universal joint allowing movement of the fitting relative to the puller in all three axes.

5-12. (canceled)

13. The device according to claim 45, wherein
the demountable device comprises:
a helix with a helical structure wherein the helix has a bore of a first diameter and an outer surface of a second diameter; wherein
the helix when mounted to the cable adapts a cable pulling attachment to the cable such that the cable is frictionally retained within the cable pulling attachment under application of a longitudinally load to the cable pulling attachment.

14. The device according to claim 13, wherein
the cable pulling attachment comprises:
a boot portion disposed at a first end of the cable pulling attachment having a slot formed therein for insertion and removal of the cable;
a front portion disposed at a distal end of the device comprising an inner portion for housing a first portion of a connector terminating the cable and a fitting for attachment of another device with which the cable pulling attachment and optic cable are pulled;
a body portion disposed between the boot portion and the front portion comprising an opening for housing a second portion of the connector and allowing insertion and removal of the connector into the front portion and body portion of the cable pulling attachment.

15. The device according to claim 13, wherein
one of:
the helix when mounted to the cable expands such that an inner diameter of the helix is larger than the first diameter and the outer surface of the helix has the same second diameter and the helix reduces in length when the helix is attached to the cable; and
the helix when mounted to the cable expands such that an inner diameter of the helix is larger than the first diameter and the outer surface of the helix is less than the second diameter.

16-18. (canceled)

19. The device according to claim 45, wherein
the demountable device comprises:
an element having an inner geometry defined by a predetermined portion of a connector terminating an end of the cable and an outer geometry defined by an inner geometry of a body portion of a pulling attachment; wherein
the element is to be mounted over the predetermined portion of the connector and pushed into the body portion of the pulling attachment to retain the connector allowing the cable to be pulled by a pulling means attached to the pulling attachment; and
the element has one of a retaining U-shape and a re-entrant U-shape.

20. The device according to claim 19, wherein
the pulling attachment comprising:
a boot portion disposed at a first end of the device having a slot formed therein for insertion and removal of a cable forming part of the fiber optic cable;
a front portion disposed at a distal end of the device comprising an inner portion for housing a first portion of a connector terminating the fiber optic cable and a fitting for attachment of another device with which the device and fiber optic cable are pulled; and
the body portion disposed between the boot portion and the front portion comprising an opening for housing a second portion of the connector and allowing insertion and removal of the connector into the front portion and body portion of the device.

21. (canceled)

22. The device according to claim 45, wherein
the demountable device comprises:
a first end portion having a defined length for encasing a predetermined portion of a cable having a diameter wherein the first end portion can be mounted onto and removed from the predetermined portion of the cable;
a second end portion having another defined length for encasing another predetermined portion of the cable wherein the second end portion can be mounted onto and removed from the another predetermined portion of the cable; and
a helical structure having an end coupled to the first end portion and a distal end coupled to the second end portion; wherein
the helical structure can be mounted onto and removed from a further portion of the cable between the predetermined portion of the cable and the another predetermined portion of the cable.

23. The device according to claim 22, wherein
at least one of the first end and the second end comprises a hole formed through the body of the at least one of the first end and the second end portion; and
either:
the hole supports the attachment of a pulling mechanism to the device to pull the cable through at least one of an opening, a bore and a tube;
or:
the device further comprises:
at least one of an inner groove and an outer groove extending from the outermost end of the at least one of the first end and the second end to the hole in the at least one of the first end and the second end;
the hole supports the attachment of a pulling mechanism to the device to pull the cable through at least one of an opening, a bore and a tube where the pulling mechanism fits within the at least one of the inner groove and the outer groove;
the inner groove when present is formed on a surface of the at least one of the first end and the second end which will be contact with the cable; and
the outer groove when present is formed on an external surface of the at least one of the first end and the second end.

24. (canceled)

25. The device according to claim 45, wherein
the demountable device is for attachment to a pre-terminated cable and comprises:
a front portion disposed at an end of the device comprising an inner portion for housing a first portion of a connector terminating the pre-terminated cable and a fitting for attachment of a pulling mechanism with which the device and pre-terminated cable are pulled;
an end portion comprising a helical structure at a distal end of the device; and
a body portion disposed between the front portion and the end portion comprising an opening for housing a second portion of the connector and allowing insertion and removal of the connector into the front portion and body portion of the device; wherein
the helical structure can be mounted onto and removed from a portion of the cable.

26. The device according to claim 25, wherein
the end portion comprises a hole; and
the hole supports the attachment of another pulling mechanism to the device allowing the device and cable to be pulled in at least one of the same direction as the pulling mechanism and in a reverse direction to that of the pulling mechanism.

27. The device according to claim 45, wherein
either the demountable device is for attachment to a pre-terminated cable and comprises:
a body having an end and a distal end;
a fitting for attachment of a pulling mechanism with which the device is pulled disposed within an exterior face of the end;
a plurality of N recesses disposed around the periphery of the end, each recess of the plurality of N recesses for accommodating a connector terminating a cable and having an end at the exterior face of the end and a distal end; and
a plurality of N grooves, each groove of the plurality of N grooves dimensioned to accommodate a cable and running from an end at the distal end of a predetermined recess of the plurality of recesses to a point along the body; wherein
the device supports the mounting of up to M terminated cables;
N and M are positive integers greater than or equal to 2; and
M≤N;
or:
the demountable device comprises:
a body having an end and a distal end;
a fitting for attachment of a pulling mechanism with which the device is pulled disposed within an exterior face of the end;
a plurality of N grooves, each groove of the plurality of N grooves dimensioned to accommodate a cable and running from a point along the body to another point along the body; wherein
each groove supports the mounting of up to M cables;
the device supports the mounting of up to R cables;
N and M are positive integers;
N≥2;
M≥1; and
R≤N*M.

28. (canceled)

29. The device according to claim 45, wherein
the demountable device is for attachment to an unterminated cable and comprises:
a front portion disposed at an end of the device having a slot formed within an outer surface of the front portion;
an end portion comprising a helical structure at a distal end of the device having another slot formed within an outer surface of the end portion; and
a body portion disposed between the front portion and the end portion comprising a helically disposed groove disposed around an outer surface of the body portion wherein an end of the groove connects with the slot in the front portion and a distal end of the groove connects with the other slot in the end portion; and
either:
the slot, the another slot, and the groove each allow the insertion and removal of the unterminated cable;
or:
the slot formed within the outer surface of the front portion has a first portion shaped to continue the helically disposed groove disposed around the outer surface of the body portion and a second portion disposed in a direction contra to the direction of the helically disposed groove and the slot, the another slot, and the groove each allow the insertion and removal of the unterminated cable.

30. (canceled)

31. The device according to claim 45, wherein
the demountable device comprises:
a body of defined cross-sectional geometry with a plurality of surfaces; and
one or more grooves of defined geometry and dimensions where each groove of the one or more grooves is formed within a surface of the a plurality of surfaces; wherein
an end of each groove of the one or more grooves terminates within a defined surface of the plurality of surfaces and a distal end of the groove of the one or more grooves terminates within another defined surface of the plurality of surfaces; and
either:
each groove of the one or more grooves allows the insertion and removal of the cable;
or:
each groove of the one or more grooves allows the insertion and removal of a cable and the defined geometry is a re-entrant geometry such that each cable when inserted into a groove of the one or more grooves is retained physically within the groove of the one or more grooves.

32. (canceled)

33. The device according to claim 45, wherein
the demountable device comprises:
a body of defined cross-sectional geometry with an outer surface, an end and a distal end;
a first recess formed within the end of the body;
a second recess formed within the distal end of the body;
a helically disposed groove of defined geometry and dimensions disposed around the outer surface of the body;
a first guide with the defined geometry and dimensions connecting an end of the first recess to an end of the helically disposed groove;
a second guide with the defined geometry and dimensions connecting an end of the second recess to a distal end of the helically disposed groove; wherein
the first recess is dimensioned to hold a first connector terminating an end of a cable;
the second recess is dimensioned to hold a second connector terminating a distal end of the cable; and
the first guide, the second guide and the helically disposed groove allow for the demountable insertion of the cable.

34. The device according to claim 45, wherein
the demountable device comprises:
an elongate body having an end and a distal end;
one or more grooves, each groove extending from the end of the elongate body to a position along the elongate body with a cross-section supporting insertion of a cable having a predetermined geometry;
one or more spiral grooves, each spiral groove extending from the distal end of the elongate body to another position along the elongate body supporting insertion of strength members of one or more cables when mounted to the device.

35. The device according to claim 34, wherein
either:
each groove of the one or more grooves is one of linear along the elongate body and defines a portion of a helix along the elongate body;
or:
the demountable device further comprises:
a bore extending from the end of the elongate body to the distal end of the elongate body;
a pull rod having an end, a distal end, a central portion, and a fitting forming part of the distal end; wherein
a length of the pull rod is longer than a length of the elongate body;
the end is dimensioned to prevent the end going into the bore;
the distal end and central portion are dimensioned to fit within the bore;
the fitting supports attachment of a means to pull the pull rod and elongate body through one of a bore and a conduit.

35. (canceled)

36. The device according to claim 34, wherein
the demountable device further comprises:
one of:
one or more other grooves, each other groove extending from an end of a predetermined groove of the one or more grooves along the elongate body to the another position; and
one or more other grooves, each other groove coupled to an end of a defined spiral groove of the one or more spiral grooves at the distal end of the elongate body and extending along the elongate body towards the end for a defined distance where one or more strength members of the cable are wound into the defined spiral groove of the one or more spiral grooves and the other groove of the one or more other grooves such that a pulling force applied to the distal end of the elongate body pulls upon the one or more strength members of the cable rather than the outer jacket of the cable or other elements forming part of the cable.

37. (canceled)

38. The device according to claim 45, wherein
the demountable device comprises:
an elongate body having a first end and a distal end;
a first groove comprising a portion axial to a longitudinal axis of the elongate body at the end of the elongate body, another portion axial to the longitudinal axis of the elongate body at the distal end; and a further portion between the portion and another portion along a helical path;
a second groove comprising a portion axial to a longitudinal axis of the elongate body at the end of the elongate body, another portion axial to the longitudinal axis of the elongate body at the distal end; and a further portion between the portion and another portion along a helical path; wherein
the first groove supports insertion and retention of the cable; and
the second groove supports insertion and retention of the cable.

39. The device according to claim 38, further comprising
one of:
a third groove comprising a portion axial to a longitudinal axis of the elongate body at the end of the elongate body, another portion axial to the longitudinal axis of the elongate body at the distal end; and a further portion between the portion and another portion along a helical path and the third groove supports insertion and retention of a pulling cable or pulling rope; and
a third groove and a fourth groove where the third groove comprises a portion axial to a longitudinal axis of the elongate body at the end of the elongate body, another portion axial to the longitudinal axis of the elongate body at the distal end; and a further portion between the portion and another portion along a helical path and the fourth groove comprises a portion axial to a longitudinal axis of the elongate body at the end of the elongate body, another portion axial to the longitudinal axis of the elongate body at the distal end; and a further portion between the portion and another portion along a helical path where the third groove supports insertion and retention of a pulling cable or pulling rope and the fourth groove supports insertion and retention of a pulling cable or pulling rope.

40. (canceled)

41. The device according to claim 45, wherein
the demountable device is for attachment to a pre-terminated cable and comprises:
a boot portion disposed at a first end of the device having a slot formed therein for insertion and removal of a cable forming part of the pre-terminated cable;
a front portion disposed at a distal end of the device comprising an inner portion for housing a first portion of a connector terminating the pre-terminated cable and a fitting for attachment of another device with which the device and pre-terminated cable are pulled; and
a body portion disposed between the boot portion and the front portion comprising an opening for housing a second portion of the connector and allowing insertion and removal of the connector into the front portion and body portion of the device;
the boot portion and the body portion are a single piece part; and
the front portion is one of removably attachable to the body portion and permanently attached to the body portion.

42-44. (canceled)

45. A device comprising:
a demountable device for attachment to a cable.
